(19) United States
(12) Patent Application Publication
(10) Pub. No.: US 2005/0078660 A1
(43) Pub. Date: Apr. 14, 2005

(54) Distributed message transmission system and method

(76) Inventor: Ian Wood, London (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/918,852

(22) Filed: Aug. 12, 2004

Related U.S. Application Data
(63) Continuation of application No. PCT/GB03/00709, filed on Feb. 18, 2003.

(30) Foreign Application Priority Data
Feb. 18, 2002 (GB) 0203796.8
Feb. 18, 2002 (GB) 0203795.0
May 3, 2002 (GB) 0210243.2

(51) Int. Cl. H04L 12/66

(52) U.S. Cl. 370/352

(57) ABSTRACT

A system and method for routing at least one message to a component connected to a telecommunications network. The message is received from the telecommunications network over a telecommunications communication protocol link. Interaction with the message occurs at the MAP layer, or at another equivalent high level protocol layer, to determine at least one piece of information, including information indicative of the destination, from the message A route is then selected to deliver the message to its destination, which is connected to the telecommunications network. The route being selected from at least a first route via the telecommunications network and a second route via a network separate to the telecommunications network and the route further being selected based on the information determined from the message.

The present invention relates to the field of mobile telecommunications and relates particularly to the field of sending and routing Short Message Service (SMS) messages within a telecommunications network.

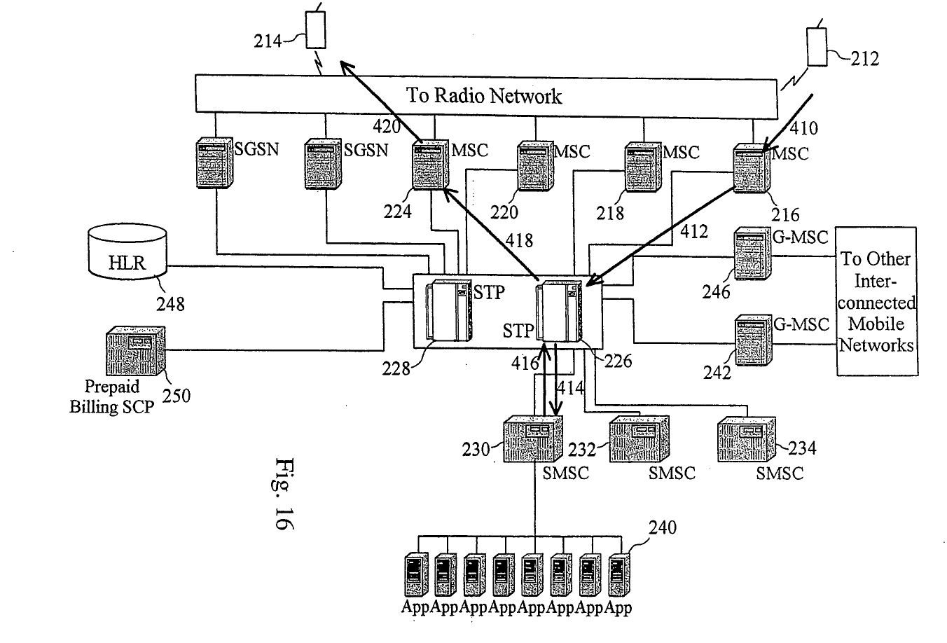

Referring to FIG. 16, a basic SMS messaging network may consist of a network of Mobile Switching Centres (MSCs), which control radio frequency (RF) connections to mobile entities on the network, at least one Short Message Service Centre (SMSC), which stores and forwards messages, at least one Signalling Transfer Point (STP), which provides a hub through which messages may pass between the components of the network, a Home Location Register (HLR), which stores location information for the mobile entities on the network and, optionally, Gateway MSCs (G-MSCs) (or Internetworking Gateway MSCs (IG-MSCs)), through which a mobile operator's network may be connected to the networks of other operators. Signalling occurs between the network elements using the Common Channel Signalling System No. 7 (SS7) protocol defined by the International Telecommunications Union (ITU). The SS7 protocol stack consists of six layers, as described in more detail below. The lower layers of the stack are usually used for routing messages across the telecommunications network whilst the higher layers contain the message data. As shown in FIG. 16, further components of the SMS message network may include a Prepaid Billing Service Control Point (SCP), to control billing of messages sent to and from prepaid mobile telephones, applications, which may connect to an SMSC of the telecommunications network via a proprietary interface, and SGSN components (Serving GPRS Support Nodes), which function in a similar way to the MSCs but work within a 2.5G or 3G network. Similarly, the term “SMSC” is intended to encompass all types of message service centres that handle short messages and is not limited to an SMSC in a GSM mobile telecommunications network. For example, the term encompasses message service centres in other types of network, for example 2.5G and 3G networks.

One problem with conventional SMS messaging networks is that each message passes through the STP at least once as it is routed from one mobile entity to another on the network. This can cause congestion at the STP and requires SS7 bandwidth, which is expensive, to be provided.

There are also problems in the prior art system in connecting applications to the telecommunications network and in using those applications to send and receive messages. In the prior art system, a limited number of applications may connect via a proprietary interface to an SMSC in the network. Once connected, these applications can only receive messages from other mobile entities for which the SMSC to which they are connected is the home SMSC. Problems of congestion at the STP may also be intensified when applications are connected to the mobile network, since applications tend to send and receive large transient volumes of messages.

Proposals to alleviate the problems of congestion on the SMS messaging network have comprised offload of traffic from the SS7 network and onto a parallel separate network, such as an IP network. One such system is outlined in WO-A-01/59969. In this system, messages may be intercepted by terminals connected to MSCs and G-MSCs on the mobile network. These terminals provide protocol translation to transfer the message from one point in the telecommunications network, which uses the SS7 protocol, to a separate network, which may use a protocol such as IP. Once they have been transferred onto the separate network, the messages are delivered to another point in a telecommunications network, via a further protocol translation terminal, bypassing a portion of the network. This system may allow messages to bypass at least some of the busier points of the telecommunications network such as the STPs, and so may reduce congestion at those points.

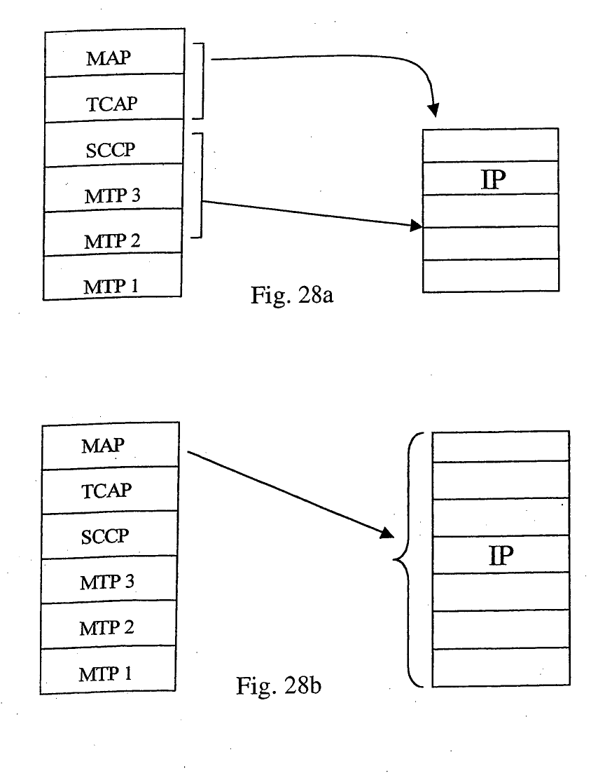

Protocol translation terminals allow the transfer of messages or data from the SS7 network to another network, such as IP, and are well known in the art. A common technique used in IP offload will now be described with reference to FIG. 28. As outlined above, the SS7 protocol stack typically consists of six layers: the Message Transfer Part (MTP) Layer 1, Layer 2 and Layer 3, the Signalling Connection Control Part (SCCP), the Transaction Capabilities Applications Part (TCAP), and the Mobile Application Part (MAP). In a prior art network, routing of messages takes place at the lower MTP and SCCP layers. The higher TCAP and MAP layers contain the message data itself (for example, the content of the message). Other protocols may be used in alternative networks, but it is a common feature of the protocol stack that the lower layers of the stack are used to route data across the network and the higher layers contain the message or packet data.

A commonly used offload system extracts the routing data, such as the identifier of the destination of the message, from the lower SCCP and MTP layers and inserts this routing data into the equivalent layers of an IP stack. As shown in FIG. 28a, the message data in the MAP and TCAP layers is then transferred directly onto the IP protocol stack. The data contained within the MAP and TCAP layers is not processed or read, but is transferred to be carried on the IP stack. “MAP” is the term used in ETSI standards and is used herein for convenience to connote an application level layer; it is intended to encompass equivalents (for example IS-41-C and IS-41-D of the TIA and EIA standards).

The IP offload systems described above do not solve the problems of congestion on the telecommunications network as a whole. Processing of the message is still undertaken by components of the mobile network, such as the SMSC, and congestion may occur at these points. It is necessary for the SMSC to process the messages since, as explained in more detail below, the final destination address for a message originated by a mobile handset may be contained within the payload of the message, which is encapsulated by the protocol translation terminal. In addition, the implementation of the IP offload system may be relatively inflexible.

The present invention seeks to solve some of the problems outlined above and provides a system and method by which congestion on the SS7 layer of the telecommunications network may be reduced and by which the efficiency of the transmission of messages across the telecommunications network may be increased whilst requiring little modification of the existing network.

Aspects of the invention are set out in the independent claims and preferred features are set out in the dependent claims. Preferred features of each aspect may be applied to other aspects of the invention unless otherwise stated.

There is described herein a method of processing a message in a mobile telecommunications network having at least one message service centre for processing messages comprising:
receiving a message in a mobile telecommunications network prior to receipt of the message by any message service centre;
analysing the message to classify the message into one of a plurality of predetermined message types;
selecting a delivery strategy for the message from a plurality of predetermined delivery strategies based on the determined message type.

Selecting the delivery strategy for a message based on the message type may allow messages to be delivered more efficiently and may reduce the load on the mobile network. For example, it may be advantageous to deliver certain types of messages directly to their destinations without passing through an SMSC of the mobile network, hence reducing congestion at this network component. Also, it may not be necessary for the delivery of some types of message to be acknowledged to the message sender.

Preferably, one of the predetermined delivery strategies comprises forwarding the message to a message service centre.

The message service centre may be an SMSC of the mobile network, or it may be another message service centre, for example an AMSC described below. The message service centre may be attached to the mobile telecommunications network and may use this network to forward the message to its destination. The message service centre is preferably attached to the component that receives the message over a network separate to the mobile telecommunications network, for example over a TCP/IP network. In this way, the message may be forwarded to the message service centre without passing over the mobile telecommunications network and without causing congestion on this network. The message service centre may forward the message to its destination address over the mobile telephone network or over a separate network.

One of the predetermined delivery strategies may comprise attempting to deliver the message directly to its destination without the message passing through an SMSC of the mobile telecommunications network. This may be performed, for example, by terminating the mobile originated message and sending a mobile terminated message via the mobile telecommunications network to the destination mobile station.

The delivery strategy preferably further comprises forwarding the message to a message service centre if the attempt to deliver the message directly to its destination fails. Hence the message may be stored by the message service centre (for example an SMSC or an AMSC) until the message can be delivered to its destination.

The delivery strategy may further comprise storing the message and subsequently attempting to deliver the message to its destination. The message may be stored at the component that receives the message or, more preferably, the message may be forwarded to a component, such as a message service centre, with a persistent store.

Preferably at least one delivery strategy further comprises performing additional processing of the message.

The additional processing may comprise at least one of:
forwarding the contents of the message to an email;
forwarding the contents of the message to voicemail;
forwarding the message to an application that processes voting messages;
storing the message in a persistent message store and subsequently attempting to deliver the message to its destination.

According to a preferred embodiment, the plurality of predetermined message types includes at least one of:
a peer-to-peer message;
a peer-to-application message;
an application-to-peer message;
a voting-to-application message.

These message types are message types that are commonly sent across mobile telecommunications networks. A peer-to-peer message is a message sent across the mobile network between two mobile stations. The mobile stations may share the same home network or may belong to different mobile networks.

Preferably, the message is analysed at the MAP layer to determine the message type. Analysing the message at the MAP layer may allow information such as the identifiers of the originating and destination mobile stations and the identifier of the home SMSC for the originating mobile station to be determined.

According to one embodiment, for at least one type of message having a destination within a defined destination class, the message is acknowledged to the originator without requiring confirmation of receipt of the message at its destination.

Hence the message may be acknowledged to the originating mobile station before it is forwarded to its final destination address. This may allow the radio communication link between the originating mobile station and the mobile telecommunications network to be terminated more quickly than in the prior art system hence reducing congestion at this point on the network. This may be particularly advantageous when the mobile telecommunications network is busy. A defined destination class may be, for example, an identifier for an application or a range of identifiers for an application or a plurality of applications. Alternatively, the defined destination class may be defined more broadly and may comprise, for example, every message that is destined for an application.

According to one preferable embodiment, the message may be classified into one of the plurality of predetermined message types based on at least one of:
an identifier of the originating mobile station or application;
an identifier of the destination mobile station or application;
an identifier of the SMSC to which the message is addressed.

In one embodiment, the method may further comprise determining billing status for the message prior to or without processing the message by a message service centre. In prior art mobile networks, message service centres process messages to determine their billing status, for example whether the messages originate from pre-paid or post-paid mobile platforms. However, providing the functionality to determine the billing status without using a message service centre may allow the message to be passed directly to its destination without the need to be processed by a message service centre.

In one embodiment, the message may be received by intercepting the message, the component that intercepts the message being configured to appear to the network to have the same identifier as the SMSC of the network to which the message is addressed.

According to a further aspect there is provided a method of processing messages in a mobile telephone network comprising:
grouping a plurality of messages of a predetermined type into a batch;
delivering the batch of messages to a single location.

This may allow information that is common to all of the messages to be removed from each message and included only once for the group of messages. Hence the messages may be transmitted more efficiently to the single location.

Preferably, the method further comprises:
analysing the message to determine the message type based on at least one predetermined criterion;
grouping a plurality of messages of the same type into a batch.

Messages of the same type may be treated more efficiently in the same way, so it is likely to be useful to group messages of the same type together.

According to one preferable embodiment, the method further comprises compressing the batch of messages before delivering the batch of messages. This may reduce the size of the batch of messages and allow the messages to be transmitted more quicky to their destination.

The message type may include at least one of:
a peer-to-peer message;
a peer-to-application message;
an application-to-peer message;
a voting-to-application message.

According to one preferred embodiment, the message may be classified into one of the plurality of predetermined message types based on at least one of:
an identifier of the originating mobile station or application;
an identifier of the destination mobile station or application;
an identifier of the SMSC to which the message is addressed.

Hence messages originating from a single mobile station or apparatus may be grouped into a batch, or messages destined for the same SMSC, mobile station or application may be grouped together for more efficient delivery.

In one embodiment, the single location may be an application.

In particular, the application may be an application that processes voting messages. This may mean that it is particularly advantageous to group messages together, since voting applications often attract a high number of messages over a short period.

According to a further embodiment, the single location may be a message service centre. Hence messages that need to be delivered to a message service centre may be grouped and sent in batches.

According to a further aspect, there is provided a method of processing a message in a mobile telecommunications network comprising selecting a delivery strategy for the message from a plurality of predetermined delivery strategies based on at least one predetermined network condition.

According to one embodiment, the predetermined network condition may comprise at least one of:
the network load;
the load at a selected component in the network;
the availability of the destination short message entity for the message;
the throughput of new messages arriving in the system.

The delivery strategy may further be selected based on the message type and wherein the message type may comprise one of:
a peer-to-peer message;
a peer-to-application message;
an application-to-peer message;
a voting-to-application message.

According to a preferable embodiment, a default delivery strategy is defined and, under adverse network conditions, at least one alternative delivery strategy is adopted in which at least one step of the default delivery strategy is omitted or modified.

The adverse network conditions may be determined by monitoring some or all of the network conditions outlined above. The default delivery strategy may comprise the steps of the standard delivery strategy for the mobile telecommunications network or may be a default strategy defined by the system described herein.

Preferably, the alternative delivery strategy comprises at least one of the following features:
acknowledging receipt of the message to the originating mobile station prior to receipt at the intended destination;
storing the message in a persistent store for subsequent delivery to its destination;
performing at least some steps which are linked in the default message delivery process asynchronously;
performing the step of obtaining billing information for the message asynchronously.

Acknowledging receipt of the message to the original mobile station prior to receipt at the intended destination provides the advantage that the radio link between an originating mobile terminal and the mobile telecommunications network may be terminated as quickly as possible, without waiting for receipt of the message to be acknowledged by the destination mobile entity. Hence congestion on this part of the network may be reduced. One embodiment of this delivery strategy is described in more detail below as the “Immediate Acknowledgement” strategy.

A further delivery strategy may comprise storing the message in a persistent store. The store may be located at the network component that first receives the message, but more preferably is located at a message service centre, for example an AMSC or and SMSC as described herein. The message may be acknowledged to the originating mobile terminal when the message is stored. The stored message may be delivered to its destination at a later time, for example when the network becomes less busy or when the destination entity becomes available to receive messages. One embodiment of this feature is described in more detail below as the “Persistence” delivery strategy. This delivery strategy may be used particularly when the network is transmitting high volumes of traffic and is subject to congestion. Acknowledgment of the message to the originating mobile entity does not guarantee that the message will be delivered to the destination message entity, but the message may be persisted until delivery is successful or for a predetermined period of time.

Performing at least some steps which are linked in the default message delivery process asynchronously may allow the message delivery process to be completed more quickly since steps that are normally dependent on the completion of previous steps in the message delivery process may be performed without waiting for completion of those steps. As described above, acknowledgement of the message may be transmitted to the originating mobile terminal before the destination mobile station has received the message. In particular, the step of obtaining billing information for the message may be performed asynchronously.

Preferably, the plurality of predetermined delivery strategies includes at least one of:
acknowledging the message to the originating mobile station prior to receipt at the intended destination; storing the message for later delivery;
forwarding the message to a high-speed application and relaying an acknowledgement to the originating mobile station;
forwarding the message to a message service centre and acknowledging the message to the originating mobile station on receipt of the message by the message service centre.

The strategy of forwarding the message to a high-speed application and relaying an acknowledgement to the originating mobile station may be particularly advantageous for messages sent to applications that process high volumes of messages, such as voting applications. The application may be designed particularly to allow an acknowledgement to be sent out quickly and hence to allow the mobile telecommunications network to terminate its link with the originating mobile entity quickly. This strategy provides the advantage that the originating mobile station may receive positive and reliable acknowledgement of receipt of the message by the application.

The strategy of forwarding the message to a message service centre and acknowledging the message to the originating mobile station on receipt of the message by the message service centre may also provide an efficient method by which messages may be acknowledged. This method is also known as “Double Acknowledgement” and is described in more detail below.

According to a preferred embodiment, the delivery strategy selected for at least one message type may be modified in response to changes in the at least one predetermined network condition.

According to a highly preferable feature, under a first set of adverse network conditions, a first alternative delivery strategy is adopted and, under a second set of adverse network conditions, a second alternative delivery strategy is adopted.

This may allow the delivery strategy to be changed as network conditions change. In particular, if network conditions worsen, a delivery strategy that increases the throughput rate of messages in the system, for example by decreasing the time from sending of the message to acknowledgement of receipt of the message being sent to the originating mobile station.

Network conditions may be measured according to the parameters outlined above.

In one embodiment, the default delivery strategy may be to wait for an acknowledgement of receipt of a message at its destination before acknowledging receipt to the originating message entity. A first alternative delivery strategy may be to forward the message to an entity for persistent storage of the message and to acknowledge receipt to the originating message entity on storage of the message. A second alternative delivery strategy may be to acknowledge receipt of the message to the originating message entity when the message is initially received and before further processing or delivery of the message takes place. Each of these delivery strategies are described in more detail herein.

The delivery strategies may preferably be designed to acknowledge receipt of the message more quickly as the network becomes more congested. It is advantageous, however, not to use the fastest message acknowledgement delivery strategy as a default strategy, since this strategy may decrease the reliability of the system, since a message that is acknowledged immediately on receipt will not necessarily actually be delivered to its intended destination.

According to a further aspect, there is provided a method of processing a request to assign a billing category to a message in a mobile telecommunications network, the method comprising:
receiving a request to determine whether a message originates from a mobile terminal associated with at least a first or second billing category;
responding to the request based on information available from a billing server wherein the method is characterised by:
storing in a cache identifiers of originating mobile terminals in at least one billing category based on the results of said selecting and consulting the cache to attempt to determine the processing category.

In a prior art network, a billing server may be used to determine whether a mobile entity that has originated a message is a pre-paid terminal and determine whether the pre-paid mobile terminal has sufficient credit to send the message. Details about pre-paid mobile terminals are not cached since the credit information has to be up to date to prevent fraud in the system and to prevent messages being sent by terminals that do not have sufficient credit. However, the process of assigning a billing category may be speeded up, and hence message processing may be speeded up, by caching information about post-paid terminals. In this way, if the terminal can be easily identified as a post-paid terminal, then it is not necessary to consult information about pre-paid terminals.

A further aspect provides a method of assigning a processing category to a message in a mobile telecommunications network comprising:
sending a request to a billing server to determine whether a message originates from a mobile terminal associated with at least a first or second billing category;
selecting the processing category based on the billing category wherein the method is characterised by:
storing in a cache identifiers of originating mobile terminals in at least one processing category based on the results of said selecting and consulting the cache to attempt to determine the processing category prior to sending a request to the billing server.

According to this aspect, a cache, for example of post-paid terminal identifiers, may be stored by message processing elements, for example the MDP and AMSC described herein. As outlined above, requesting and obtaining billing information from a billing server may be a slow process, which may delay the message sending process. Caching identifiers may allow the processing category, or billing method, for some messages to be determined without consulting a billing server.

According to a preferable feature of the preceding two aspects, the billing categories comprise pre-paid and post-paid services.

Preferably, for a first processing category, messages may be processed further without requiring a response from the billing server.

The caches of the preceding two aspects are preferably refreshed periodically to ensure that outdated information is not stored in the caches and relied on for billing by the network. Alternatively or in addition, the cache may be updated or refreshed when changes to billing information are implemented in the network, for example when data in a billing server is updated. A further alternative or additional feature may be that the caches have a limited capacity and so data in the caches is automatically overwritten as new data is entered into the cache.

According to a further aspect, there is provided a method of configuring a mobile telecommunications network, the network having at least one SMSC and the at least one SMSC having a unique identifier associated with it, the method comprising:
routing messages containing a selected unique identifier associated with an SMSC to a network component other than the SMSC.

A further aspect provides a method of processing a message in a mobile telecommunications network by a message processing component which interacts with the message to determine one of a plurality of actions based on message content, the method comprising:
receiving a message from a message entity;
forwarding the message to a target having a persistent store;
forwarding an acknowledgement to the message entity;
wherein the message is forwarded to the target without being retained in a persistent store.

A message processing component preferably comprises a component that interacts with the message but does not store the message. Not storing the message may be advantageous since the component may be provided without large amounts of storage capacity. Instead the message may be forwarded directly to a target that can store the message, for example, this may be a central target that receives messages from a plurality of message processing components. Acknowledgement of receipt of the message may then be passed to the originating message entity. If the originating entity does not receive acknowledgment of the message then the entity may try to resend the message. Hence the message may be stored either in the target having a persistent store or in the originating message entity, so it is not necessary to provide storage capacity for the message at the message processing component.

The target having a persistent store may comprise a message service centre, such as an AMSC as described herein or an SMSC of the mobile telecommunications network, or the target may be a component specifically designed to receive and store messages.

The stored messages are preferably released from storage for delivery to their destination message entities, for example they may be released to a message service centre or to a message processing component. According to a preferred embodiment, the method further comprises:
awaiting an acknowledgement from the target;
and wherein the acknowledgement is forwarded to the message entity in response to the acknowledgement from the target.

Hence a message may be acknowledged only when it has been persisted in the message store. This may increase the likelihood that the message may be delivered to its destination.

According to a further embodiment the acknowledgement is forwarded to the message entity without awaiting acknowledgement from the target. This may help to increase the throughput of messages through the message processing component and hence reduce congestion on the mobile telecommunications network. This embodiment may be particularly useful for high volumes of non-critical message types, for example voting messages.

Further apparatus aspects are set out in the accompanying claims. Preferred features of the method aspects outlined above may be applied to the apparatus aspects.

According to a further aspect, there is provided a method of routing at least one message to a component connected to a telecommunications network comprising:
receiving the message from the telecommunications network over a telecommunications communication protocol link;
interacting with the message at the MAP layer to determine at least one piece of information including information indicative of the destination, from the message;
selecting a route for a destination connected to the telecommunications network from at least a first route via the telecommunications network and a second route via a network separate to the telecommunications network based on the information determined;
routing at least a portion of the message via the selected route.

Extracting information from the message at the MAP layer (which is normally only encapsulated in prior art offload systems) may allow the message to be routed efficiently and “intelligently” to its destination according to the information obtained. For example, it may not be necessary for certain types of message to pass through the SMSC component of the telecommunications network, hence reducing the load on this part of the telecommunications network.

In this specification and claims, references to the MAP protocol or MAP layer are intended to encompass similar or equivalent application protocols for example, but not limited to, other high-level protocols of other standards, such as the IS-41-C and IS-41-D protocols.

Preferably, the at least one piece of information extracted from the message may be used to determine the message type, wherein the message type may be one of: mobile originated, mobile terminated, application originated or application terminated. In a preferred embodiment, the at least one piece of information extracted from the message may be the destination address for the message. This may be a global identifier of the destination entity for the message, which may be for example, a mobile telephone handset or an application. The message type may then be determined by consulting a global lookup table, either locally or remotely over a network. The global lookup table may contain further information relating to each destination address, such as whether the destination entity is a mobile telephone handset or an application, routing data for the destination entity and availability information for the destination entity.

Determining the type of message may increase the efficiency of message processing, for example, messages destined for applications may be processed in a different way to those being sent to mobiles, and mobile or application originated messages may require additional processing compared to the mobile or application terminated messages.

Preferably, the method further comprises determining that the message is an application terminated message destined for an application connected to a remote node. Messages may be routed to applications not directly connected to the component that receives and parses the message. Applications may be connected to a remote node in the telecommunications network, such as to an SMSC of the home operator's network, or another operator's network, or applications may be connected to a remote node in the separate network, for example an IP network.

Preferably, the network separate to the telecommunications network is an IP network. This may provide an efficient and easily implemented method by which messages may be sent to their destinations whilst reducing congestion on the SS7 telecommunications network.

Preferably, the step of receiving the message from the telecommunications network further comprises terminating the message. If the message is terminated, then a new message may be generated, based on information extracted from the terminated message, and the message may be sent directly to its destination. Hence it is not necessary to send the message to an SMSC of the telecommunications network for the message to be terminated.

According to a highly preferred embodiment, if the message type determined is a mobile originated message, then the method further comprises:
parsing the message at the MAP layer to extract at least one piece of information from the message;
routing at least a portion of the message to its destination over a network separate to the telecommunications network based on the information extracted from the message.

Parsing a mobile originated message at the MAP (or other high level protocol) layer may allow the message to be processed by the network component at which it is received. The message may be delivered directly from there to its destination without passing through the SMSC of the telecommunications network for processing. This provides the advantage that the load on the SMSC may be reduced and the mobile originated message may be delivered more quickly and more efficiently to its destination. Parsing the message may allow the network component to determine the most efficient way to route each message to its destination.

Preferably, the at least one piece of information extracted from the message is an identifier of the final destination entity for the message.

Preferably, the method further comprises performing a destination lookup for the identifier of the final destination entity for the message.

Preferably, performing the destination lookup comprises requesting location information for the identifier of the final destination entity for the message from a remote component. This provides the advantage that it is not necessary for each component that receives messages to provide a destination lookup facility locally. A remote central component may also provide further functionality centrally, such as message storage capabilities and IMSI and prepaid credit lookup facilities.

Preferably, the message is routed to its destination without passing through an SMSC of the telecommunications network. Preferably, the message is routed to its destination without passing through an STP of the telecommunications network. This may allow the message to be routed to its destination without causing congestion at these particularly busy components of the telecommunications network.

Preferably, the message is passed to a message handling component, such as an SMSC or AMSC, to allow storage of the message. This may reduce the need for large message storage capabilities at each point in the network where messages are received.

Preferably, the network over which the message is routed is selected according to at least one predetermined condition.

The message is preferably routed to its destination over a network separate to the telecommunications network, but may be routed over the telecommunications network in some situations, for example if it would be more efficient to route a particular message over the telecommunications network.

Further preferably, the at least one predetermined condition comprises at least one of:
information extracted from the message at the MAP layer;
the message type;
an identifier of the final destination entity for the message;
destination lookup information obtained for the identifier of the final destination entity for the message;
an identifier of the mobile entity which originated the message;
an identifier of the home SMSC for the message.

Other conditions may also be used to determine which network the message is routed over. In addition, a combination of the conditions outlined above may be used to determined the network used. One example of the advantages in selecting the network over which the message is routed may be that messages destined for other operator's networks may be selectively routed over the telecommunications network.

Preferably, the step of routing the message over a network separate to the telecommunications network further comprises:
selecting one connection from a plurality of connections to components in the telecommunications network, wherein the plurality of connections are separate from the telecommunications communication protocol links; delivering the message into the telecommunications network via the selected one of the plurality of connections.

Hence messages may advantageously be delivered into the telecommunications network at a selected point, which may allow each message to be delivered to its destination in the most efficient way.

Preferably, at least one of the plurality of connections is bidirectional and the method further comprises receiving a message via at least one of the plurality of connections.

Preferably, the message is received via a first connection out of the plurality of connections and wherein the message is delivered into the telecommunications network via a selected one of the plurality of connections.

Preferably, wherein the connection via which the message is delivered into the telecommunications network is selected according to the at least one piece of information extracted from the message at the MAP layer.

Preferably, at least one of the plurality of connections to components in the telecommunications network comprises a connection via a message delivery component, which processes received messages for transmission between components in the telecommunications network and transmits at least a portion of each message over one of the plurality of connections separate from the telecommunications communication protocol links.

Preferably a plurality of the connections to components in the telecommunications network are via message delivery components and the wherein the message delivery components are interconnected over connections separate from the telecommunications communication protocol links. Hence messages may be passed between message delivery components without passing over the telecommunications network.

Preferably, the message may be received from a component in the telecommunications network over an SS7 connection. Hence the present system and method may be implemented within an existing telecommunications network with the minimum possible modifications to the existing network.

Preferably, at least one message delivery component receives messages from more than one component in the telecommunications network.

Preferably, wherein the connections separate from the telecommunications communication protocol links are IP connections.

Preferably, at least some of the plurality of telecommunications components comprise switches in the telecommunications network.

Preferably, the method further comprises obtaining at least one piece of information from a location register before routing the message to its destination.

Preferably, the location register stores location information for globally unique identifiers corresponding to applications connected to the telecommunications network. This may allow messages to be delivered to applications in the mobile network from any operator's network.

Preferably, the method further comprises requesting at least one piece of information from a message handling component before routing the message to its destination, the message handling component comprising means for obtaining information relating to mobile entities or applications connected to the mobile telecommunications network. A central message handling component may be used by each of the distributed message delivery components to perform functions such as destination and availability lookup for each destination mobile or application, IMSI check and prepaid credit check capabilities and storage capabilities. Since these functions may be performed by the central message handling component over a network separate to the telecommunications network, it may not be necessary to provide each message delivery component with this functionality locally. Hence, a large number of distributed message delivery components may be implemented within a telecommunications network, but most of the functionality may be provided by the central component.

According to one preferable embodiment, at least part of the message is routed to its destination via a message handling component. The message handling component may use the information contained within the at least a part of the message to determine information which may then be used to route the message. However, in the preferred embodiment, it is not necessary to route the whole of the message via the message handling component.

Further preferably, the message handling component obtains at least one piece of information relating to mobile entities or applications from the location register.

Further preferably, the message handling component provides an interface between the telecommunications network and the applications for which location information is stored in the location register.

Preferably, the at least one piece of information comprises at least one of:
location information for the destination entity corresponding to the identifier of the final destination of the message;
availability information for the destination entity corresponding to the identifier of the final destination of the message;
International Mobile Subscriber Identity (IMSI) information; and
prepaid credit information.

Further information may also be obtained centrally by the message handling component for each message.

Preferably, the message may be received from a Gateway Mobile Switching Centre (G-MSC) in the telecommunications network. Hence messages may be offloaded by the message delivery components at the G-MSC, which may allow messages to travel a short a distance as possible across the home network operator's telecommunications network.

Preferably, the message may be received from a Mobile Switching Centre (MSC) in the telecommunications network. Hence messages may be received at the earliest possible point after they are generated by mobile entities connected to the MSCs.

According to a further aspect, there is provided a method of routing at least one message to a destination component connected to a network separate to the telecommunications network comprising:
receiving the message from the telecommunications network over a telecommunications communication protocol link;
interacting with the message at the MAP layer to determine at least one piece of information including information indicative of the destination from the message;
routing at least a portion of the message to its destination over the network separate to the telecommunications network without routing the message via an SMSC of the telecommunications network.

According to a further aspect, there is provided apparatus for routing at least one message to a component connected to a telecommunications network comprising:
means for receiving the message from the telecommunications network over a telecommunications communication protocol link;
means for interacting with the message at the MAP layer to determine at least one piece of information including information indicative of the destination from the message;
means for selecting a route for a destination connected to the telecommunications network from at least a first route via the telecommunications network and a second route via a network separate to the telecommunications network based on the information determined;
means for routing at least a portion of the message via the selected route.

Preferable features of the present apparatus aspect correspond to equivalent features of the method aspect outlined above.

A further aspect provides apparatus for routing at least one message to a destination component connected to a network separate to the telecommunications network comprising:
means for receiving the message from the telecommunications network over a telecommunications communication protocol link;
means for interacting with the message at the MAP layer to determine at least one piece of information including information indicative of the destination from the message;
means for routing at least a portion of the message to its destination over the network separate to the telecommunications network without routing the message via an SMSC of the telecommunications network.

A further aspect provides apparatus for transferring information from a message in a telecommunications network to a message handling component comprising:
means for receiving the message from the telecommunications network and terminating the message;
means for processing the received message to extract at least a portion of the content of the message;
means for sending the extracted portion of the content of the message to a message handling component over a network that utilises a protocol other than the telecommunications protocol.

Preferably, at least a portion of the content of the message is extracted at the MAP layer.

Also herein described is a method of determining the type of a message comprising:
receiving the message from a telecommunications network;
parsing the message at the MAP layer to determine an identifier of the destination entity of the message; based on the identifier of the destination entity of the message, determining the message type, wherein the message type may be one of: mobile originated, mobile terminated, application originated or application terminated.

Determining the message type may allow different types of message to be treated in different ways and hence messages may be handled so that they may be routed to their destinations in the most efficient manner.

According to a further aspect, there is provided apparatus for delivering data to one of a plurality of telecommunications components in a telecommunications network, the plurality of telecommunications components in the telecommunications network being interconnected over a telecommunications communication protocol link, the apparatus comprising:
means for connecting to a first telecommunications component via a first connection separate from the telecommunications communication protocol link;
means for connecting to a second telecommunications component via a second connection separate from the telecommunications communication protocol link;
means for selecting one of the first and second components as an introduction point for the data;
means for delivering the data into the telecommunications network via the selected one of the first and second connections.

This may allow data, such as SMS messages, to be delivered to a selected component in a telecommunications network over a network separate to the telecommunications communication protocol link. This may allow data to be “intelligently” introduced to a selected point in the telecommunications network for onward delivery to their destinations. This may advantageously reduce the message volume, and so reduce congestion, on the SS7 layer of the telecommunications network.

The data preferably comprises SMS messages, but other types of message or data may be transferred between components in the telecommunications network. For example, multimedia messages, or voice messages may be transmitted. Control messages which act to set up voice calls between components, or the data which comprises the voice calls themselves, may also be transmitted using the apparatus and methods described herein. Other data may also be transmitted between components in the telecommunications network using the apparatus and methods described herein, for example an item of data such as an address book entry could be sent between mobile telephone handsets connected to the network. Messages sent over 2.5G or 3G networks could also be intercepted and transferred to their destinations according to the apparatus and methods described herein. Incorporation of the present system into a network other than an SS7 mobile telecommunications network is described in more detail below.

Preferably, at least one of the connections to the first and second telecommunications components is bidirectional and the apparatus further comprises means for receiving data via the first or second connection. Hence data may be both received from the telecommunications network and delivered to the telecommunications network.

Further preferably, the data may be received via the first or second connection and the data may be delivered into the telecommunications network via a selected one of the first or second connections. Hence data received via one connection may be “intelligently” delivered back to the telecommunications network for onward delivery to their destinations.

Preferably, the apparatus further comprises means for connecting to at least a third telecommunications components via a connection separate from the telecommunications communication protocol link. Using a plurality of separate connections may advantageously allow data to be delivered into the telecommunications network at a selected one of many points.

Preferably, the connection via which the data is delivered into the telecommunications network may be selected according to information extracted from the data. Hence the or each item of data may be introduced to the telecommunications network at the most suitable point for that item of data.

According to a particularly preferable embodiment, the means for connecting to at least one telecommunications component comprises a connection via a message delivery component, which processes data for transmission between a component in the telecommunications network and transmits at least a portion of the data over the connection separate from the telecommunications communication protocol link. Initial processing at the message delivery component may mean that it is not necessary to transmit all of the data over the separate connection. Instead, the important information may be extracted and transported over the separate connection without, for example, the overheads associated with the SS7 protocol also being transported over the separate connection.

Preferably, the message delivery components are interconnected over connections separate from the telecommunications communication protocol link. This may advantageously allow data to be transmitted directly between message delivery components without passing through the telecommunications network or through a central control point on the network of separate connections.

A further preferable feature is that the data may be received from a component in the telecommunications network over an SS7 connection. This may provide the advantage that an embodiment of the present invention may be incorporated into a prior art telecommunications network without the need for significant modifications to the existing infrastructure.

According to a further preferable feature, at least one message delivery component receives data from more than one component in the telecommunications network. This may reduce the number of message delivery components required to implement an embodiment of the system and may be advantageous, particularly when components of the telecommunications network are located close to each other.

Preferably, the connections separate from the telecommunications communication protocol link are Internet Protocol (IP) connections. Using IP connections may allow data to be efficiently and reliably transmitted between components over the separate connections.

Preferably, at least some of the plurality of telecommunications components comprise switches in the telecommunications network. This may allow data to be intercepted as they enter the telecommunications network so that they may be offloaded at the earliest opportunity and to be reintroduced to the telecommunications network at points close to their final destination entities.

According to a further preferable feature, the data is passed between the plurality of telecommunications components without passing through an Short Message Service Centre (SMSC) of the telecommunications network. A further preferable feature is that the data is passed between the plurality of telecommunications components without passing through an Signalling Transfer Point (STP) of the telecommunications network. Implementation of these features may reduce congestion on the telecommunications network at points that, in the prior art, may become particularly heavily congested when the network is busy.

Preferably, the message is passed to a message handling component, such as an SMSC or AMSC, to allow storage of the message.

Preferably, the apparatus further comprises a location register. This may allow location information corresponding to destination entities of the data to be obtained over the separate network, which may further reduce congestion on the telecommunications network.

Preferably, the location register provides location information for globally unique identifiers corresponding to applications connected to the telecommunications network. This may allow data to be routed to applications attached to the telecommunications network from mobile entities within or outside the home operator's network.

Preferably, the apparatus further comprises a message handling component which comprises means for obtaining information relating to mobile entities or applications connected to the telecommunications network. The message handling component may provide a central point in the network which may obtain information requested by the message delivery components.

More preferably, the message handling component may provide an interface between the telecommunications network and the applications for which location information is stored in the location register. Hence the message handling component may provide an efficient and practicable means by which applications can connect to the telecommunications network.

Preferably, at least one of the connections separate from the telecommunications communication protocol link is to a Gateway Mobile Switching Centre (G-MSC) in the telecommunications network. This may allow the immediate offload from the telecommunications network of traffic entering the network from other operator's networks (off-net traffic). In a typical prior art telecommunications network, this off-net traffic accounts for a large proportion of the data within the network, so congestion within the network may be significantly reduced by offloading this traffic at the G-MSCs, as it enters the network.

Preferably, at least one of the connections separate from the telecommunications communication protocol link is to a Mobile Switching Centre (MSC) in the telecommunications network. This may allow further offload of data from the telecommunications network. Both on-net traffic generated by mobile entities connected to the home operator's network and traffic destined for mobile entities connected to the home operator's network may be offloaded, further reducing congestion on the SS7 layer of the home operator's network.

Taken in conjunction, the previous two features may maximise the ability of the system to offload data from the telecommunications network and hence reduce congestion on this network.

According to a further aspect, there is provided apparatus for transferring information from an item of data in a telecommunications network to a message handling component comprising:
means for receiving the data from the telecommunications network and terminating the data;
means for processing the received data to extract at least a portion of the content of the data;
means for sending the extracted portion of the content of the data to a message handling component over a network that utilises a protocol other than the telecommunications protocol.

Since the data may be terminated by this component of apparatus, the data itself does not need to be transferred through the separate network, to the message handling component. The system is more efficient then, since only the portion of the data necessary to obtain the required routing information may be sent across the separate network. This may allow the data itself to travel the minimum distance necessary both over the telecommunications network and over the separate network to its destination, since the data may be stored by the apparatus until information corresponding to its destination has been obtained. A central message handling component may be used to obtain the necessary information for each item of data on behalf of each piece of apparatus. This means that the apparatus that receives the data does not have to obtain the necessary information itself. Hence, the receiving apparatus does not have to comprise means to access the data itself from the relevant network components or, alternatively, does not need to store the information corresponding to destination addresses itself. This may allow the receiving apparatus to be simpler, smaller and cheaper than it otherwise would be, making the system more efficient and easier to implement in an existing telecommunications network. In addition, since the information is requested over the separate network, for example, over a fast IP link, the information may be sent quickly between the message handling component and the receiving apparatus without causing congestion on the SS7 layer of the telecommunications network and without causing significant delay to the onward transmission of the data. Also, this implementation of the system may allow pre-existing technology to be utilised, for example, the Home Location Register (HLR) of the pre-existing telecommunications network may be used by the message handling component to provide location information.

Preferably, the apparatus further comprises a distributed software system, wherein the distributed software system is also run on the message handling component. Hence both the apparatus for transferring information in an item of data to a message handling component and the message handling component itself may be controlled by the same distributed software, which may be run over a plurality of components. Using a distributed software system may be used to provide redundancy between the software and hardware components of the system.

Preferably, the apparatus further comprises means for receiving at least one piece of information from the message handling component, wherein the information is based on the extracted portion of the data content sent to the message handling component. The information received may allow further processing of the data and may allow the receiving apparatus to deal with the data in the most appropriate and efficient manner.

Preferably, the apparatus further comprises means for sending an extracted portion of the content of the data to a component in the telecommunications network according to the at least one piece of information received from the message handling component. Hence the data may be retained by the apparatus and not transferred over the network until information corresponding to its destination has been obtained. This may allow the data to be routed to a destination selected according to the information obtained.

Preferably, the means for processing the received data comprises means for extracting an identifier of the final destination of the data from the payload of the data. This advantageously allows the destination address to be determined without the data being reformatted as a mobile terminated message, which may allow the data to be routed to the destination address without passing through the message handling component of the telecommunications network. The capability of the apparatus to extract the destination address in this way is a highly preferable feature of the system, since it may facilitate ‘intelligent’ routing of the data from the point at which it enters the telecommunications network.

According to a further preferable feature, the extracted portion of the content of the data comprises the identifier of the final destination of the data extracted from the payload of the data. This may allow the message handling component to obtain information for the entity corresponding to the identifier of the final destination contained within the data. This may advantageously facilitate the further processing of the data.

Preferably, the information received from the message handling component comprises at least one of:
location information for the destination entity corresponding to the identifier of the final destination of the data;
availability information for the destination entity corresponding to the identifier of the final destination of the data;
International Mobile Subscriber Identity (IMSI); and
prepaid credit information.

Hence the apparatus may be provided with of the information necessary to route the data to its destination address.

Preferably, at least one item of data is received from a Gateway Mobile Switching Centre (G-MSC) of the telecommunications network. Preferably, at least one item of data is received from a Mobile Switching Centre (MSC) of the telecommunications network. As discussed above, both of these preferable features may maximise the ability of the system to offload data from the SS7 layer of the telecommunications network.

Preferably, the means for sending the extracted portion of the content of the data to a component in the telecommunications network comprises means for sending the at least a portion of the content of the data over a selected one of the telecommunications communication protocol link or over a network separate to the telecommunications network. Selection of the network used may allow the at least a portion of the content of the data to be routed to its destination in the most efficient manner.

Preferably, the network is selected according to at least one predetermined condition. More preferably, the at least one predetermined condition comprises at least one of:
the identifier of the final destination of the data extracted from the data payload;
the at least one piece of information requested from the message handling component;
an identifier of the mobile entity which originated the data;
an identifier of the home SMSC for the data.

The availability information or the location information obtained from the message handling component may advantageously be used to select the appropriate network over which to forward the data portion (for example, the message switching centre to which the destination mobile entity is attached may not have a corresponding message delivery component, so it may be advantageous to deliver this data over the SS7 layer of the telecommunications network.) Selection based on the originators identity or the SMSC identifier may allow only data originated by mobile entities belonging to the home operator's network to be offloaded onto the separate network (data originated by roaming users may not be offloaded). Finally, offloading according to the destination address of the data may allow only data destined for certain entities to be off-loaded, for example, only data destined for mobile entities on other operator's networks.

According to a further aspect, there is provided apparatus for transferring information from data in a message handling component to a telecommunications network comprising:
means for receiving at least a portion of the content of data over a network that utilises a protocol other than the telecommunications communication protocol;
means for generating data based on the content of the data received;
means for sending the generated data to a component within the telecommunications network.

The apparatus may allow the data to be transmitted to its destination entity within the telecommunications network. This may be a mobile telephone or an application connected to the telecommunications network, or the data may be transferred to a G-MSC and on to a telecommunications network of a second operator.

Preferably, the apparatus further comprises a distributed software system, wherein the distributed software system is also run on the message handling component.

Preferably, the at least a portion of the content of the data comprises an identifier of the final destination of the data. This may allow the apparatus to identify the destination entity for onward transmission of the data.

According to one preferred feature, the generated data is sent to a Gateway Mobile Switching Centre (G-MSC) within the telecommunications network. According to a further preferred feature, the generated data is sent to a Mobile Switching Centre (MSC) within the telecommunications network. Similarly to the offload of data from the telecommunications network discussed above, delivery of the data to these components may allow the data to be transferred to its destination in the most efficient manner, and transfer of the data over the telecommunications network may be minimised at the delivery end as well as the offload end.

A further aspect provides a method of delivering data between a plurality of telecommunications components in a telecommunications network, the plurality of telecommunications components in the telecommunications network being interconnected over a telecommunications communication protocol link, the method comprising:
connecting to a first telecommunications component via a first connection separate from the telecommunications communication protocol link;
connecting to a second telecommunications component via a second connection separate from the telecommunications communication protocol link;
selecting one of the first and second components as an introduction point for the data;
delivering the data into the telecommunications network via the selected one of the first and second connections.

The advantages of this method aspect, and its preferred features, correspond to the advantages for the similar apparatus aspects and preferred features outlined above.

Preferably, at least one of the connections to the first and second telecommunications components is bidirectional and the method further comprises receiving data via the first or second connection.

Preferably, the data may be received via the first or second connection and the data may be delivered into the telecommunications network via a selected one of the first or second connections.

Preferably, the method further comprises connecting to more than two telecommunications components via connections separate from the telecommunications communication protocol link.

Preferably, the method further comprises selecting the connection via which the data is delivered into the telecommunications network according to information extracted from the data.

According to a further preferable feature, connecting to each telecommunications component comprises connecting via a message delivery component, which processes data received from a component in the telecommunications network and transmits at least a portion of the data over the connection separate from the telecommunications communication protocol link.

Preferably, the message delivery component receives the data from the component in the telecommunications network over an SS7 connection.

Preferably, at least some of the plurality of telecommunications components comprise switches in the telecommunications network.

According to a further preferable feature, the data is passed between the plurality of telecommunications components without passing through a Short Message Service Centre (SMSC) of the telecommunications network. A further preferable feature is that the data is passed between the plurality of telecommunications components without passing through a Signalling Transfer Point (STP) of the telecommunications network.

Preferably, the message is passed to a message handling component, such as an SMSC or AMSC, to allow storage of the message.

Preferably, at least one of the telecommunications components is a Gateway Mobile Switching Centre (G-MSC) of the telecommunications network. Preferably, at least one of the telecommunications components is a Mobile Switching Centre (MSC) of the telecommunications network.

A further aspect provides a method of transferring at least one item of data between components in a telecommunications network, the method comprising:
receiving the data from a first component in the telecommunications network;
parsing the data payload to determine destination information for the data;
routing the data to a second component in the telecommunications network based on the destination information determined.

The advantages of the present aspect and its preferable features are outlined above with the corresponding apparatus aspects.

Preferably, the data is transferred between the components in the telecommunications network without passing through a Short Message Service Centre (SMSC) of the telecommunications network. Preferably, the data may also be transferred between the components in the telecommunications network without passing through a Signalling Transfer Point (STP) of the telecommunications network.

Preferably, the message is transferred between the components in the telecommunications network without being transferred into a memory for storage.

Preferably, the method further comprises obtaining at least one piece of information corresponding to the destination information determined for the data. More preferably, the at least one piece of information comprises at least one of:
location information for the destination entity corresponding to the destination information determined for the data;
availability information for the destination entity corresponding to the destination information determined for the data;
International Mobile Subscriber Identity (IMSI); and
prepaid credit information.

More preferably, the at least one piece of information is obtained from a message handling component over a network separate from the telecommunications network.

A further preferable feature provides that the message is transferred between the components in the telecommunications network over a communication link other than a telecommunications communication protocol link.

Preferably, the data is transferred over a network selected from the telecommunications network and a network other than the telecommunications network and wherein the network is selected depending on at least one predetermined condition.

More preferably, the at least one predetermined condition comprises at least one of:
the destination information extracted from the data payload;
the at least one piece of information requested from the message handling component;
an identifier of the mobile entity which originated the data;
an identifier of the home SMSC for the data.

Preferably, the first and second components in the telecommunications network are message switching centres.

Preferably, the data is routed across the separate network to the connection to the telecommunications network that is closest to the destination entity of the data. This may allow data to be routed efficiently to their destinations and to be routed the minimum possible distance over the telecommunications network.

Preferably, the data is routed to a selected second component in the telecommunications network, the second component being selected according to at least one predetermined condition.

More preferably, the at least one predetermined condition comprises at least one of:
the availability of the second component of the telecommunications network;
the geographical distance or the distance over the network of the second component of the telecommunications network from the destination entity;
the availability of the message delivery component to which the second component is connected;
the geographical distance or the distance over the network between the destination entity and the message delivery component to which the second component of the telecommunications network is connected.

The use of predetermined conditions such as those listed above may again aid in allowing efficient delivery of items of data to their destinations. Load balancing between components and the use of geographical or network distances to decide the components via which the data may be sent may allow efficient delivery of data. This preferable feature may also allow the system to select advantageously the point at which the data is transferred from the separate network to the telecommunications network.

According to a further preferable feature the data is routed to a message handling component if the entity corresponding to the destination address is not available or is not able to receive the data when the at least one piece of information is obtained. This provides the advantage that the message delivery components themselves do not require a large memory to store data which cannot be delivered immediately.

According to one feature of this aspect, the data may be routed to the message handling component over the telecommunications network. Hence data may be returned to the telecommunications network if it is not possible to route them to their destinations immediately. This may allow the system to take advantage of the preexisting functionality of the mobile telephone network to store the data and deliver it at a later time. Passing the data back to the telecommunications network may allow the functionality of the SMSC of the pre-existing system to be incorporated into the new system without modification.

According to a further preferable feature, the data may be routed to the second component in the telecommunications network according to specific instructions obtained from a routing table stored within the telecommunications network. This may allow specific routing rules to be entered into the routing table for the delivery of data to mobile entities or applications that receive a high volume of incoming traffic. This may increase the efficiency of data delivery to these entities.

A further aspect provides a message delivery component arranged as a component of a distributed system for controlling the routing of data between components in a telecommunications network, the message delivery component comprising:
means for connecting to the telecommunications network;
means for connecting, over a network separate to the telecommunications network, to at least one other such message delivery component;
means for connecting to a remote message handling component over the network separate to the telecommunications network;
processing means configured, on connection to the remote message handling component, to permit control of the message delivery component and destination lookup for data received by the message delivery component by the remote message handling component.

Since the message delivery component may be controlled by the remote message handling component, the message delivery component may be optimised. The message delivery component may be small and inexpensive, hence allowing it to be integrated into an existing telecommunications network at a plurality of points, but the message delivery component may also provide a large range of functionality, via an efficient connection to the remote message handling component. For example, destination lookup may be provided remotely at the message handling component, so the functionality (and hence the size and cost) of the message delivery component may be reduced, but data may be delivered efficiently to its destination, as if the message delivery component itself did have a destination lookup facility.

Providing an interconnected network of message delivery components may also provide software and hardware redundancy in the system. Software, for example software agents, may be distributed among the message delivery components and hardware redundancy may be introduced if one message delivery components may take over the functionality of another message delivery component which has failed or which is overloaded.

Preferably, the message delivery component further comprises means for requesting destination lookup from the remote message handling component for data received by the message delivery component. Hence data, such as destination data, may be actively requested by the message delivery component from the message handling component, when incoming data is received from the telecommunications network. This may allow data to be transmitted efficiently through the distributed system.

A further aspect provides a distributed system comprising:
a message handling component;
a plurality of message delivery components;
means for connecting the plurality of message delivery components to a telecommunications network;
means for interconnecting the plurality of message delivery components and the message handling component over a network separate to the telecommunications network;
and wherein:
the message handling component is arranged to control each of the plurality of message delivery components;
the message delivery components are each arranged to receive data from and deliver data to components within the telecommunications network;
the message handling component is arranged to perform a destination lookup for data received by the message delivery components.

As discussed above, providing a system of distributed message delivery components, along with a central message handling component, may optimise the efficiency of the data delivery system. The distributed system may allow the sophistication of the individual message delivery components to be reduced, whilst increasing the sophistication of the system as a whole.

The message handling component may perform other service functions for the message delivery components, in addition to or instead of the destination lookup function. Such service functions may include load balancing of data between the message delivery components, storage of data which cannot be directed immediately to its destination address, intelligent queueing of data waiting to be sent to its destination, prepaid credit lookup facilities, IMSI lookup facilities and delivery of messages to applications which may be connected to the telecommunications network via the message handling component.

Preferably, the components of the distributed system are interconnected using a ring architecture.

Preferably, the distributed system further comprises a plurality of software agents, wherein each software agent has a predefined function and wherein:
at least one software agent is arranged to execute on a message delivery component to control at least one function of the message delivery component;
at least one software agent is arranged to execute on the message handling component to provide a destination lookup facility for data received at a message delivery component.

Software agents may be distributed among components of the system to provide software redundancy to the system. Other software agents may also be implemented within the distributed system to provide further functionality, for example to provide the further functionality of the message handling component outlined above.

A further aspect provides a distributed system for controlling the routing of data between components within a telecommunications network, comprising:
a plurality of first portions arranged to control the receipt and delivery of the data to and from the telecommunications network and each providing an interface between the telecommunications network and a network separate to the telecommunications network;
a second portion arranged to control lookup of destination information for data received from the telecommunications network and communicating with the first portion over the network separate to the mobile telecommunications network.

A further aspect provides a software suite for controlling a distributed system outlined above, comprising:
a first portion to control the receipt and delivery of the data to and from the telecommunications network and arranged to execute on a message delivery component;
a second portion to control lookup of destination information for data received from the telecommunications network and arranged to execute on a message handling component.

A further aspect provides a data packet comprising data extracted from a message, the message being suitable for transfer between components of a telecommunications network, addressed from a message terminating component and to a message handling component arranged to process telecommunications network protocol compliant messages.

Preferably, the data packet is formatted for transfer over an IP network and the data extracted from the message includes the destination address, extracted from the payload of the message.

A further aspect provides a method of routing at least one message to its destination comprising routing the message based on the Mobile Application Part (MAP) layer. Preferably, the message is routed over an IP network. This may allow messages to be routed directly according to the destination address within the message payload rather than routing the message via a message handling component of the telecommunications network.

A further aspect provides a computer program or computer program product comprising instructions for implementing a method according to any of the preceding method aspects or any of their preferred features.

One embodiment of the present invention will now be described with reference to the following drawings in which:

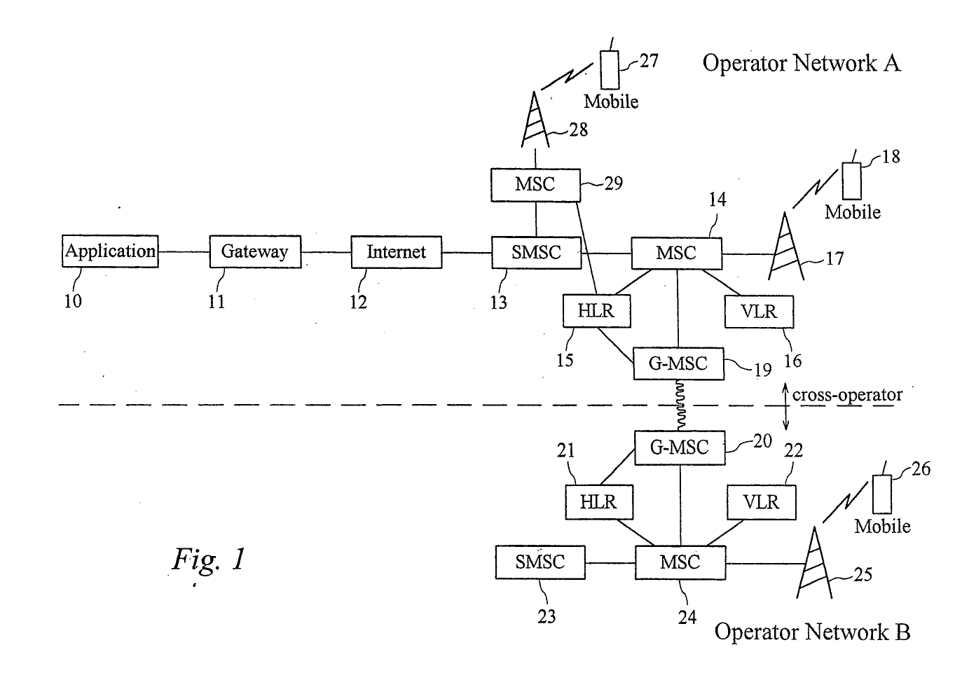

FIG. 1 is a schematic overview of a prior art SMS system operating over a GSM network;

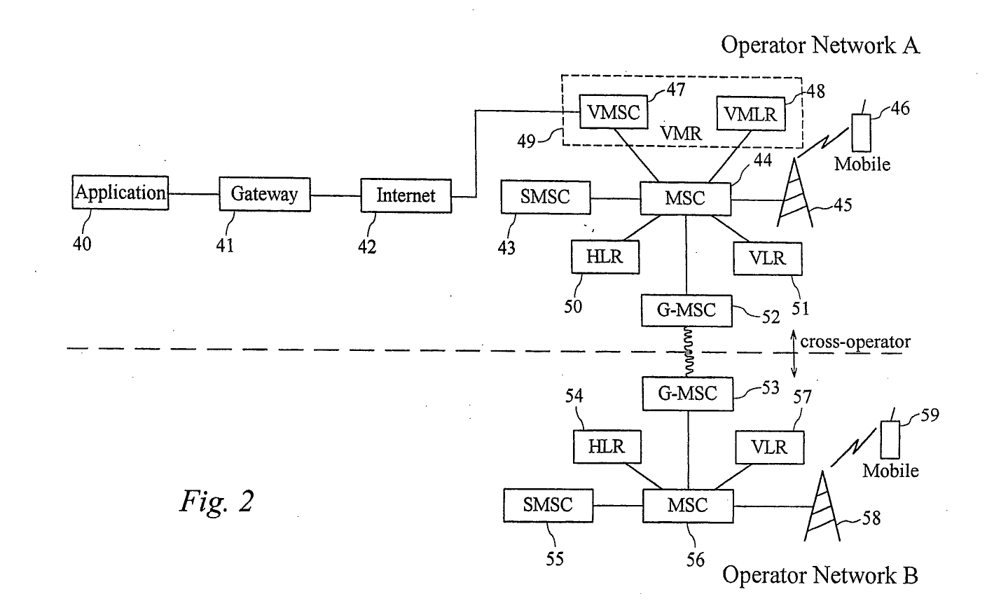

FIG. 2 is a schematic overview of an SMS system operating over a GSM network that incorporates one embodiment of the present system;

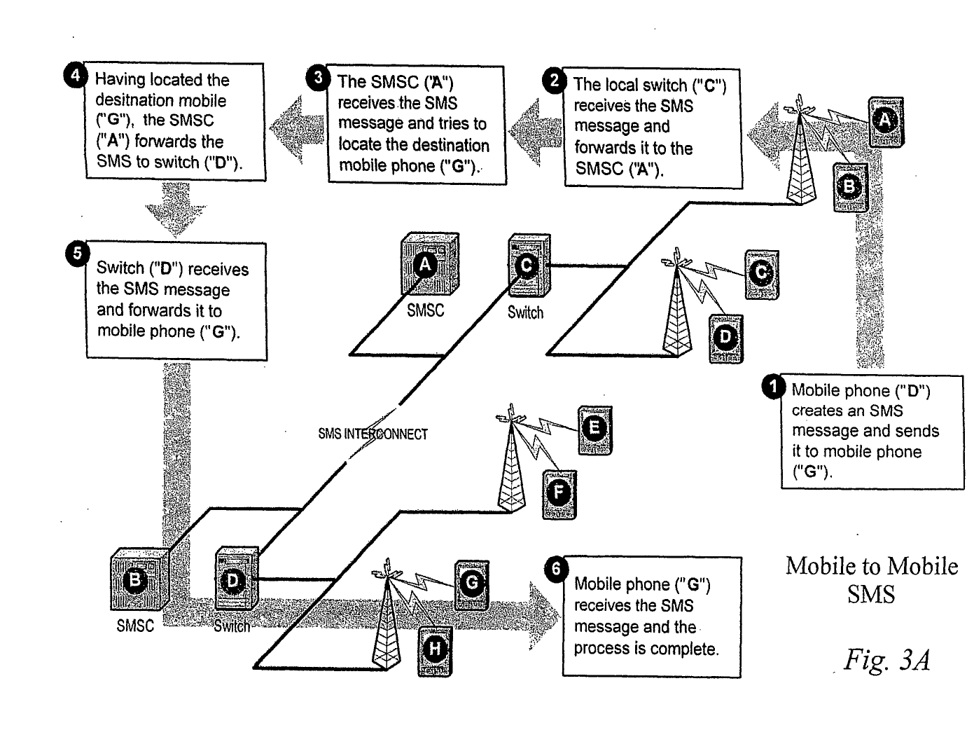

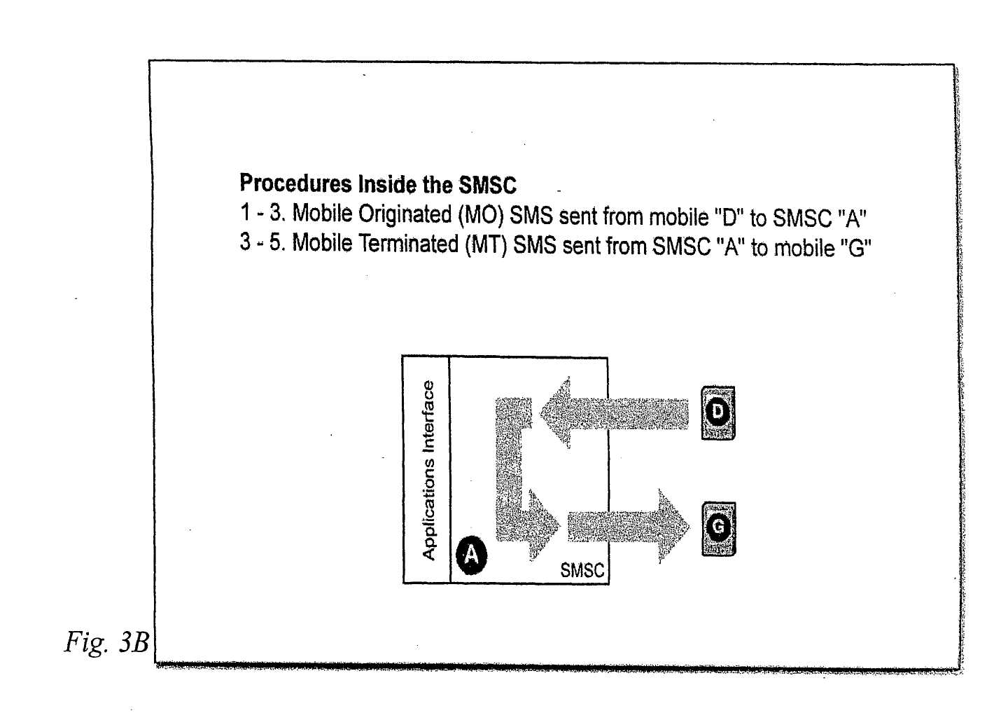

FIG. 3 is a schematic overview of the process of sending a mobile to mobile SMS message in a prior art GSM system;

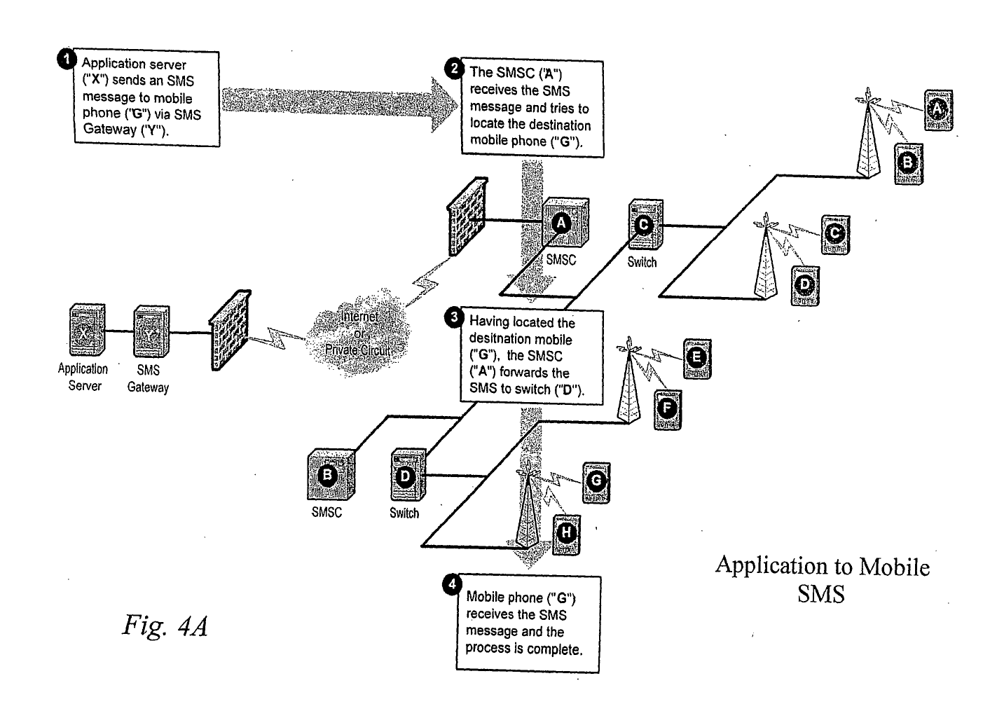

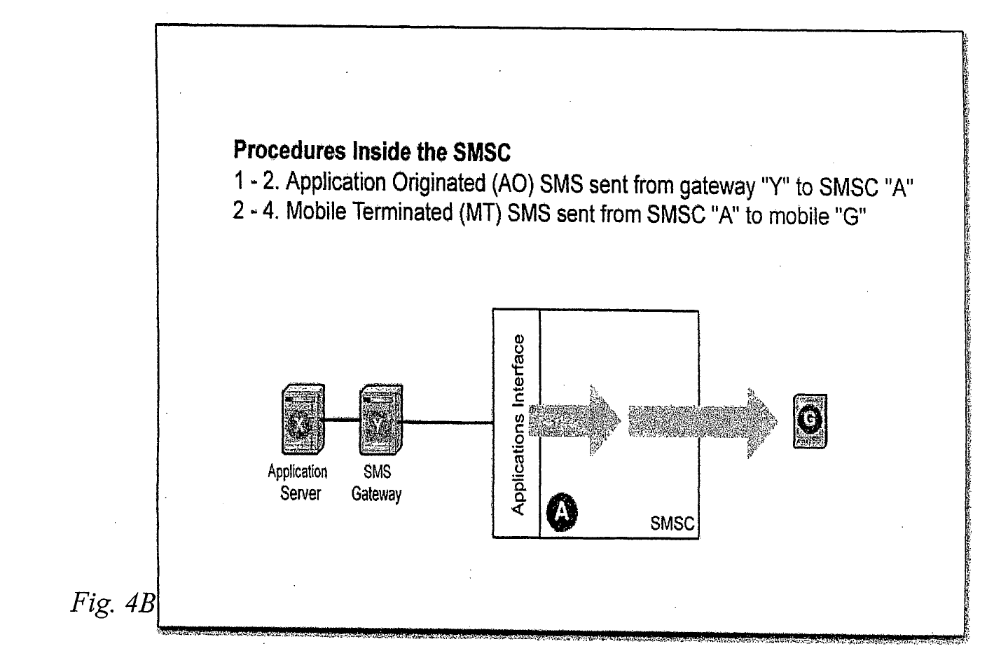

FIG. 4 is a schematic overview of the process of sending an application to mobile SMS message in a prior art GSM system;

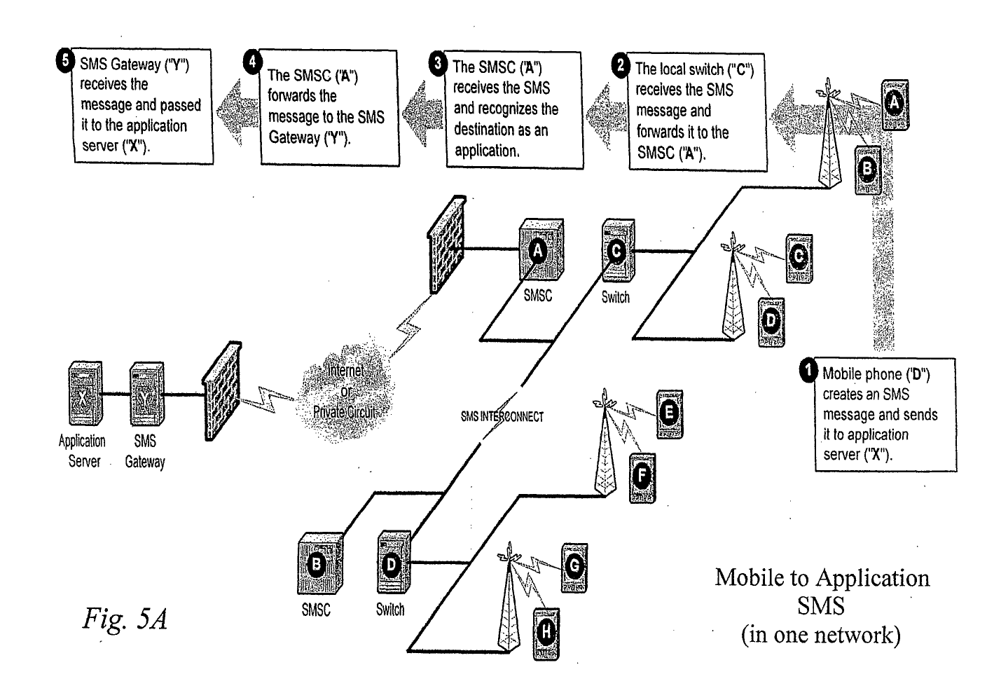

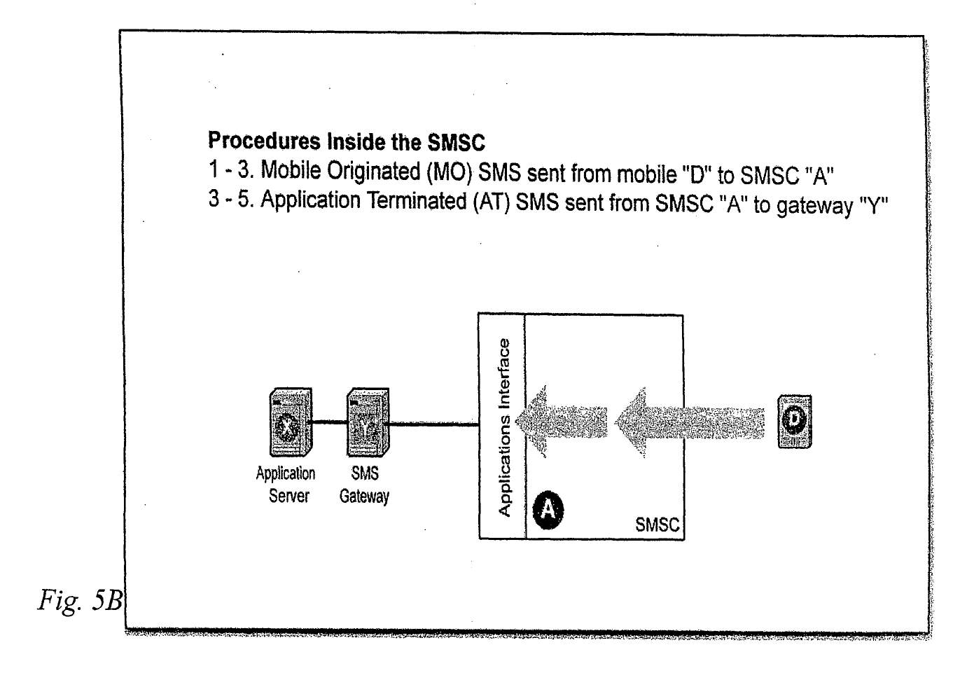

FIG. 5 is a schematic overview of the process of sending a mobile to application SMS message within one network in a prior art GSM system;

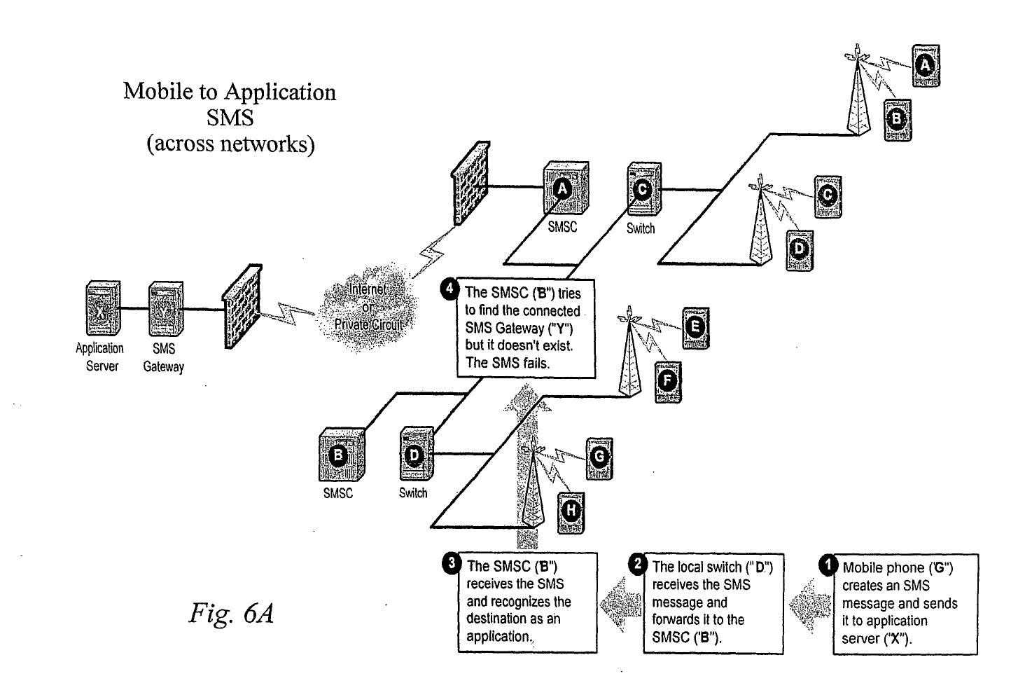

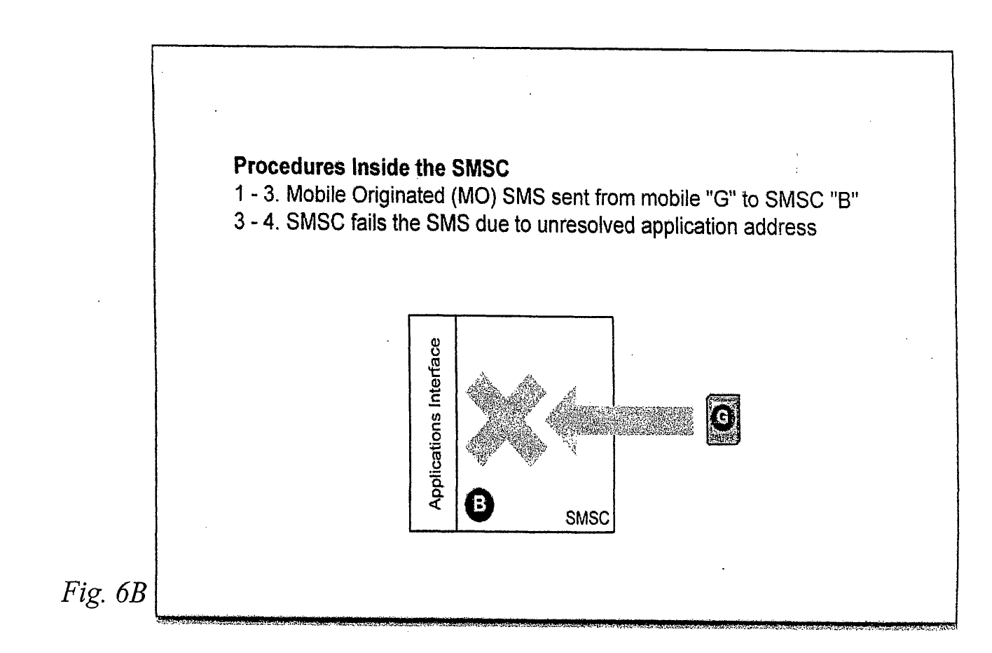

FIG. 6 is a schematic overview of the process attempting to send a mobile to application SMS message across networks in a prior art GSM system;

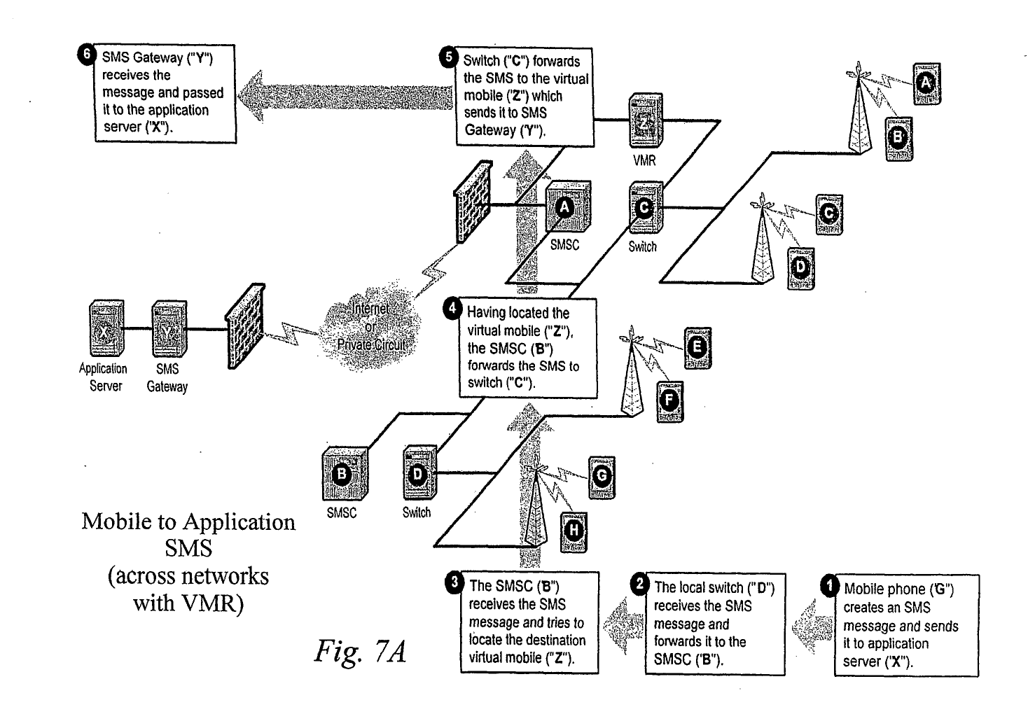

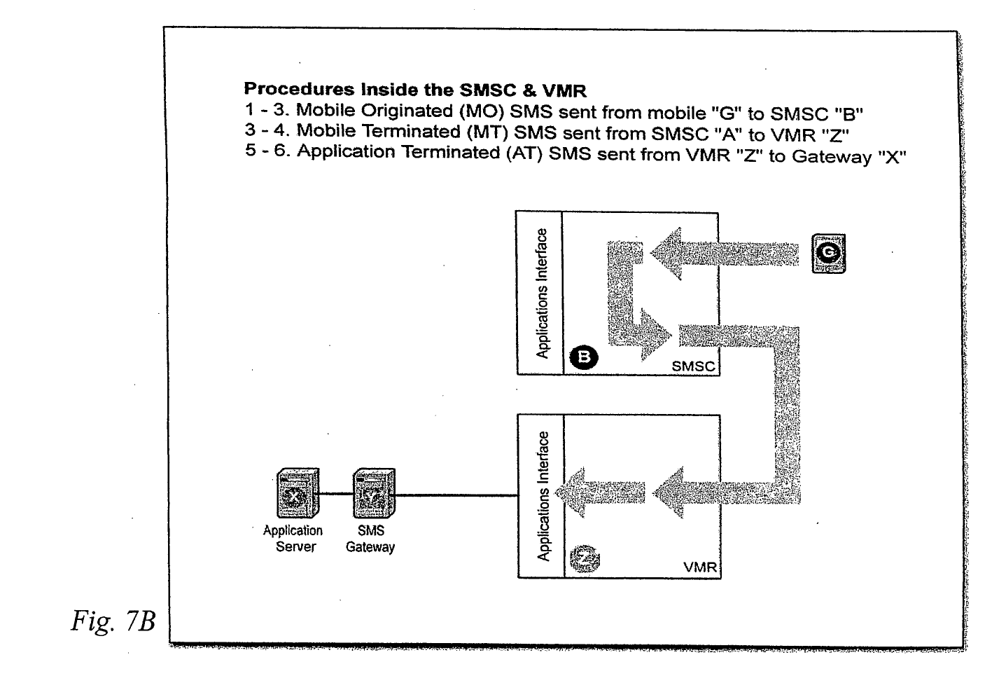

FIG. 7 is a schematic overview of the process of sending a mobile to application SMS message across networks in a GSM system that incorporates one embodiment of the present system;

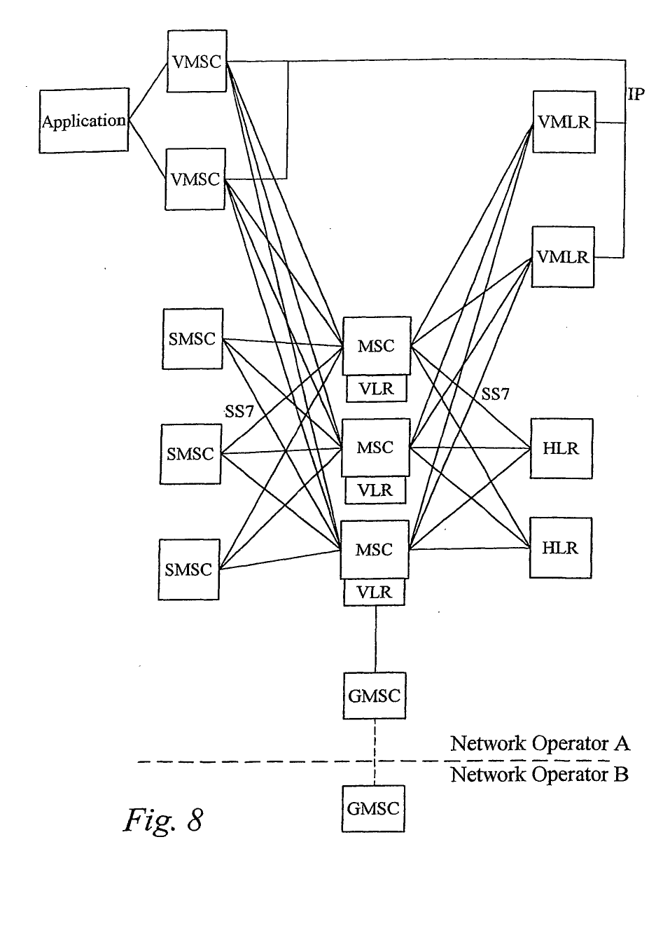

FIG. 8 is a schematic overview of one embodiment of the present system showing the communications channels used by different elements of the network;

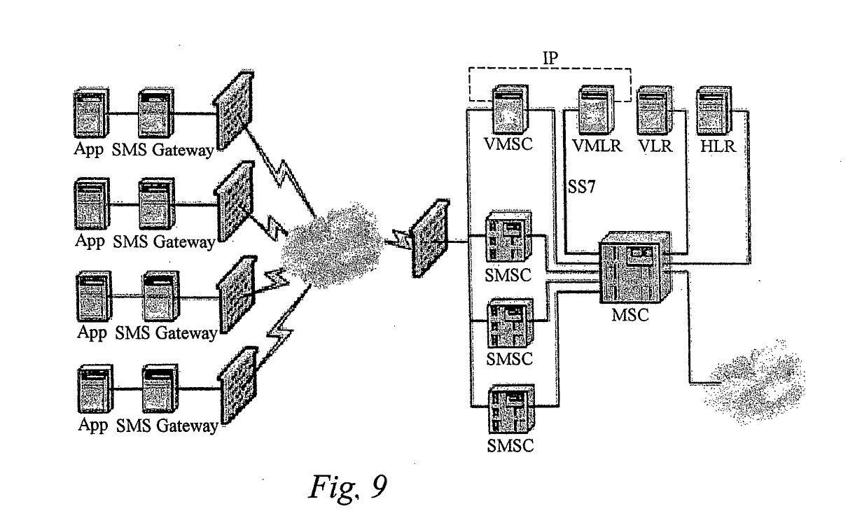

FIG. 9 is a schematic diagram showing how one embodiment of the present system might be incorporated into a prior art GSM network, with multiple applications connected;

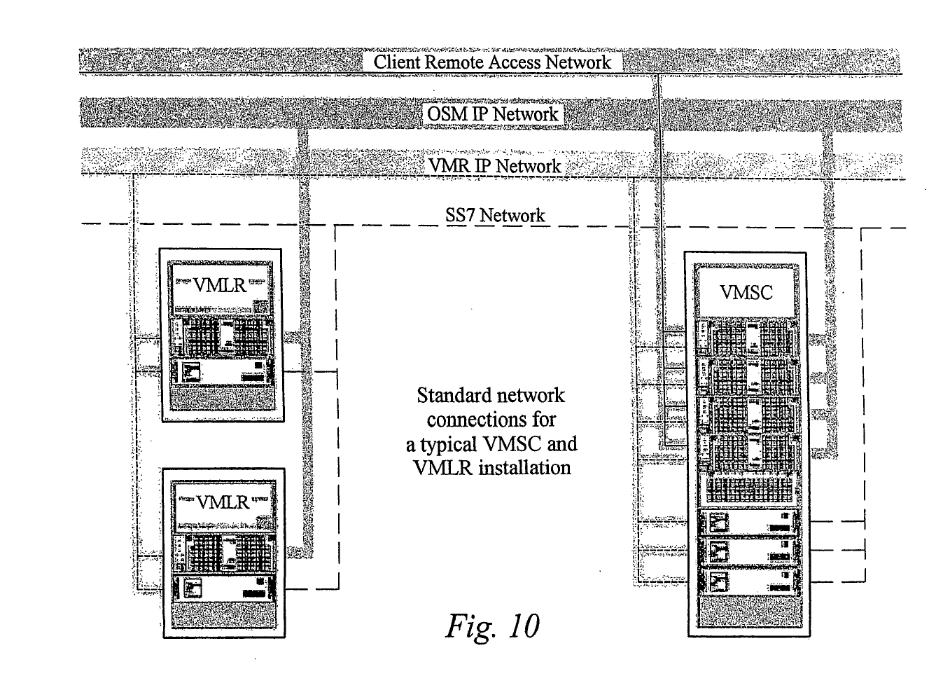

FIG. 10 is a schematic diagram showing the standard network connections of a typical VMSC and VMLR installation.

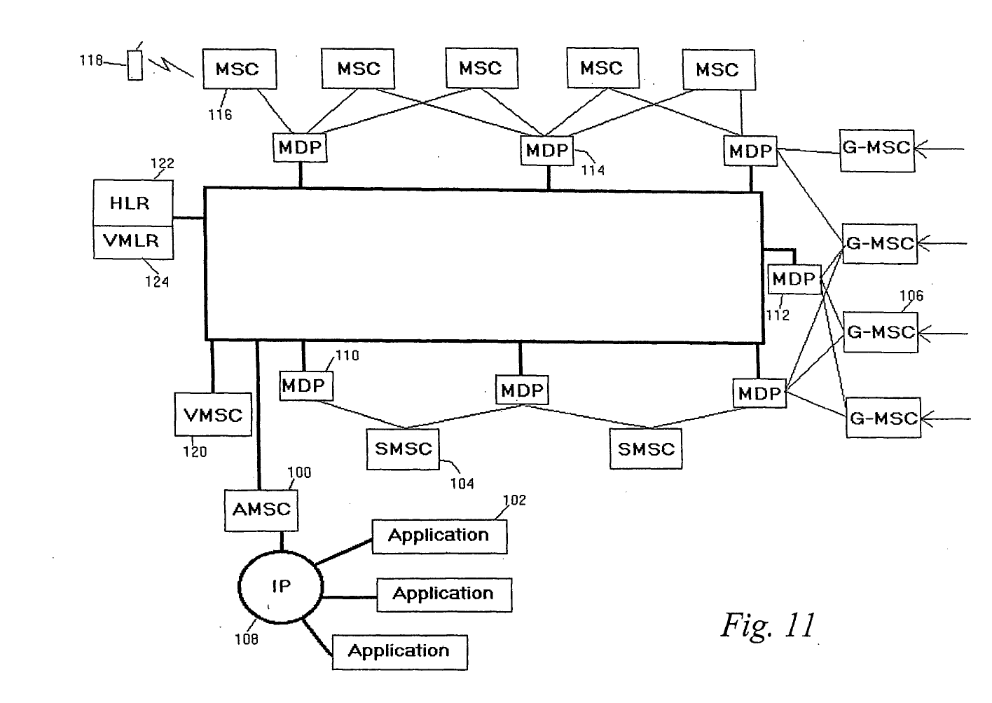

FIG. 11 is a schematic diagram showing one embodiment of the present system incorporated into a GSM network.

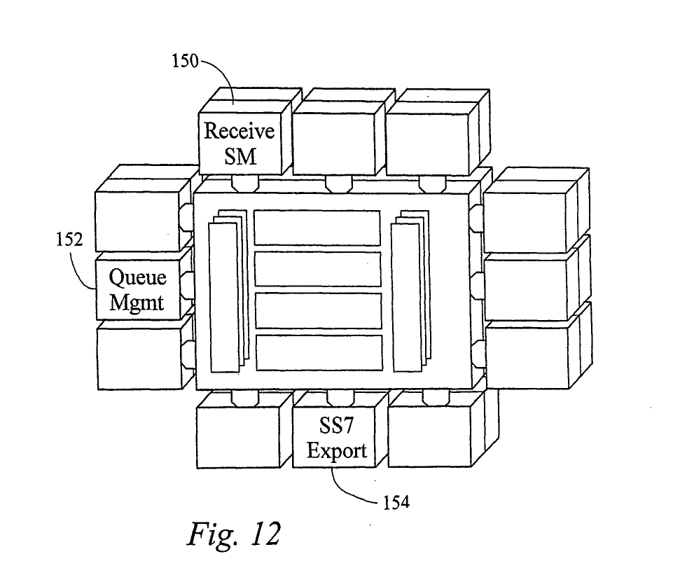

FIG. 12 is a schematic diagram showing the distributed architecture of one embodiment of the present system.

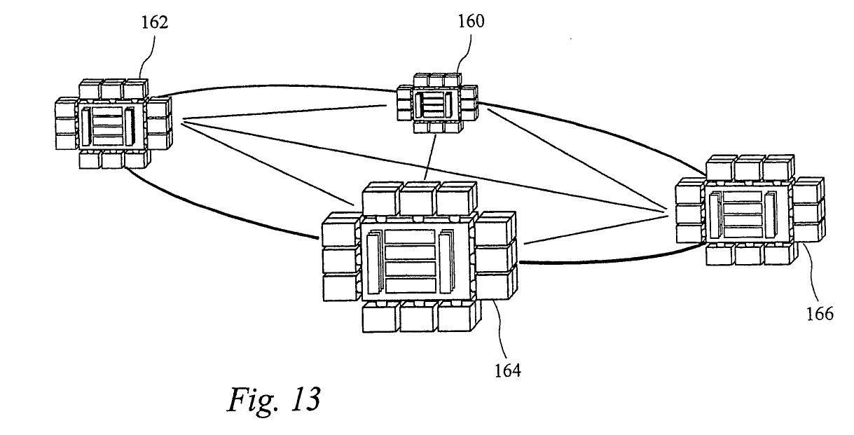

FIG. 13 is a schematic overview of a distributed network of apparatus according to one embodiment of the present system.

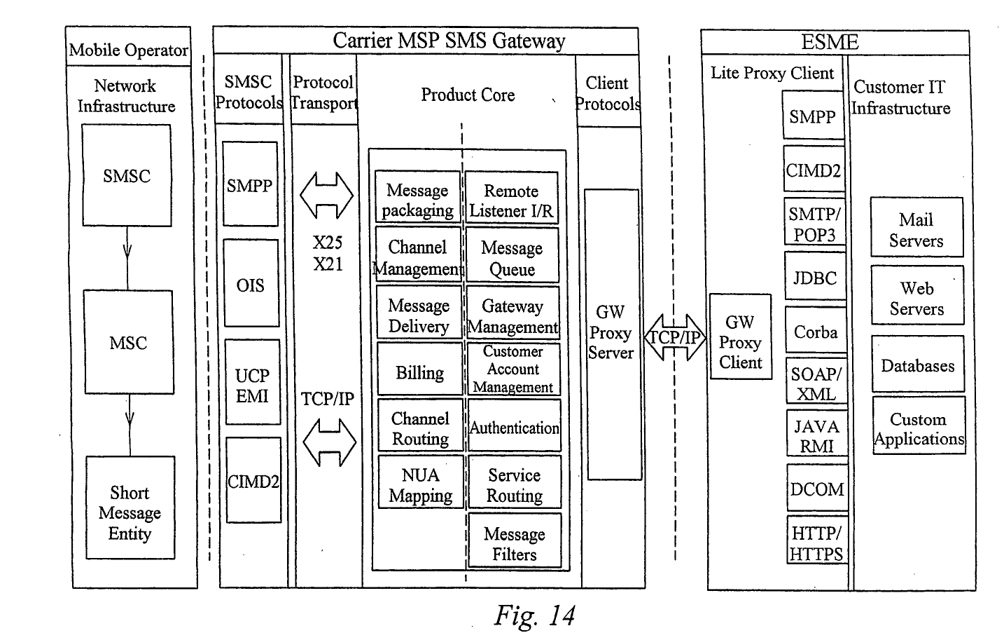

FIG. 14 is a schematic diagram of one embodiment of a gateway that may be used to connect the application to the mobile telecommunications network.

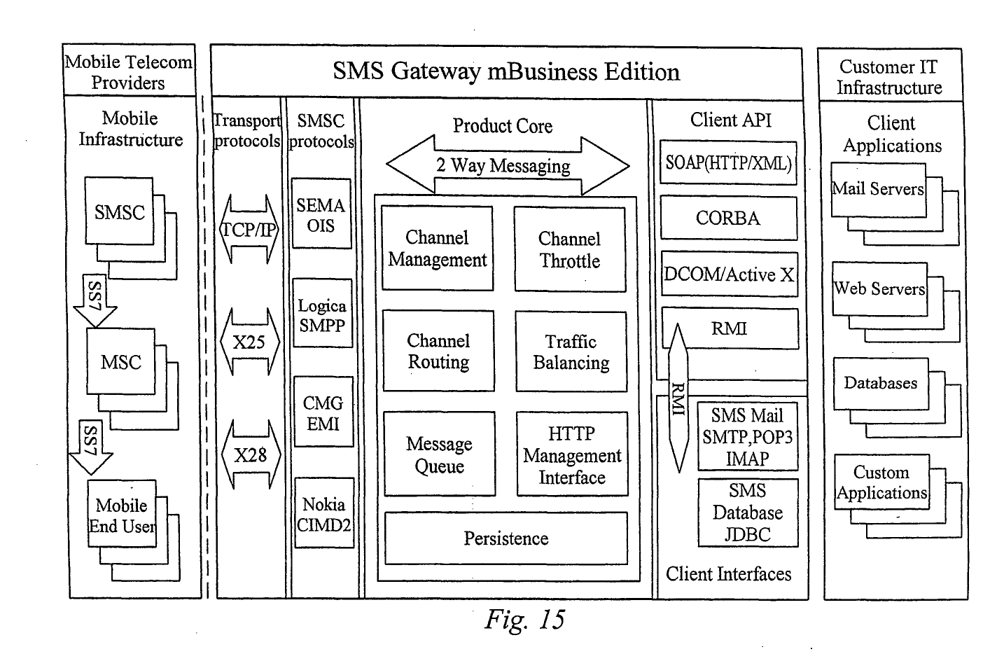

FIG. 15 is a schematic diagram of a second embodiment of a gateway that may be used to connect the application to the mobile telecommunications network;

FIG. 16 is a schematic diagram of one embodiment of a prior art telecommunications network within which SMS messages may be sent;

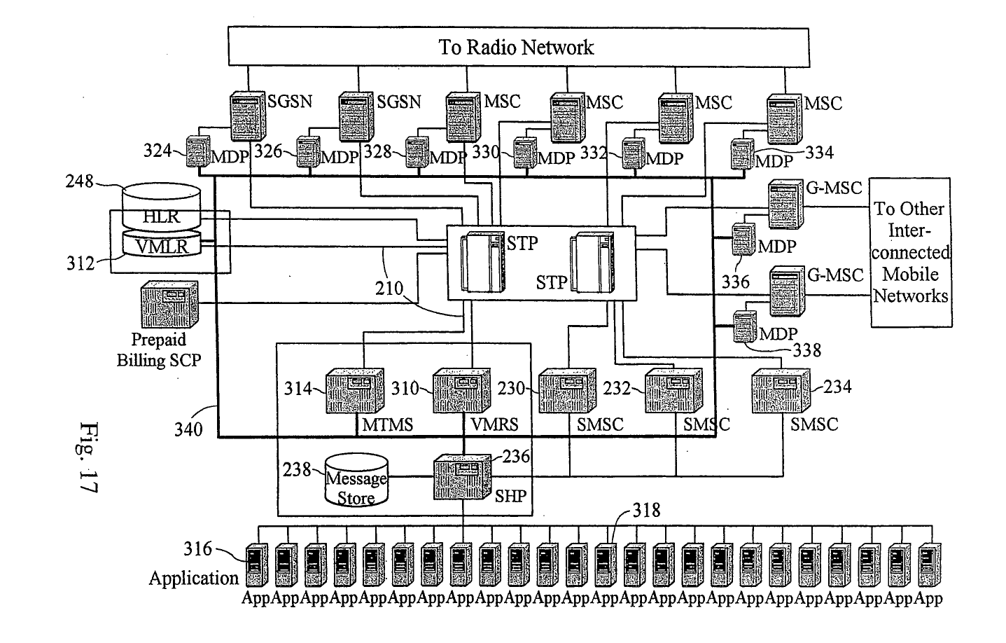

FIG. 17 is a schematic diagram of a distributed network of message delivery components incorporated into a prior art SMS messaging network according to one embodiment of the present invention;

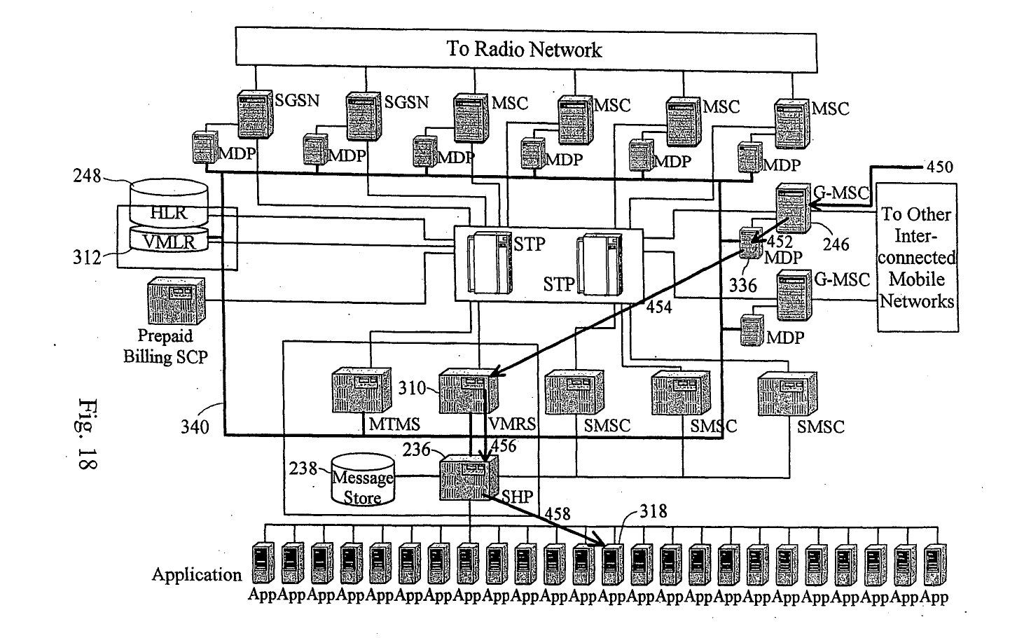

FIG. 18 is a schematic diagram illustrating the process of sending a message from an off-net mobile entity to an application according to one embodiment of the present invention.

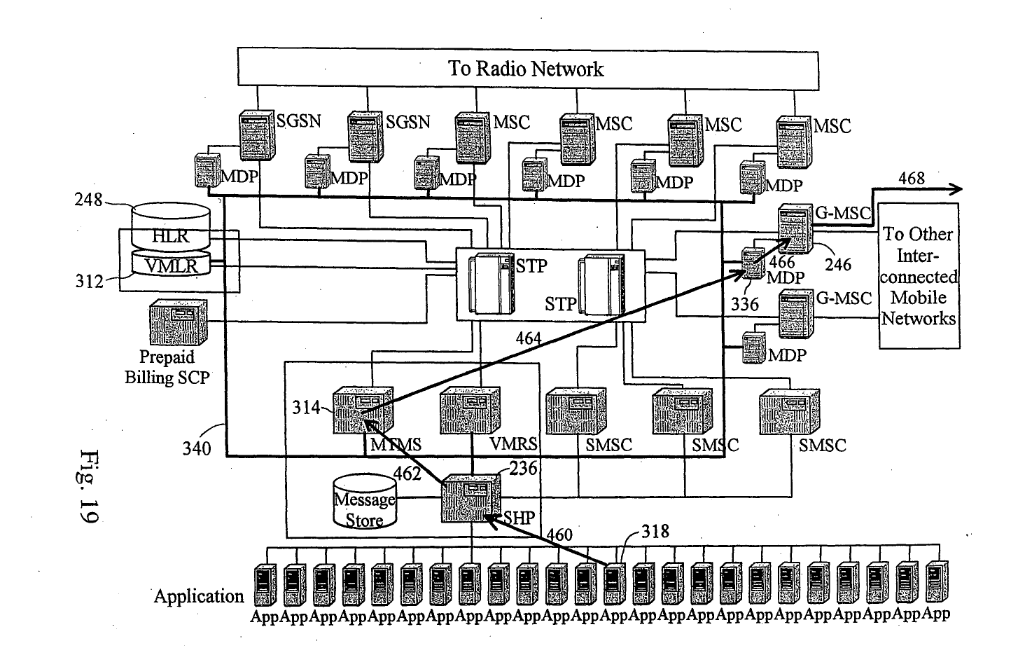

FIG. 19 is a schematic diagram illustrating the process of sending a message from an application to an off-net mobile entity according to one embodiment of the present invention.

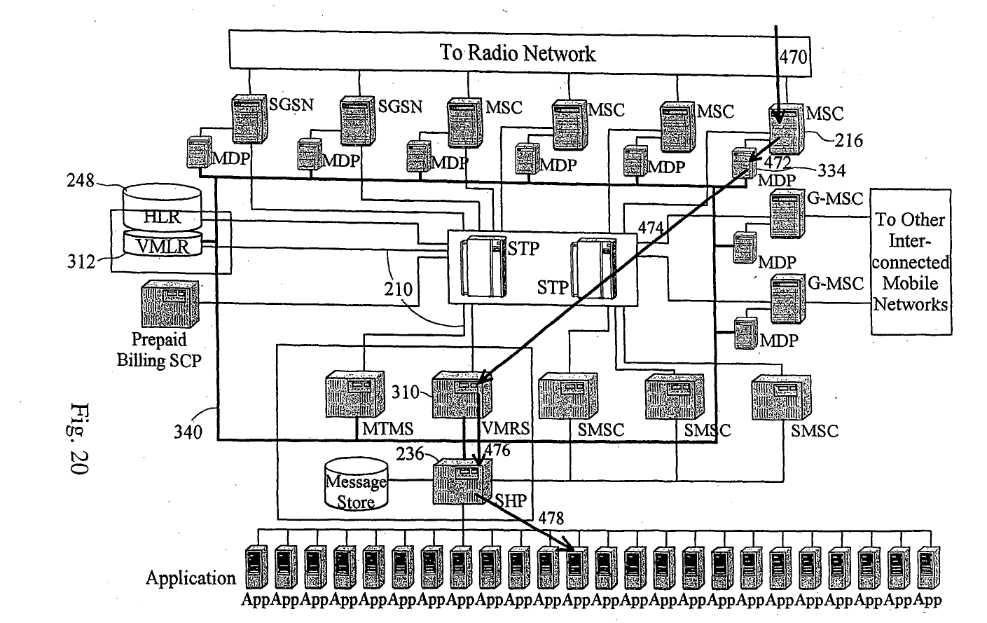

FIG. 20 is a schematic diagram illustrating the process of sending a message from an on-net mobile entity to an application according to one embodiment of the present invention.

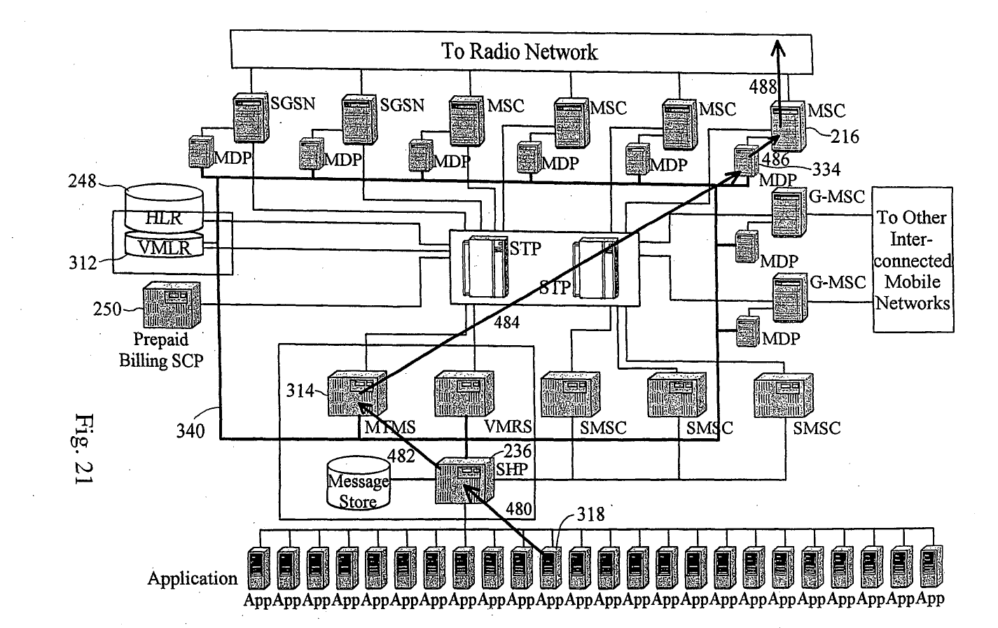

FIG. 21 is a schematic diagram illustrating the process of sending a message from an application to an on-net mobile entity according to one embodiment of the present invention.

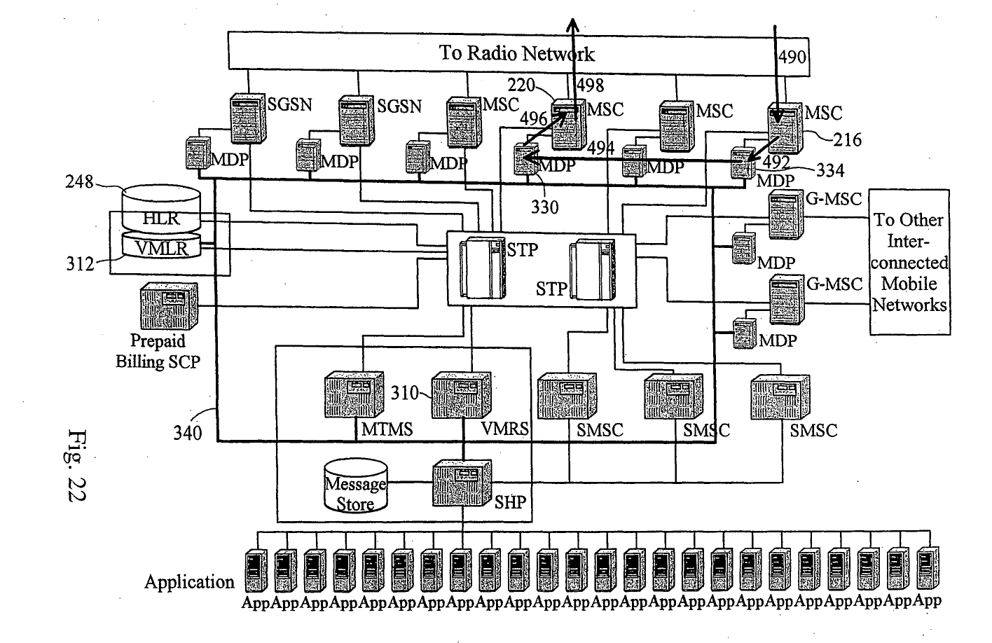

FIG. 22 is a schematic diagram illustrating a first process of sending a message between two on-net mobile entities according to one embodiment of the present invention.

FIG. 23 is a schematic diagram illustrating a second process of sending a message between two on-net mobile entities according to one embodiment of the present invention.

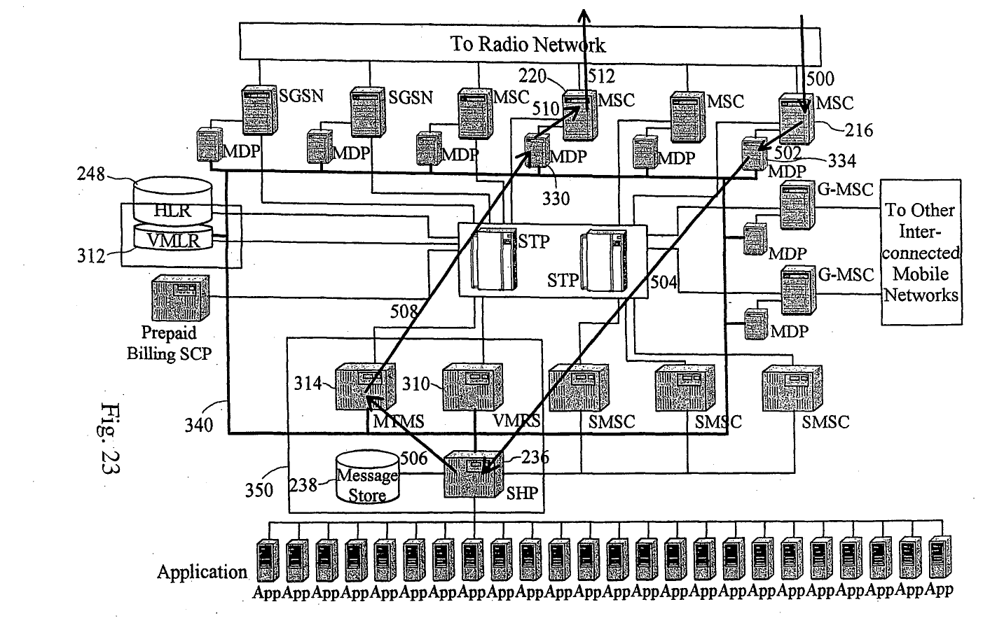

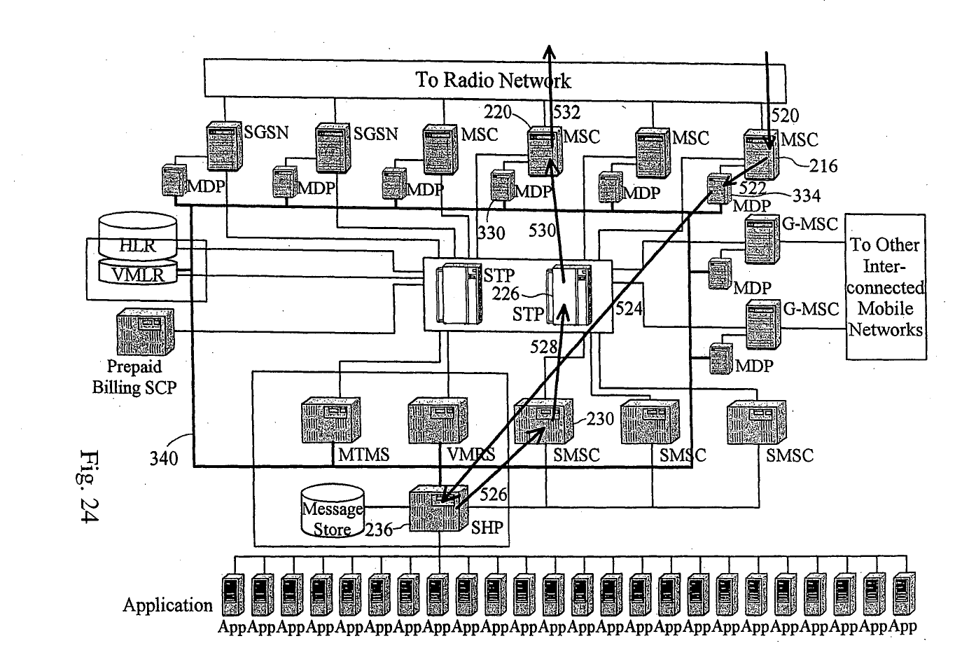

FIG. 24 is a schematic diagram illustrating a third process of sending a message between two on-net mobile entities according to one embodiment of the present invention.

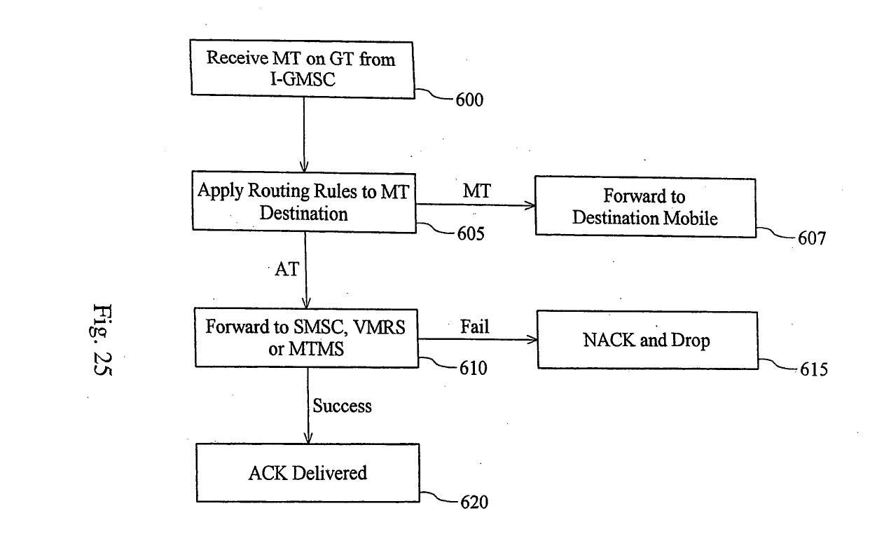

FIG. 25 is a schematic diagram illustrating a number of methods by which a mobile terminated message may be processed according to one embodiment of the present invention;

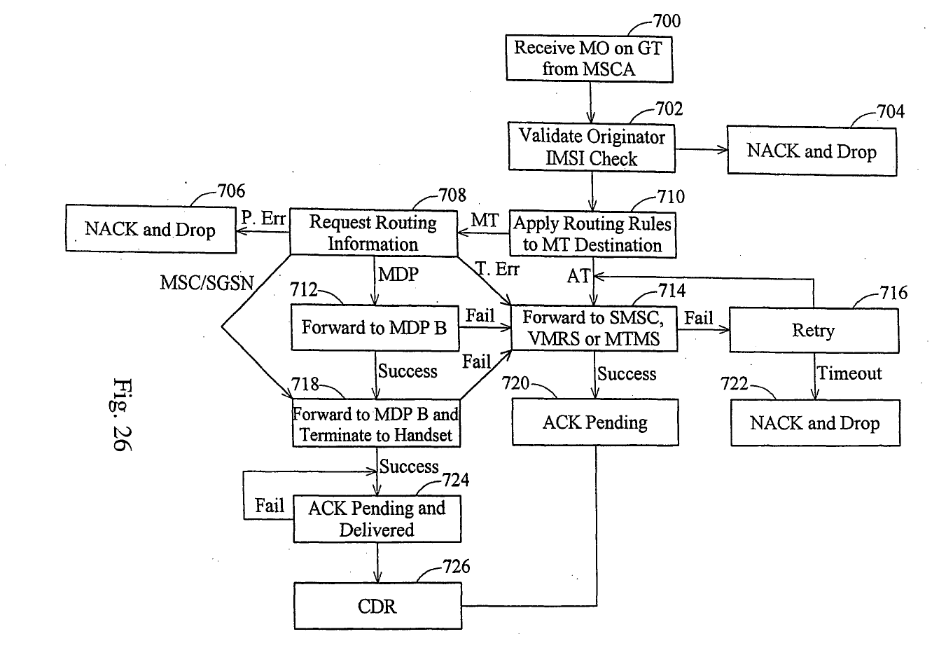

FIG. 26 is a schematic diagram illustrating a number of methods by which a mobile originated message may be processed according to one embodiment of the present invention;

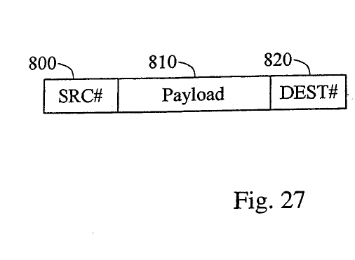

FIG. 27 illustrates the structure of an SMS message which may be sent within the telecommunications network.

FIG. 28a is a schematic diagram of protocol conversion for a prior art IP offload system.

FIG. 28b is a schematic diagram of protocol conversion according to one embodiment of the present invention;

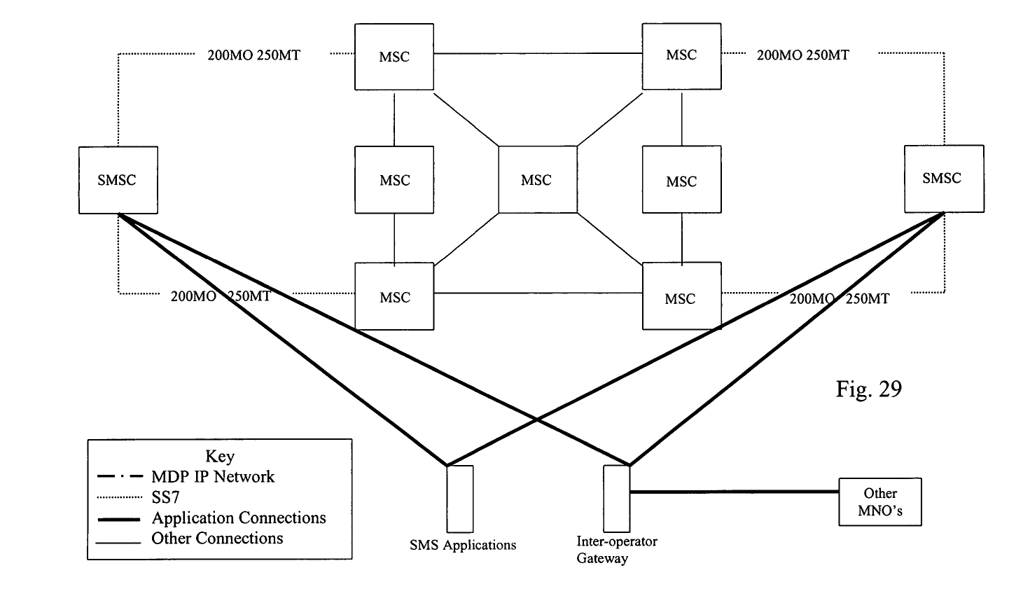

FIG. 29 is a schematic diagram of a medium sized mobile telecommunications network;

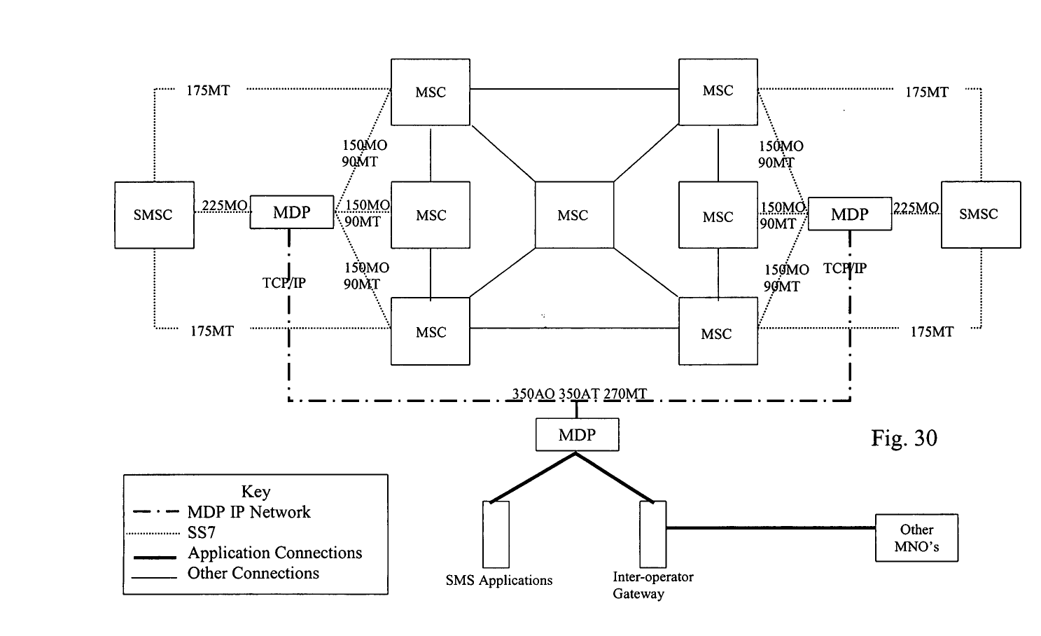

FIG. 30 is a schematic diagram of the mobile telecommunications network of FIG. 29, but with one embodiment of the MDP system incorporated into the network;

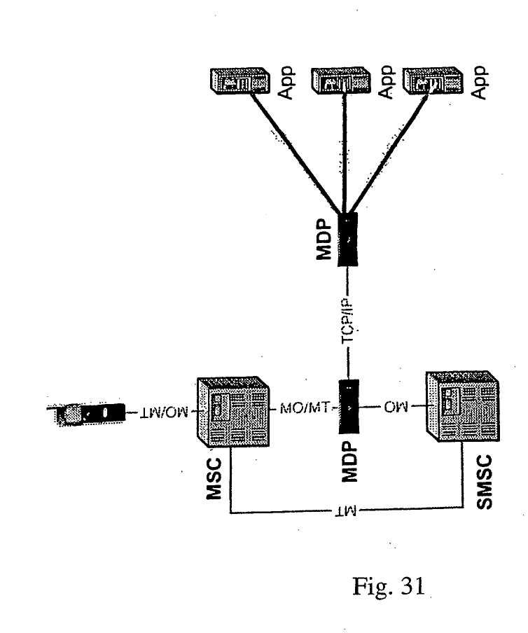

FIG. 31 is a schematic diagram of the location of MDPs within a mobile telecommunications network according to one embodiment of the system described herein;

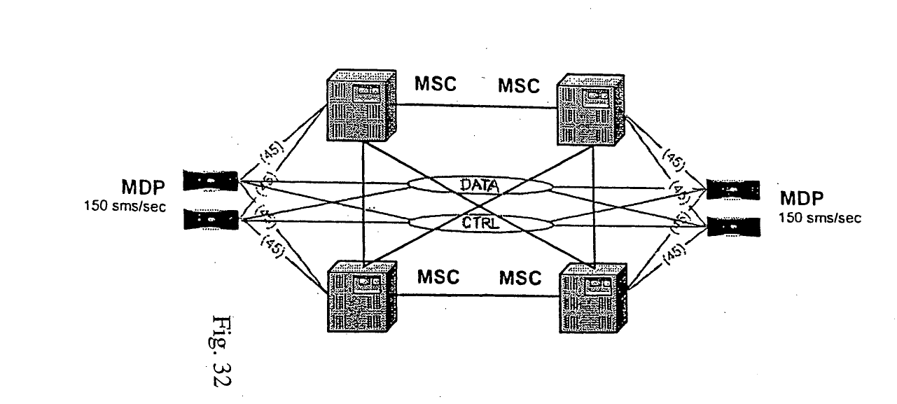

FIG. 32 shows one embodiment of the implementation of an MDP system into a mobile telecommunications network;

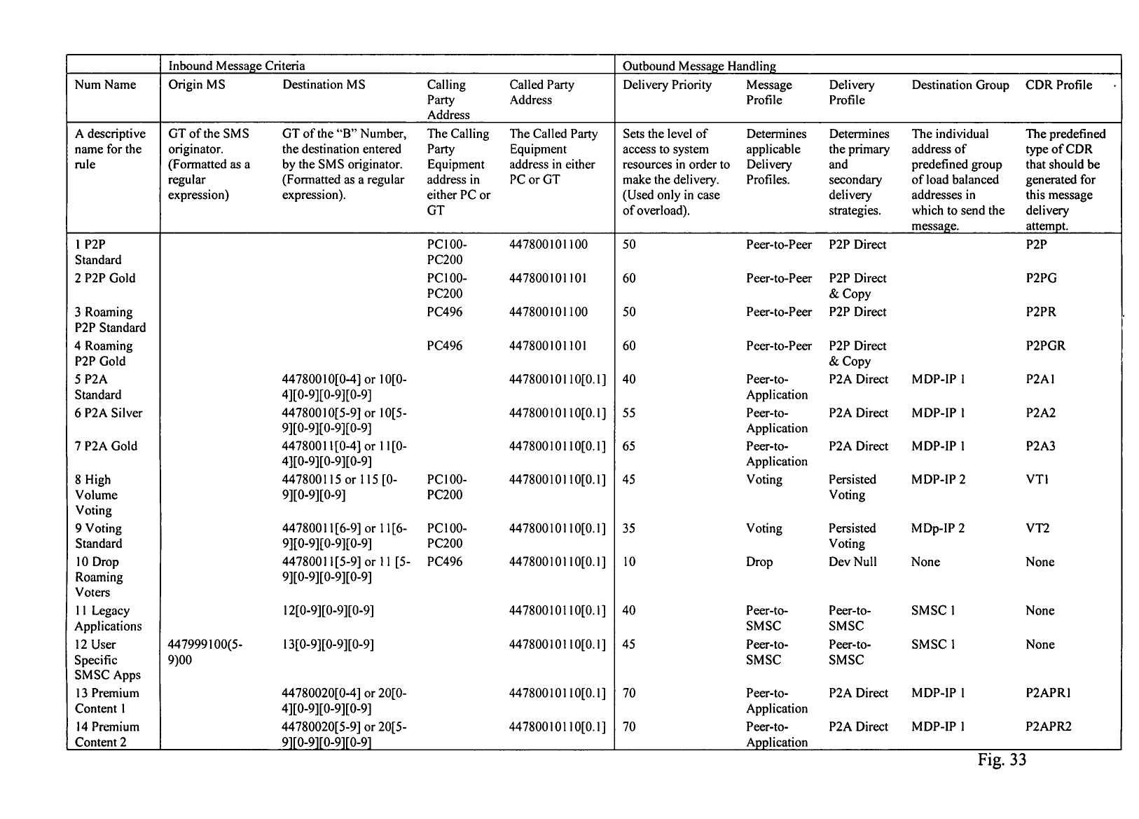

FIG. 33 shows an example of a routing table which may be used by one embodiment of the MDP system;

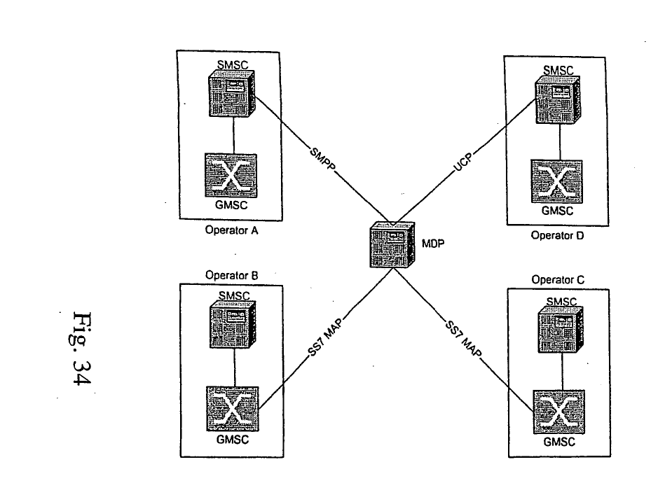

FIG. 34 illustrates how the MDP may be connected to a number of operator's mobile telecommunication networks according to one embodiment;

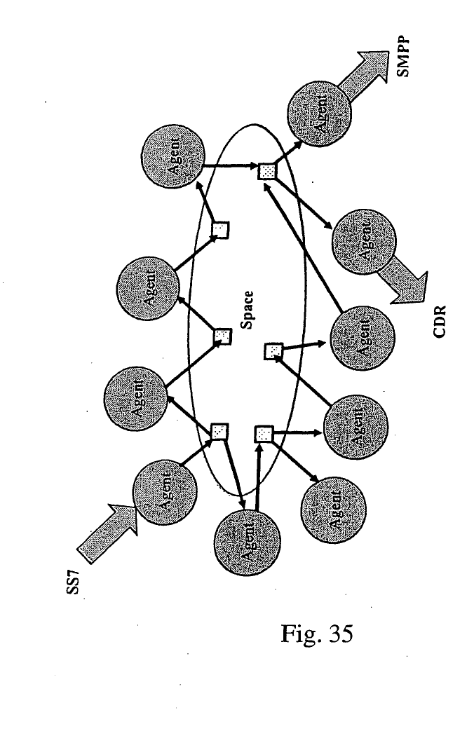

FIG. 35 is a schematic diagram of one embodiment of the distributed architecture of the system described herein;

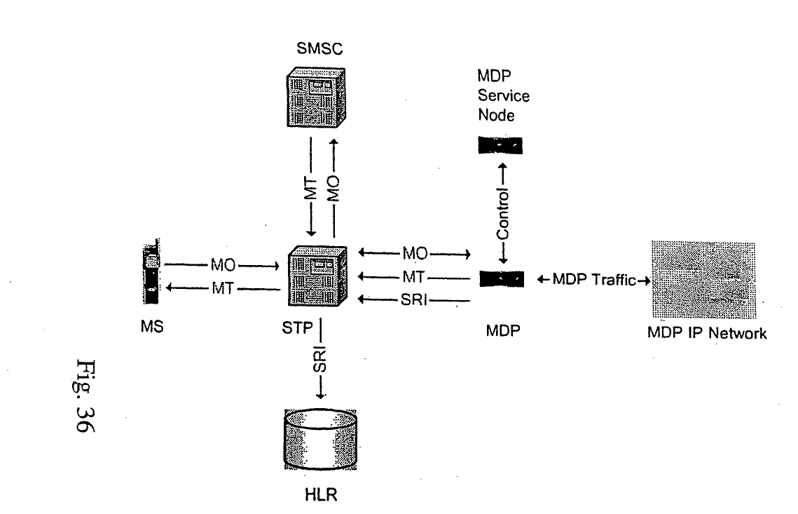

FIG. 36 illustrates one embodiment of network connections for an MDP node of the system described herein;

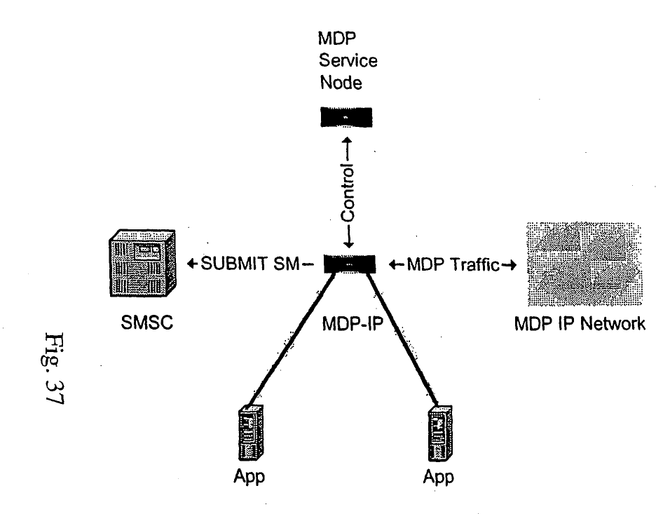

FIG. 37 illustrates one embodiment of network connections for an MDP-IP node of the system described herein;

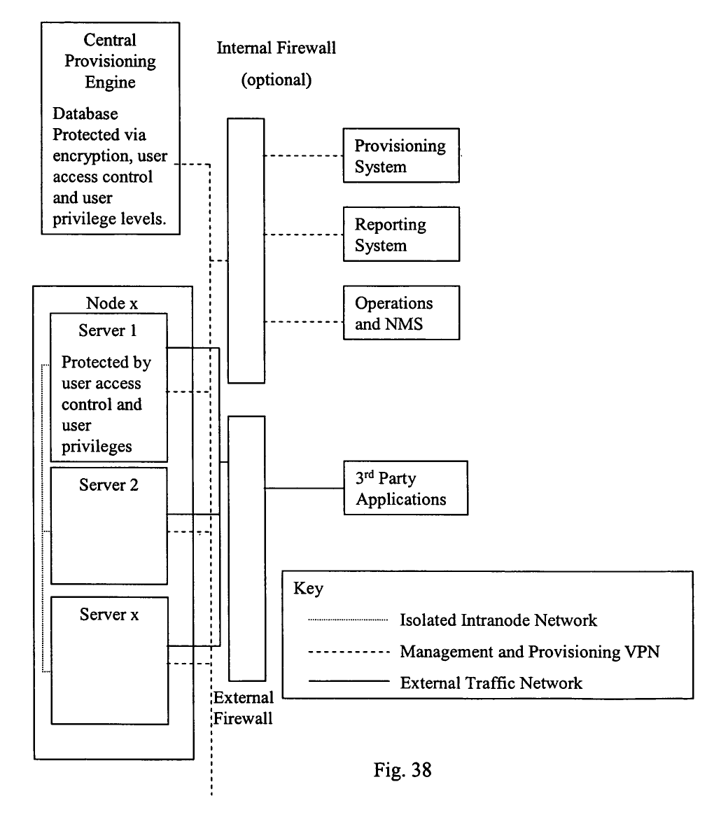

FIG. 38 is a schematic diagram of a high level security architecture according to one embodiment of the system described herein;

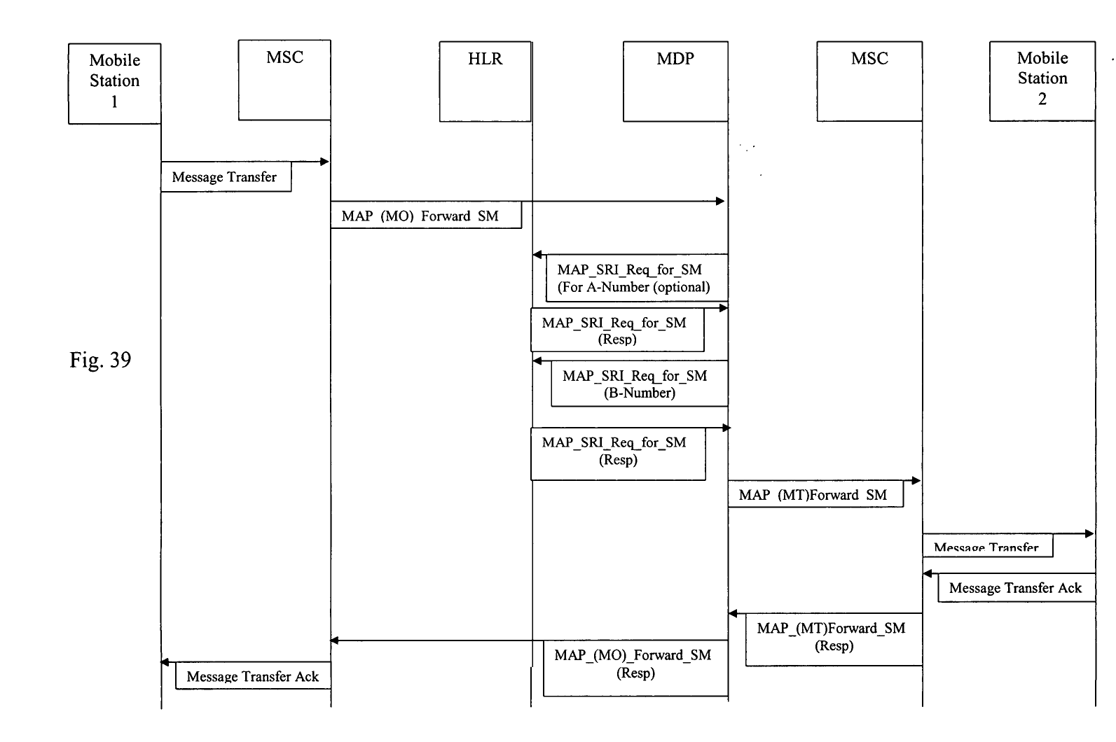

FIG. 39 is a sequence diagram illustrating the process of direct delivery of messages according to one embodiment of the system described herein;

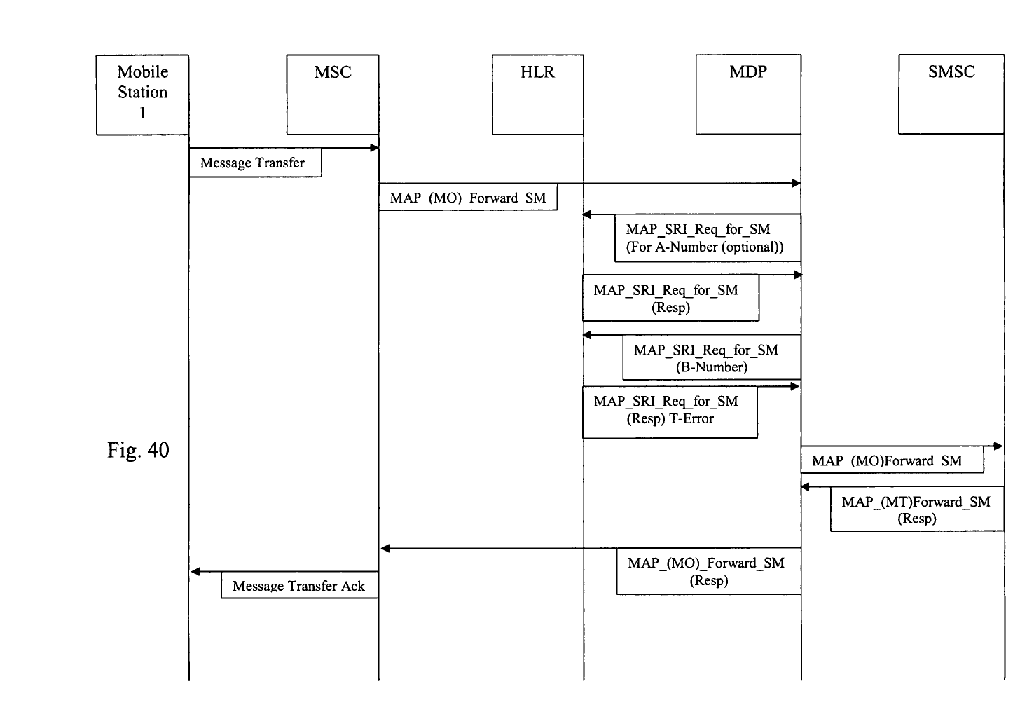

FIG. 40 is a sequence diagram illustrating the process of delivering a message to an SMSC via an MDP according to one embodiment of the system described herein;

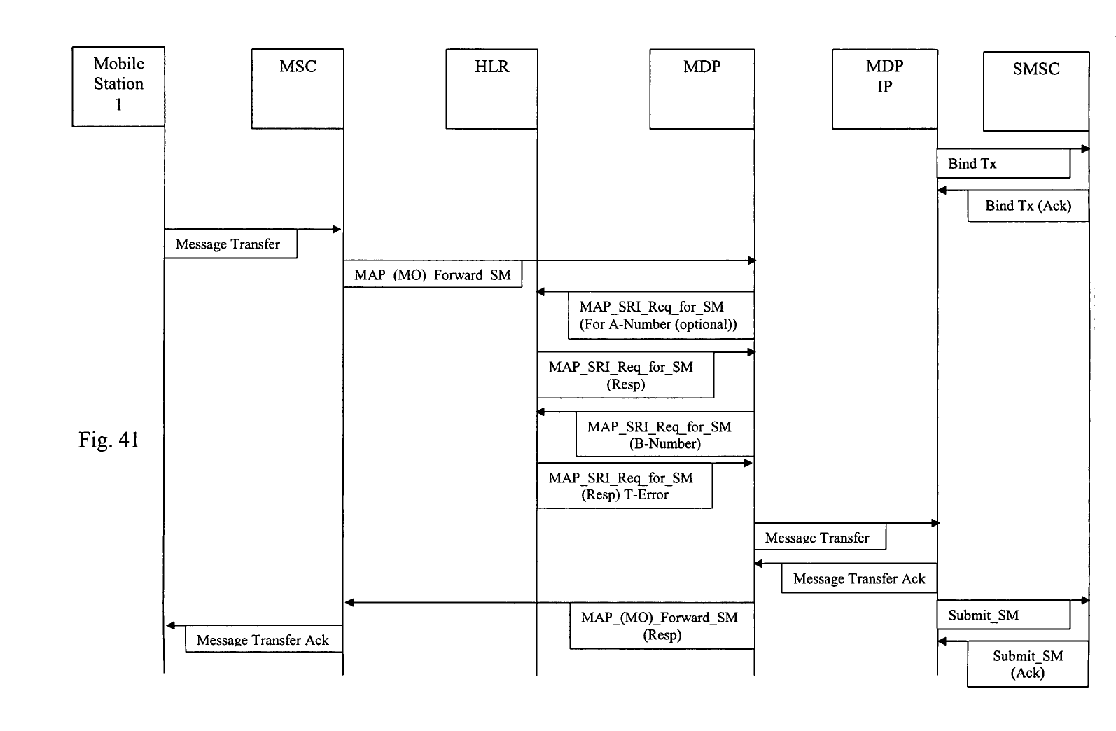

FIG. 41 is a sequence diagram illustrating the process of delivering a message to an SMSC via an MDP and an MDP-IP according to one embodiment of the system described herein;

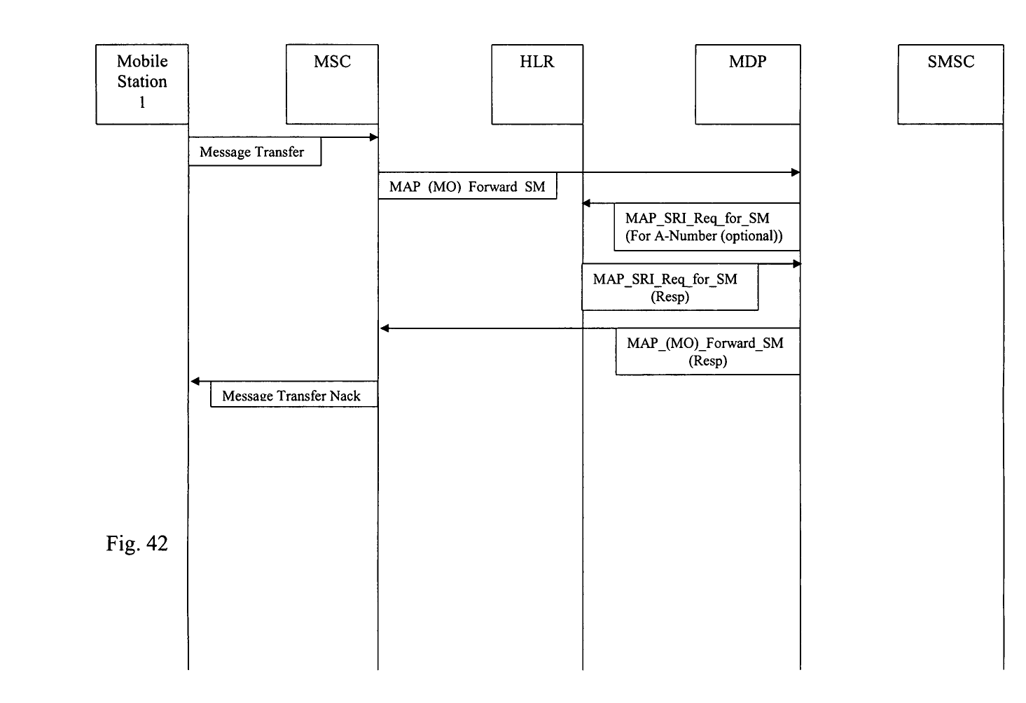

FIG. 42 is a sequence diagram illustrating non-delivery of a message to a blacklisted number according to one embodiment of the system described herein;

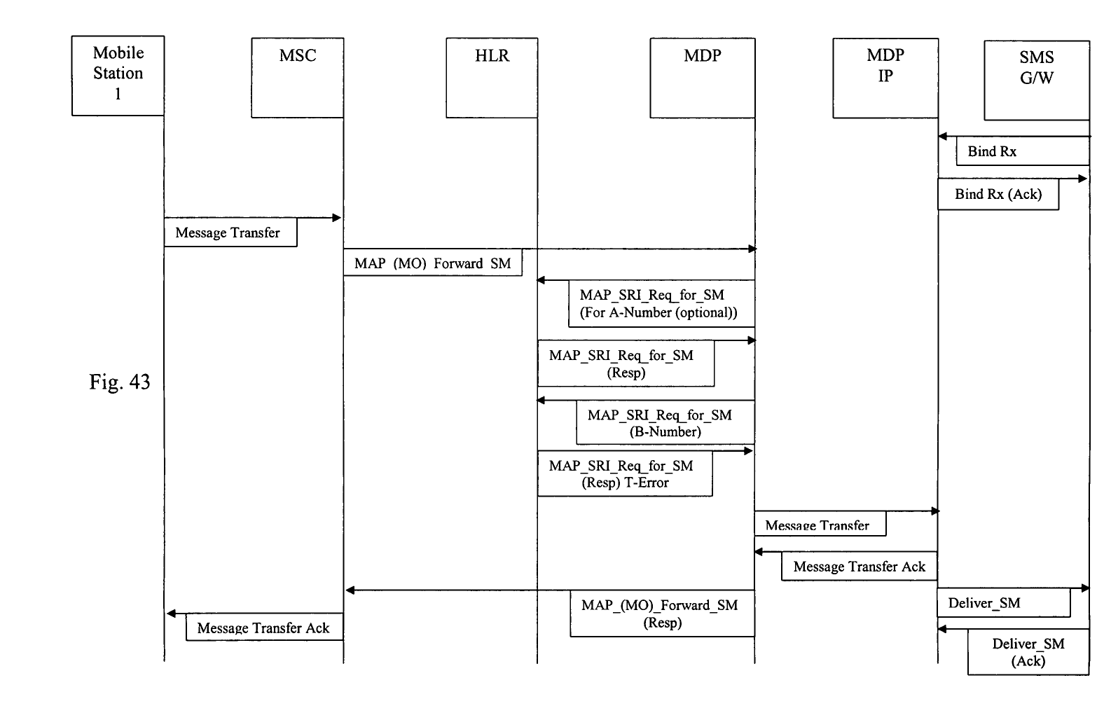

FIG. 43 is a sequence diagram illustrating the process of delivery of a message to a gateway MSC for delivery to another network via an MDP according to one embodiment of the system described herein;

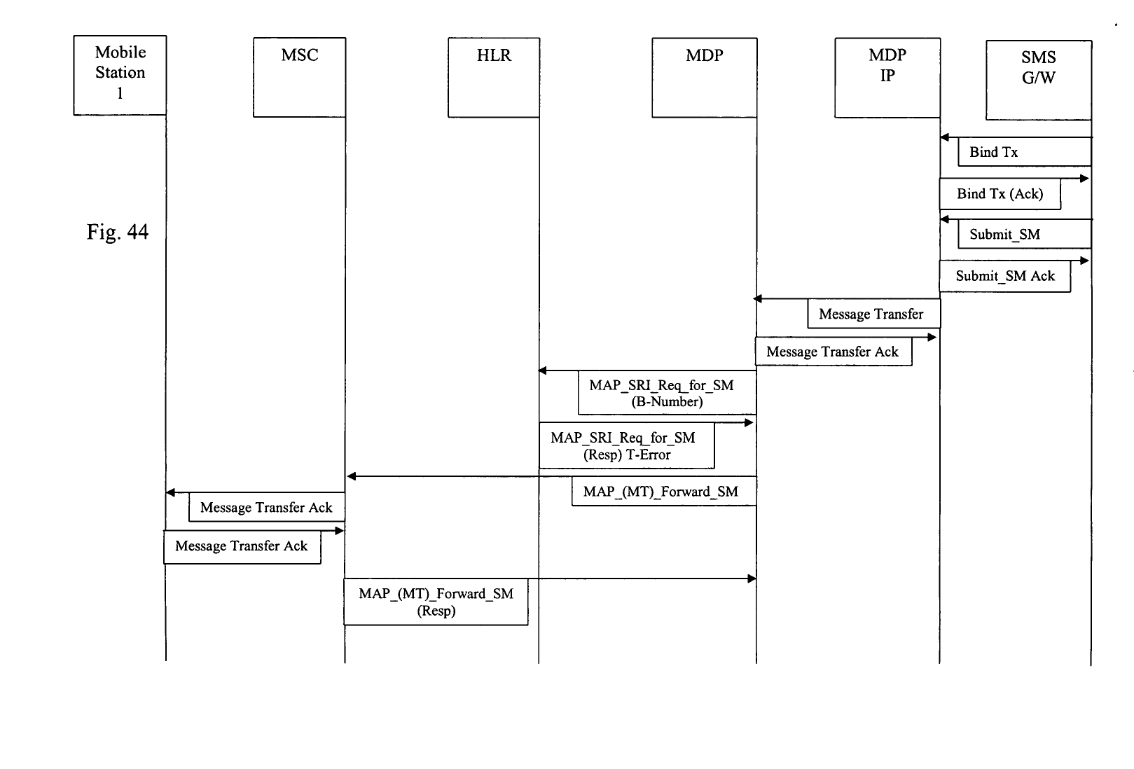

FIG. 44 is a sequence diagram illustrating the process of delivery of a message from another network to a mobile station via MDP according to one embodiment of the system described herein;

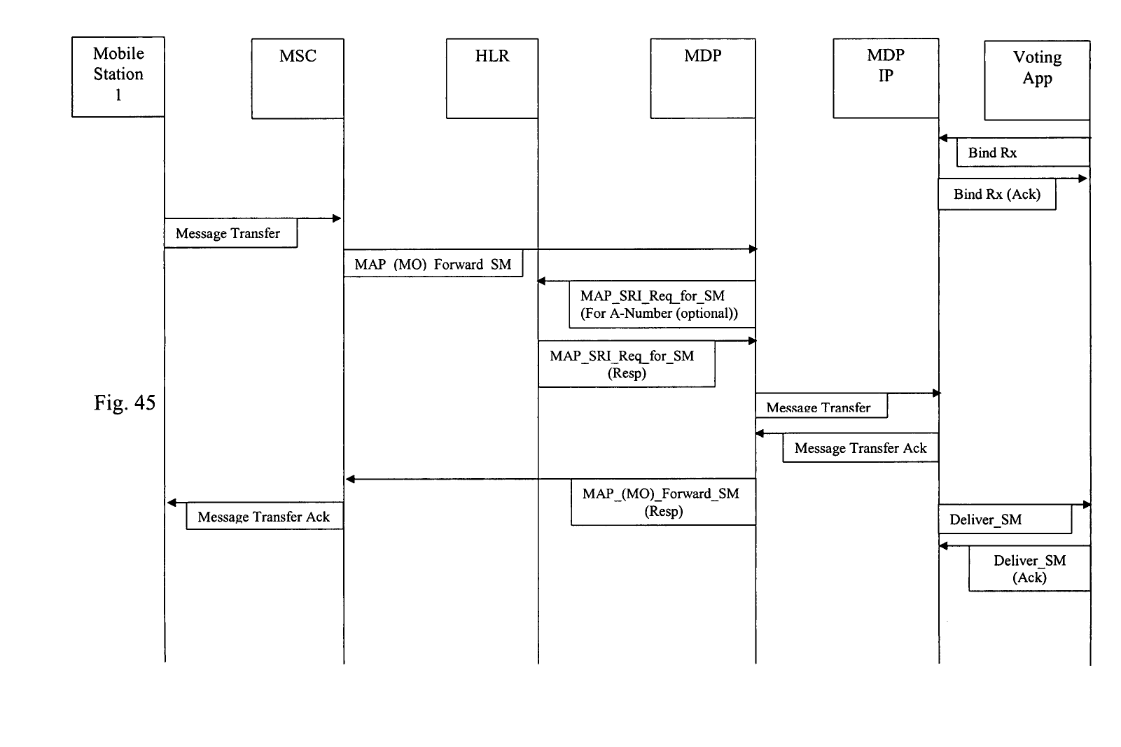

FIG. 45 is a sequence diagram illustrating the process of delivery of a voting message to a voting application according to one embodiment of the system described herein;

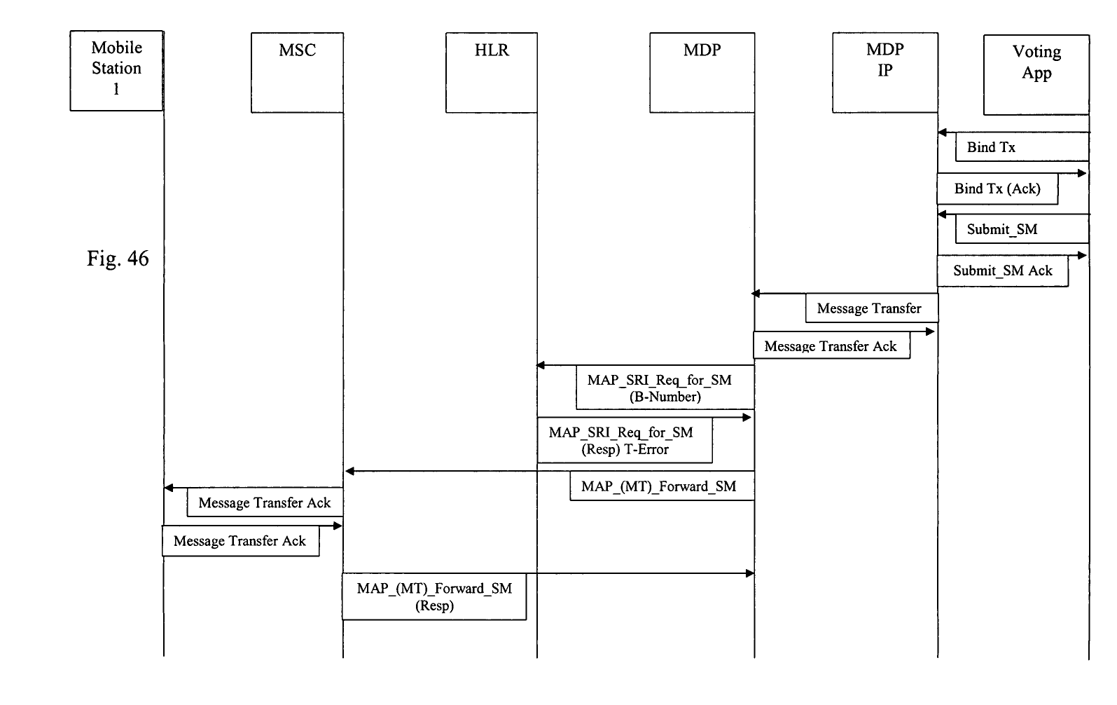

FIG. 46 is a sequence diagram illustrating the process of delivery of a message from a voting application to a mobile station via MDP according to one embodiment of the system described herein;

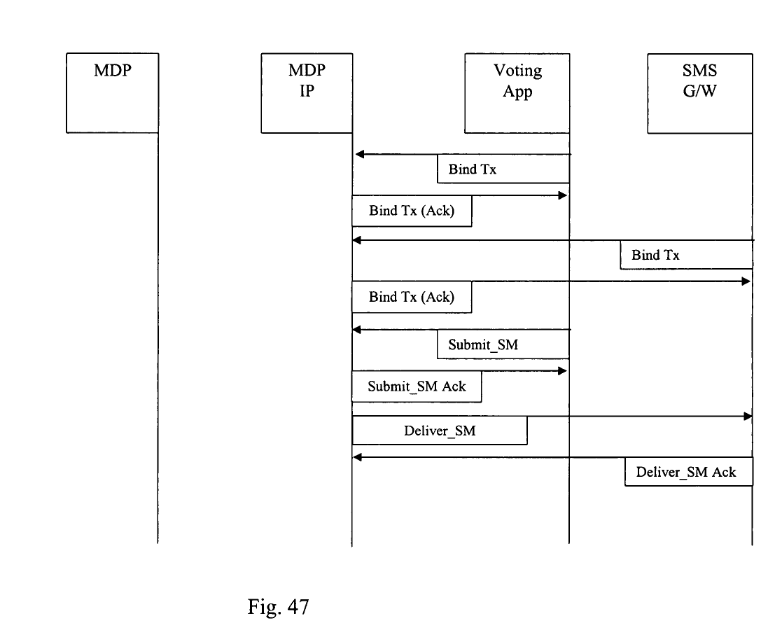

FIG. 47 is a sequence diagram illustrating the process of delivery of a message from a voting application to a gateway MSC for delivery to another network according to one embodiment of the system described herein;

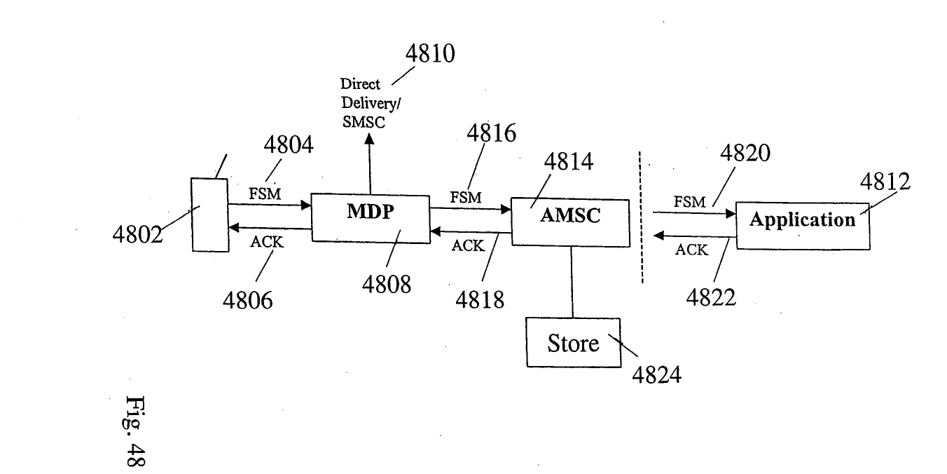

FIG. 48 illustrates how a message may be delivered via the MDP system described herein and via the AMSC described herein to an application;

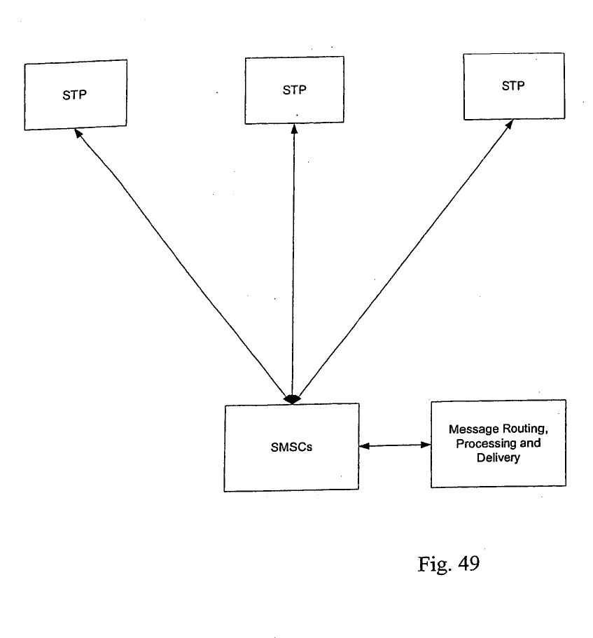

FIG. 49 illustrates a prior art mobile telecommunications network;

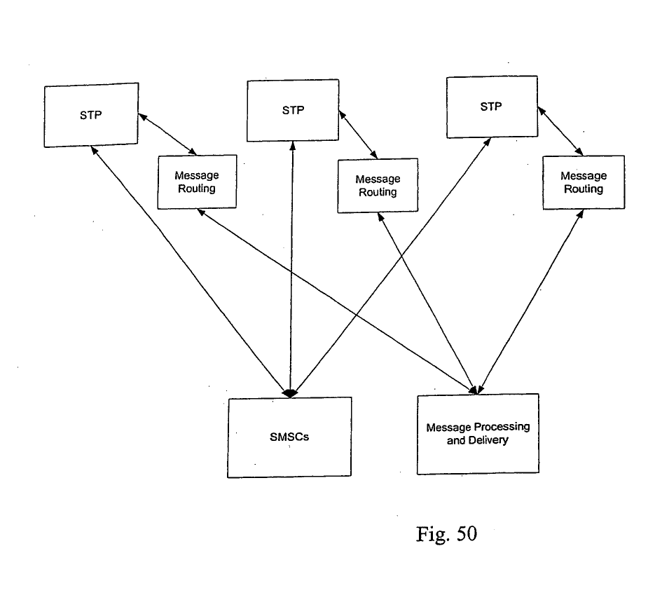

FIG. 50 is a schematic diagram of a mobile telecommunications network with a decentralised and distributed approach to the sending of messages;

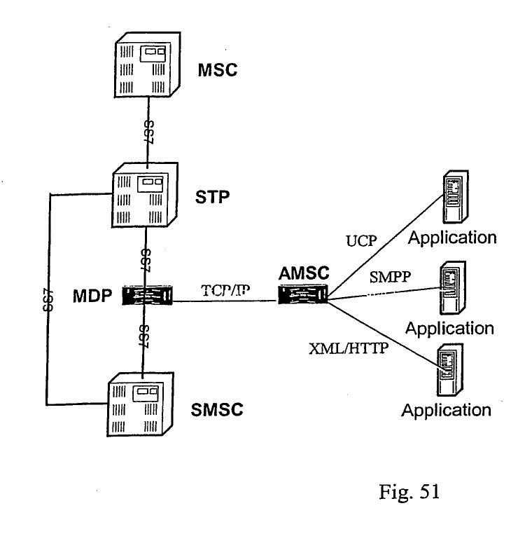

FIG. 51 is a schematic diagram of one embodiment of the MDP and AMSC systems implemented within a mobile telecommunications network;

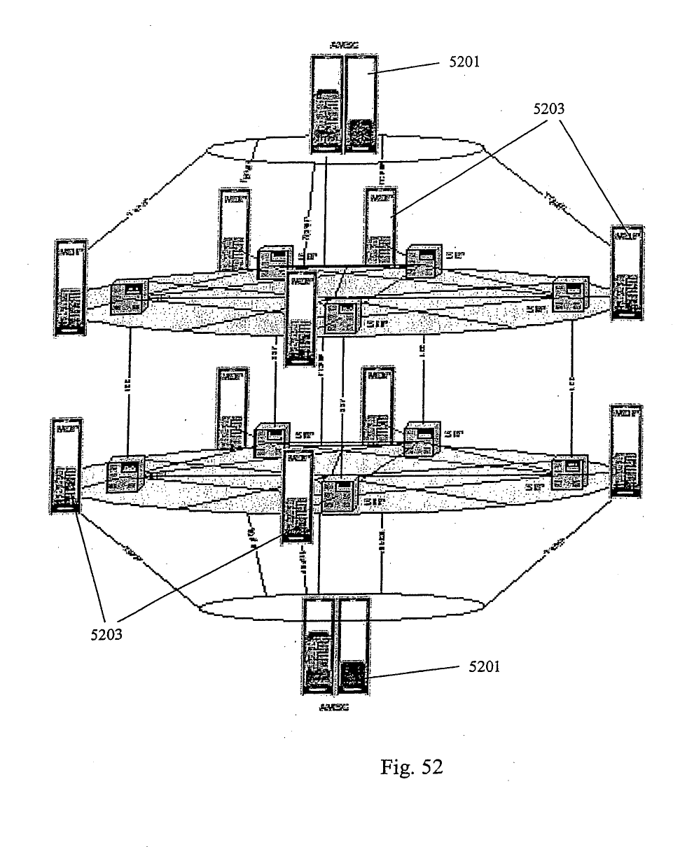

FIG. 52 is a schematic diagram of one embodiment of the deployment of the MDP and AMSC systems in a mobile telecommunications network;

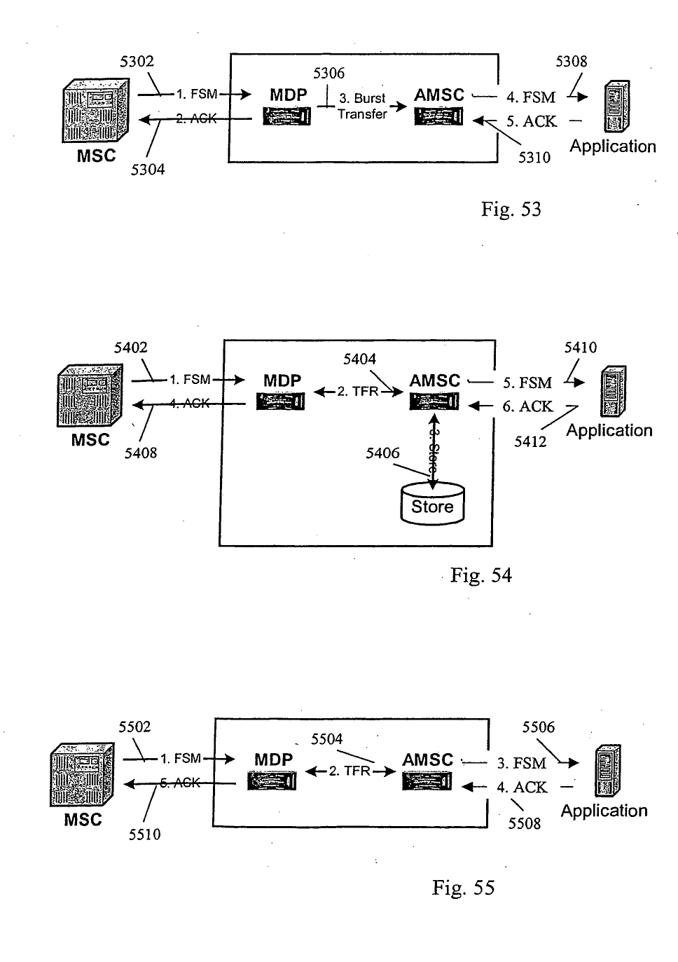

FIG. 53 is a sequence diagram showing one embodiment of the Immediate Acknowledgement procedure;

FIG. 54 is a sequence diagram showing persistence of messages according to one embodiment;

FIG. 55 is a sequence diagram showing one embodiment of the Synchronised Double Acknowledgement procedure;

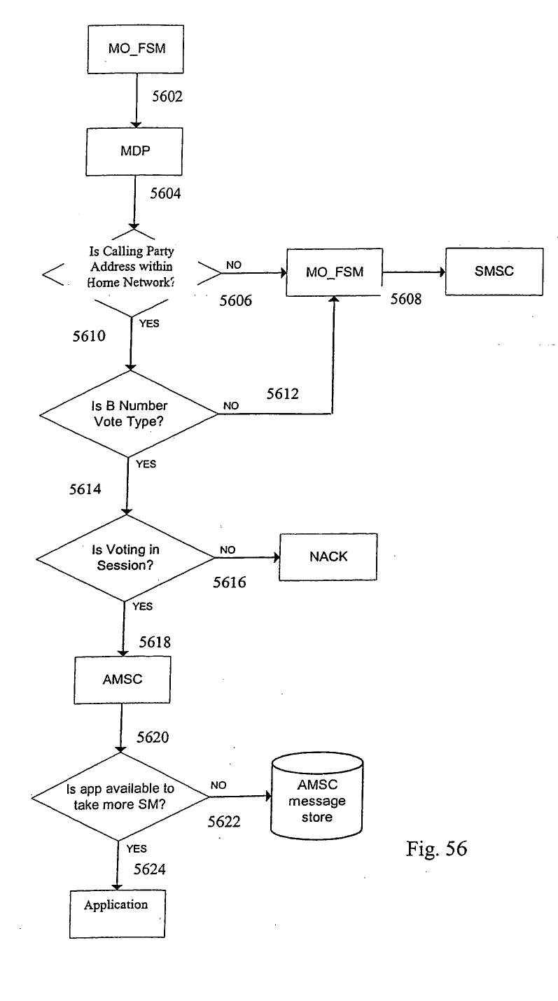

FIG. 56 is a flow diagram showing an example of the flow of routing decisions in one embodiment of the network described herein;

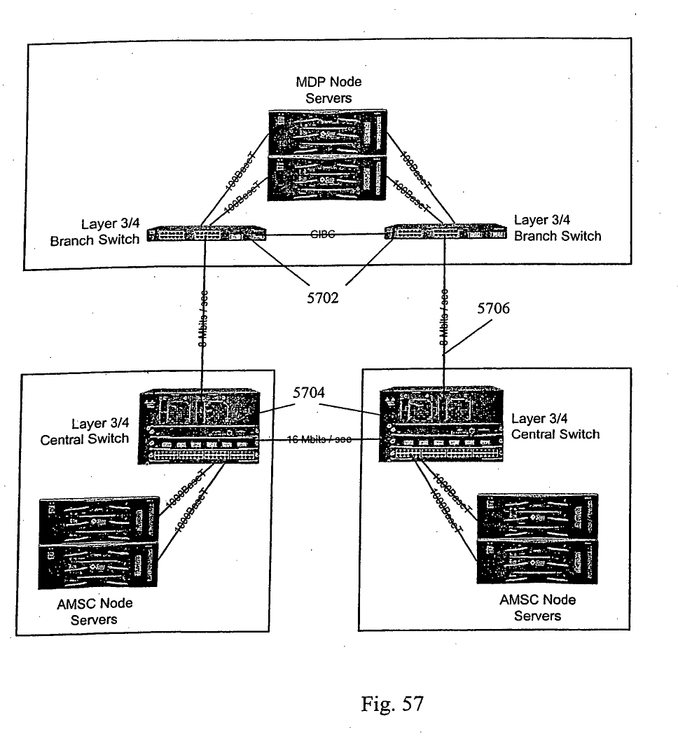

FIG. 57 is a schematic diagram showing one embodiment of a TCP/IP network connecting components of the system described herein;

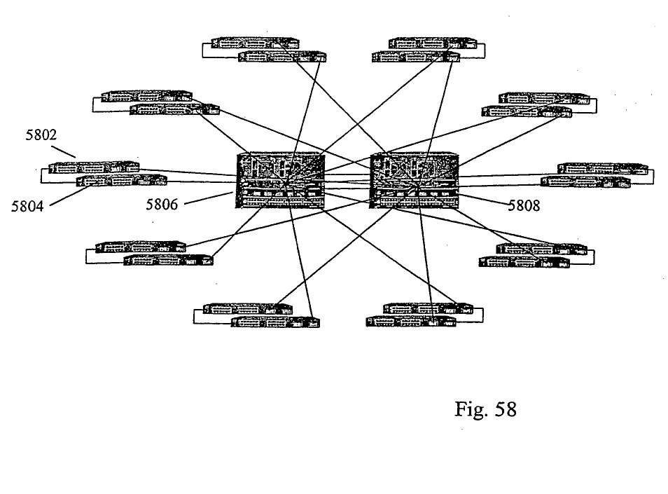

FIG. 58 is a schematic diagram showing a plurality of AMSC and MDP network components connected by a semi-meshed full-redundant TCP/IP network.

In the figures listed above, corresponding components are labelled with the same numbers.

FIG. 16 shows a prior art telecommunications network, the components of which are connected over SS7 connections 210. The arrows 410, 412, 414, 416, 418, 420 illustrate an example path of an SMS message sent from one mobile entity to another within the mobile network.

The main components of an SMS message which may be sent across the network of FIG. 16 are shown schematically in FIG. 27. SMS messages consist of three main components: a source number (SRC#) 800, a destination number (DEST#) 820, and a payload 810. For a mobile originated (MO) message, the source number is an identifier of the originating mobile. This may be the MSISDN number of the originating mobile, or the identifier may be derived from the MSISDN number. The destination number of a mobile originated message is an identifier of the home SMSC of the mobile entity. The payload of a mobile originated message contains the message data and an identification number of the final destination of the message, for example, the MSISDN number of the destination mobile.

With reference to FIG. 1, the message is sent 410 from the originating mobile 212 to an MSC 216 within the mobile network. The MSC 216 forwards 412, 414 this message to the home SMSC 230 of the originating mobile 212 via a network STP 226. The message is forwarded to the home SMSC 230 according to the SMSC identifier found in the DEST# part of the message, as described above. The SMSC identifier may be the same for all of the SMSCs 230, 232, 234 in a particular operator's network. The STP 226 of the network may be configured to chose which SMSC each message is sent to depending on factors such as the availability of each SMSC 230, 232, 234.

The SMSC terminates the mobile originated message and creates a new, mobile terminated (MT) message for delivery to the destination mobile entity 214 (the destination entity could also be an application). With reference to FIG. 27, a MT message also has a SRG# 800, a payload 810 and a DEST# 820. The SRC# 800 of an MT message is an identifier of the originating mobile, and the payload 510 contains the message data. The SMSC parses the incoming mobile originated message and extracts the identifier, for example the MSISDN number, of the destination mobile. This identifier then forms the DEST# 820 for the MT message.

Turning to FIG. 1, the home SMSC 230 sends a “Send Routing Information” request to the HLR 248 of the network, via an STP 226, to determine the location and availability of the mobile entity 214 that corresponds to the extracted destination identifier. If the destination mobile is available and able to receive messages, the SMSC 230 then routes the MT message 416, 418, via an STP 226, to the MSC 224 that is closest to the destination mobile 214, and the message may then be delivered 420 to the destination mobile 214.

In addition to using the “Send Routing Information” request to obtain location and availability information for the destination mobile entity of a message, the SMSC 230 may also perform a prepaid credit lookup at the Prepaid Billing SCP 250. This may be used by an operator to ensure that the message originator has enough prepaid credit for the message to be sent. This may also facilitate the billing of prepaid mobile telephones on the destination leg of the message delivery process (reverse billing). This may be particularly useful for the billing of services offered by application operators, such as sports update services, wherein the message recipient pays per message received. The SMSC 230 may also perform an International Mobile Subscriber Identity (IMSI) check, or number portability check. Performing these checks may allow the mobile network operator to ensure that the message originator is authorised to send messages within the home operator's network and may also be used to ensure that the MSISDN of the destination mobile station has not been transferred from one operator's network to another. In the prior art network, this information is requested by and delivered to the SMSC 230 over the SS7 network, further increasing congestion on the network.

Much of the SMS traffic on the mobile network is cross-network traffic, that is traffic that is generated by mobile entities on one mobile operator's network and delivered to mobile entities on a second operators network. These messages pass from the originator's home SMSC, through the G-MSCs 242, 246 to the destination mobile on the second operator's network. Incoming cross-network traffic may be known as off-net traffic and passes into the network through the G-MSCs 242, 246. Traffic generated on the home operator's network may be known as on-net traffic.

One embodiment of the present invention is shown in FIGS. 17 to 11. In this embodiment, a number of components have been added to the prior art telecommunications network described above. These components and the modified telecommunications network will now be described with reference to FIG. 2.

In this embodiment, the modified telecommunications network contains a Virtual Mobile Redirector Switch (VMRS) 310, a Virtual Mobile Location Register (VMLR) 312 and a Mobile Terminated Message Switch (MTMS) 314. The VMLR 312 may be provided as part of the HLR 248 of the home operator's network or as a separate entity. Applications 316, 318 may connect to both the VMRS 310 and the MTMS 314 over, for example, an IP network 340. In this embodiment, a Service Hosting Platform (SHP) 236 provides an interface between the application 316, 318 and the VMRS 310 and MTMS 314. According to one embodiment of the present invention, a combination of a number of the VMRS 310, MTMS 314, VMLR 312, SHP 236 and the Message Store 238 components may be described as an Application Message Service Centre (AMSC) 350.

Embodiments of the VMRS 310, VMLR 312 and MTMS 314 are described in more detail in patent application numbers GB 0115493.4, GB 0122943.4 and GB 0203796.8, in which the VMRS is also known as a Virtual Mobile Switching Centre (VMSC) and a combination of the VMRS and the VMLR may be known as the Virtual Mobile Redirector (VMR). In addition, the functionality of the MTMS is outlined in the description of the Application Message Service Centre (AMSC).

In short, the VMLR 312 provides a location register, similar to that of the HLR 248, but storing location and availability data for applications, which may be connected to the mobile operator's network via the VMRS 310 or the MTMS 314 as shown. Each application may be assigned a unique global identifier, for example an MSISDN number, which allows the application to act as a “virtual mobile” to which messages may be sent from other mobile entities on or off the home operator's network. In a preferred embodiment, messages are delivered to the applications 316, 318 via the VMRS 310 without the message passing through an SMSC 230, 232, 234 of the home operator's network. The MTMS 314 is optimised to allow applications 316, 318 to send messages to the mobile network and, in a preferred embodiment, messages are sent from the applications 316, 318 to their destinations without passing through an SMSC 230, 232, 234 of the home operator's network.

Hence, some of the problems described above of connecting applications to the telecommunications network and of sending messages to and from those applications may be alleviated or solved. As shown in FIG. 2, the VMRS 310, VMLR 312 and MTMS 314 may be interconnected over a network separate to the telecommunications network, for example an IP network 340. They may also be connected to the mobile operator's network over SS7 links 210. Also connected to the separate IP network 340, in this embodiment, are a plurality of Message Delivery Components (MDCs) or Message Delivery Points (MDPs) 324, 326, 328, 330, 332, 334, 336, 338. In this embodiment, each MDC 324, 326, 328, 330, 332, 334, 336, 338 connects to one of the components of the telecommunications network using a mobile telecommunications protocol. For example, in this embodiment, an MDC connects to each MSC 216 and to each G-MSC 246 over an SS7 link 210.

The MDCs 336, 338 that are connected to the G-MSCs 242, 246 of the home network may intercept incoming off-net traffic, i.e. all traffic that is passing into the home operator's network from the networks of other operators. Since there is often a plurality of mobile operator networks in any one region, a large proportion of the messages passing through any operator's network is likely to consist of off-net traffic. Hence, congestion within the home operator's network can be significantly reduced by transferring the incoming off-net traffic onto the separate IP network 340 at the G-MSCs 242, 246, as described in more detail below.

According to a further embodiment of the invention, MDCs may be connected solely to the G-MSCs of the mobile network and not, in addition, to the MSCs as in the embodiment of FIG. 2. In such an embodiment, the incoming off-net traffic could be delivered to the VMRS 310, MTMS 314 or SMSC 230 without using the SS7 network. Hence, even without the MDCs connected to the MSCs of the telecommunications network, congestion may be reduced on the SS7 network.

In the embodiment illustrated in FIG. 2, however, MDCs 328, 330, 332, 334 are connected to the MSCs 216, 218, 220, 224 of the telecommunications network. These MDCs may be used to intercept on-net traffic, originating from mobile entities connected to the home operators network, or to deliver messages to these home mobile entities, hence allowing usage of the SS7 layer of the telecommunications network to be minimised.

Use of the embodiment described above and illustrated in FIG. 17 will now be described in more detail with reference to FIGS. 18 to 11, which illustrate a number of processes by which messages may be routed across the network.

FIG. 18 illustrates the routing of an off-net message from a G-MSC 246 through the network to its destination, according to one embodiment of the present invention. In this case the destination entity is an application 318 connected to the VMRS 310, via the SHP 236. The message is routed 450 from the originating mobile to the G-MSC of the home operator's network 246 using standard telecommunications routing procedures. The message is then intercepted 452 by the MDC 336 that is connected to the G-MSC 246. In this embodiment, the MDC 336 is connected to the G-MSC 246 using an SS7 link, but, in alternative embodiments, the MDC 336 may be connected to the G-MSC 246 using another protocol, such as IP or a 2.5G or 3G telecommunications protocol, in addition to or instead of using the SS7 connection.

Since the incoming message is an off-net message, it has already passed through the home SMSC of the originating network, so it has already been re-formatted as a Mobile Terminated (MI) message as described above. This means that the message has, as its destination address (DEST#), the identifier (typically an MSISDN number) of the intended final destination of the message. The MDC 336 retains the incoming message and sends a request over the IP network 340 to the VMRS 310 to obtain the information necessary to deliver the message to the destination address. This information may include location and availability information for the destination entity, a prepaid billing check and an IMSI lookup check, as described above. This information may be requested by the VMRS 310 from components such as the VMLR 312 and the prepaid billing SCP 250 over the separate IP network 340. Alternatively, the information may be requested over the SS7 network. This information is sent back to the MDC 336 that is retaining the message, preferably over the IP network 340.

In the situation shown in FIG. 3, the destination address (DEST#) for the incoming MT message is the MSISDN of an application 318 attached to the VMRS 310 via the SHP 236. As discussed above, and as described in more detail in patent application numbers GB 0115493.4, GB 0122943.4 and GB 0203796.8, the VMRS 310 and VMLR 312 provide a mechanism by which off-net messages may be delivered to applications attached to the VMRS 310 by treating the applications as virtual mobile entities and assigning MSISDN numbers to them.

In FIG. 3, the information obtained by the VMRS 310 is sent back to the MDC 336 over the IP network 340. This allows the MDC 336 to route the MT message to its destination over the IP network 340. In this case, the message is sent 454 to the VMRS 310 for onward delivery 456, 458, via the SHP 236, to the destination application 318. In the event that the application 318 is unavailable to receive messages at that time, the message may be retained by the VMRS 310 or the SHP 236 or may be passed to the Message Store 238 for storage and later delivery.

As shown in FIG. 3, the entire message delivery process may take place over the IP network 340, which may significantly reduce congestion on the SS7 network 210.

A further message delivery process according to one embodiment of the present invention will now be described with reference to FIG. 19. The message source in FIG. 19 is an application 318 connected to the mobile network via the SHP 236. The message is sent 460, 462 from the application 318 to the MTMS 314 via the SHP 236. If the message is formatted in the same way as a mobile originated (MO) message, the MTMS 314 may parse the message to determine the destination number of the final destination of the message and may reformat the message as a mobile terminated (MT) message. In a preferred embodiment, however, the application 318 may generate the message and deliver it to the MTMS 314 in a mobile terminated format, with the final destination address in the DEST# part of the message (accessible at the SCCP protocol layer), as explained above.

Since the destination entity of this message is connected to a different mobile operator's network, the message is routed 464 over the IP network 340 to an MDC 336 connected to a G-MSC 246. The message is transmitted 466 from the MDC 336 to the G-MSC 246 over the SS7 network. The G-MSC 246 then transfers 468 the message to a G-MSC connected to the home network of the destination mobile entity for the message. Hence, as for the incoming application terminated message of FIG. 3, outgoing application originated messages may be transmitted across the home operator's network without using the SS7 network. In a further embodiment, network interconnect traffic may also be offloaded onto the separate IP network to be transmitted between telecommunications networks of different operators. This offload may be implemented using an IP connection or another separate network connection which may be established between MDCs connected to the G-MSCs of the two operator's networks. This may allow operators to interconnect over an IP network rather than a telecommunications network and may increase the efficiency of message flow between operator's networks.

FIG. 20 illustrates the process of sending an on-net MO message to an application connected to the same network according to one embodiment of the present invention. One embodiment of the present invention provides an improved method of routing MO SMS messages between the originating and destination mobile entity in a telecommunications network. As described above, with reference to FIG. 27, a MO message has three main parts: the SRC# 800 which contains an identifier of the originating mobile entity, the Payload 810 which contains the message data and an identifier of the destination mobile entity, and the DEST# 820 which contains an identifier of the home SMSC of the originating mobile entity. The SRC# 800 and DEST# 820 parts of the message are accessible at the SCCP and MTP layers of the SS7 protocol stack and are usually used for routing the message. The contents of the Payload 810 part of the message are available only at the higher MAP and TCAP layers and are usually not accessed until the message reaches the home SMSC.

With reference to FIG. 20, the MO message is generated at the originating mobile entity and sent via 470, via the radio network to an MSC 216 in the home mobile network. The MDC 334 connected to the MSC 216 intercepts 472 the incoming message over its connection to the MSC 216, which, in this embodiment, is an SS7 connection. The MDC 334 retains the message and parses the message payload at the MAP layer to determine the final destination address for the message.

The MDC 334 sends a request for information for the final destination address extracted from the message payload, to the VMRS 310 of the mobile network, via the IP link 340 by which they are connected. As in the previous examples, the VMRS 310 obtains the information necessary to route the message to its final destination address. This information may then be transferred back over the IP network 340 to the MDC 334. In this case, as for FIG. 3, the final destination of the message is an application 318 connected to the VMRS 310 via the SHP 236. On receipt of the location information, the MDC sends 474 the message directly to the VMRS 310, over the IP network, for onward delivery 476, 478, via the SHP 236, to the application 318.

The method of routing the message according to information obtained by parsing the message payload is quite distinct from the routing methods used in the prior art. Routing based on the message payload requires routing capabilities at the higher MAP protocol layer. As described above, routing at the MAP layer is not a feature of prior art message offload systems, in which routing is performed at the SCCP and MTP layers. Prior art telecommunications switches do not usually access the MAP protocol layer in routing the message between components in the telecommunications network and, as described above, prior art IP offload systems do not process data at the MAP layer either. As mentioned above, in other embodiments, alternative high level protocols may be used instead of the MAP protocol. The protocol used may depend on the type of message being transmitted through the telecommunications network.

Hence, in the present embodiment, a mobile originated message may be routed using the destination address extracted from the payload without using the SMSC number, and without the message passing through the SMSC. This both reduces congestion on the telecommunications network and increases the efficiency of delivering a message to its destination.

A further message sending process, according to one embodiment of the present invention, is now described with reference to FIG. 21, which illustrates the process of sending an on-net MT message, generated by an application 318, to a mobile entity on the home operator's network.

The MT message is generated by the application 318 and delivered 480, 482 over the IP network 340, via the SHP 236 to the MTMS 314 and reformatted by the MTMS as a MT message. In an alternative embodiment, the message may be generated by the application 318 in a MO format, parsed by the MTMS 314 to determine the destination address. The MTMS obtains the necessary location and availability information and performs the prepaid credit and IMSI look-ups over the IP network 340, for example, using the HLR 248 and the Prepaid Billing SCP 250. If the destination mobile is able and available to receive messages, the MTMS 314 sends the message 484 over the separate IP network 340 to the MDC 334 that is closest to the MSC 216 to which the destination mobile entity is connected. The message is then transmitted 486 over the SS7 connection to the MSC 216 and on 488 to the destination mobile entity.

FIG. 22 illustrates the process of sending a message between two mobile entities in the same network. The MO message is sent 490 from the originating mobile over the radio network to the MSC to which the originating mobile is connected 216. The MDC 334 connected to this MSC 216 intercepts the incoming MO message, terminates it and retains it. The MDC 334 parses the message payload at the MAP layer for the final destination address of the message and sends a message requesting information corresponding to the final destination address from the VMRS 310 over the separate IP network 340. As above, the VMRS 310 requests the information necessary to allow delivery of the message to its final destination and sends this information to the requesting MDC 334.

In this case, the destination address of the message corresponds to a second mobile entity on the home operator's network. The first MDC 334 sends 494 the MO message, via the IP network 340, to a second MDC 330, the second MDC 330 being that connected to the MSC 220 to which the destination mobile entity is connected. The second MDC 330 receives the message and forwards it 496, 498, via the second MSC 220, to the destination mobile entity.

Hence, according to this embodiment of the present invention, messages may be sent between two mobile entities on the home operator's network without using the SS7 channel. Since the MDC 334 has access to data contained within the message payload at the MAP layer, the message can be routed more efficiently to its destination without the message itself having to be passed over the SS7 or IP network to the VMRS 310, or to an SMSC 230, to be reformatted as a MT message.

FIG. 23 illustrates the process of sending a message indirectly from a first mobile entity to a second mobile entity within the home mobile operator's network. As in FIG. 22, the message is transmitted 500 from the originating mobile entity to an MSC in the network 216 and is captured 502 by the MDC 334 attached to that MSC and the destination address is determined from the payload. The MDC 334 then requests information over the IP network from, for example, the VMRS 310. If, as in FIG. 22, the destination mobile entity is available and able to receive messages at the time of request, the message may be delivered over the IP network 340, via an MDC 320 and an MSC 220, directly to the destination mobile entity, as shown in FIG. 22. The process shown in FIG. 23, however, may be used advantageously in certain situations, for example when the message needs to be stored. This may occur when the destination mobile entity is not available to receive messages, or is unable to receive messages, for example because the mobile telephone memory is full.

In FIG. 23, the message is sent 504 from the MDC 334, over the separate IP network 340 to the SHP 236 component of the AMSC 350. If the message is to be stored, for example until the destination mobile entity becomes available, the message may be transferred to the message store 238. The AMSC 350 then enters a retry cycle wherein the availability status of the destination mobile entity is monitored at regular intervals to allow the message to be sent as soon as the destination entity is available. In a preferred embodiment, the AMSC 350 may also use the Mobile Waiting Data (MWD) system, described in more detail in UK patent application numbers GB 0115493.4, GB 0122943.4 and GB 0203796.8, wherein a mobile entity informs the network of its presence as soon as it becomes available to receive messages, hence accelerating the process of delivering messages held within the mobile network.

When the destination mobile entity becomes available to receive messages, the message is transferred 506 from the SHP 236 to the MTMS 314 and on 508, over the IP network 340 to the MDC 320 that is connected to the MSC 220 of the destination mobile entity. From the MSC 220, the message may be delivered 512 over the telecommunications network to the destination mobile entity.

FIG. 24 illustrates a further process by which messages may be sent indirectly from a first mobile entity to a second mobile entity within a mobile operator's network. In this process, the message is delivered 520 from the originating mobile entity to an MSC 216 and is captured 522 by an MDC 334. The message is transferred 524 across the IP network 340 to the SHP 236. The message may then be transferred 526 to the SMSC 230 of the mobile operator's network, either across the SS7 link between the two network components or over an IP or SMPP link 210, which may connect the SHP or AMSC to the SMSC via the “back-end” proprietary interface of the SMSC. If the destination mobile entity is unavailable, the message may be stored either by the SHP 236, or by the SMSC 230. When the destination mobile entity becomes available, the message may then be delivered 528, 530, 532, over the SS7 network 210, via the STP 226 and MSC 220.

The existing mobile operator's network may be used in conjunction with the separate IP network 340, as in the process shown in FIG. 24, or in other similar processes. The SS7 network 210 may be used as a back-up for the IP network 340, traffic being transferred from the IP network to the SS7 network, for example if the IP network becomes overloaded or fails. The SS7 network may also be used, for example if there is no MDC connected to a particular MSC (for example if MDC 330 was not connected to MSC 220 in FIG. 24). The SS7 network may also be used as a back-up facility if an MDC is unavailable. Messages that would usually be captured by the MDC and offloaded may be delivered over SS7 to the SMSC as in the prior art system.

The ability of the system to revert to using the SS7 network also means that it is not necessary for a mobile network operator to connect every component in the SS7 telecommunications network to the separate IP network. This may allow the embodiment of the invention described above and illustrated in FIGS. 17 to 9 to be implemented only in part, for example, MDCs may be connected only to the G-MSCs of the network, to transfer cross-network traffic onto the IP network for delivery to the VMRS or an SMSC. Similarly, MDCs may be connected only to MSCs that handle a high volume of traffic. A partial implementation of the MDC solution described above would allow a partial transfer of traffic from the SS7 layer and onto the separate IP network, hence reducing congestion on the SS7 layer.

The flow diagram of FIG. 25 summarises the processing of a mobile terminated (MT) message according to one embodiment of the present invention. As described above, MT messages are formatted with the final destination address in the DEST# portion of the message. MT messages are received, for example from the G-MSC 600, and routing rules are applied to route the messages to their respective destinations 605. When the destination is a mobile entity, the message can be forwarded directly to the mobile entity, preferably across the IP network, as described above. If the destination address corresponds to an application, the message is forwarded to the SMSC, VMRS or MTMS 610, preferably across the IP network. The message is then forwarded to the destination application. In the case of a successful delivery, an acknowledgement of the delivery is sent back to the originating mobile entity 620. If the message cannot be delivered, the originating mobile is notified of the delivery failure and the message is dropped from the system 615.

The flow diagram of FIG. 26 summarises the processing of a mobile originated (MO) message within a mobile network according to one embodiment of the present invention. The MO message is received from the originating mobile at an MSC and is captured by the MDC 700. An IMSI check is performed on the originating mobile identifier to ensure that the originating mobile is authorized to send messages to the mobile operators network 702. As described above, the message payload is then parsed by the MDC, at the MAP layer, to determine the address of the intended final destination of the message (the MT destination) and routing rules are applied to the message according to the MT destination 710. As mentioned above, it may be possible to use a high level SS7 protocol other than MAP. In the case where the MT destination address corresponds to a mobile entity, routing information is requested by the MDC, for example from the VMRS 708. If the request for routing information fails permanently (for example, if the MT destination address is invalid), then the message may be dropped and a delivery failure message may be returned to the originating mobile entity 706. If a temporary error is encountered, (for example, if the destination mobile entity is temporarily unavailable) then the message may be forwarded to an SMSC, VMRS or MTMS for storage and later delivery 714. If the routing information is received successfully, then the message may be routed directly to the destination mobile entity, via a second MDC 712, 718. If this forwarding of the message fails, then the message may be redirected to an SMSC, VMRS or MTMS for storage and later delivery 714. If the message is delivered successfully to the MT destination, then an Acknowledgement message is sent back to the originating mobile entity 724 and an entry is made into the Call Data Records (CDR), which may be used for billing purposes 726. When the destination entity is an application, the routing rules obtained 710 will cause the message to be delivered to an SMSC, VMRS or MTMS 714. The message is then delivered to the destination application and acknowledged to the originating mobile entity 720. In the case of a failed delivery attempt, the SMSC, VMRS or MTMS retains the message and enters a retry cycle 716 until the delivery has been successful. A successful delivery is again entered into the CDR 726.

The difference between the routing methods implemented by commonly used IP offload systems and one embodiment of the present invention will now be highlighted and described in more detail with reference to FIGS. 28a and 28b.

FIG. 28a shows a well established and common method of offloading SS7 traffic onto an IP network. As described above, the SS7 protocol stack consists of six main layers. In general, the MTP and SCCP layers are used for routing the message across the SS7 network and the higher layers, here MAP and TCAP layers, contain the message data. A common method of offloading SS7 traffic onto IP is to take the data contained in the MAP and TCAP layers and insert it into the higher protocol layers of an IP stack. The SS7 routing data is then extracted from the SCCP and MTP layers and inserted into the equivalent lower routing protocol layers of the IP stack. Hence, according to this system, the routing data is extracted from the lower layers of the SS7 stack to allow routing of the data over IP, but the message data in the higher MAP and TCAP layers is not processed, and is simply carried on top of the routing layers of the IP stack.

FIG. 28b illustrates a method of routing MO messages according one embodiment of the present invention. According to this embodiment, the MO message is terminated at the MDC and a new message is created in an IP stack. In parsing the payload of the message, the MDC extracts the routing data for the destination address from the MAP layer of the SS7 stack. This extracted data is reformatted to be used directly in the routing layers of the IP stack. Hence, data is extracted from the MAP layer to be used for routing, unlike in the prior art system in which the MAP and TCAP layer data is carried on top of an IP stack and not processed in the protocol translation. In the present embodiment, the intermediate routing data contained in the SCCP and MTP layers of a MO message is not used to route the message over the IP network. Hence, messages may be routed more efficiently and more directly their destinations.

For “Roaming” mobile telephone users, for example, users who are roaming onto the home network from abroad, any message generated must be routed back over the network and sent back to their home SMSC (i.e. an SMSC on their home network). Hence, messages produced by roaming users must be sent back, via the G-MSCs, to the user's home network. Messages generated by roaming users and that have been captured by an MDC may therefore be routed over the separate IP network directly to the G-MSCs of the network. Alternatively, these messages may be selectively rejected by the MDC and returned to the MSC so that they may be routed over the SS7 network, as in the prior art network.

A further feature of one embodiment may be that the MDCs have selective message capture capabilities. For example, the MDCs may capture messages from the MSCs or G-MSCs according to the SMSC number contained in the DEST# part of the message. This may allow only messages destined for the SMSCs of the home network to be intercepted by the MDCs. Similarly, the MDCs may be set up to intercept only messages which have their final destination address within a particular range. In this way, the MDCs may capture messages according to at least one predetermined condition.

Once captured, messages may be routed in different ways according to an identifier of the type of message captured. The message type may be determined according to an identifier contained within the message for example, within the data accessible at the MAP layer. For example, messages identifier as “application-type” messages, may be routed directly to the IP network without further processing and without information being obtained by the AMSC. Hence, delivery of messages to their destinations may be made more efficient.

Similarly, a further feature of one embodiment may be that, if a particular application or mobile entity receives a large volume of incoming messages, a specific routing rule may be added into the routing table for delivery of messages to that application or mobile entity. This may allow messages to be routed more directly or more quickly to the destination application or mobile. For example, messages that are sent to an application to “vote” for a particular person/event may be routed directly to that application. This maybe particularly advantageous since such SMS “voting” generates a large transient volume of messages, which would require a large amount of processing power if each “vote” was to be processed individually.

In the embodiments described above, the separate network offloads messages from a telecommunications network which communications using the SS7 layer. It may be noted, however, that the system and methods described herein are directly applicable to other networks from which it is desired to offload traffic. In particular, the system may be implemented within a 2.5G or a 3G telecommunications network and the separate network of components may communicate with the telecommunications network components over communication links which use the protocol of the telecommunications network. By way of example, FIGS. 16 to 9 incorporate SGSN components (Serving GPRS Support Nodes), which are fully integrated into the present system in a similar way to the MSCs, over communication links to the MDCs.

In the embodiments described above, the MDCs and other components of the separate network connect to components within the SS7 network over SS7 links. It would be possible, however, to modify the components of the telecommunications network so that they can connect to the components of the separate network using other protocols, such as IP, or SMPP (Short Message Peer-to-Peer).

It is also noted that, a single MDC may be connected to a plurality of components of the telecommunications network, for example, to a G-MSC and an MSC.

In an alternative embodiment, the system may be implemented without a MTMS or other message handling component. In this embodiment, the individual MDCs may each perform functions such as destination lookup locally, or each MDC may have direct access to the HLR of the telecommunications network to provide this capability. Other functionality that may be provided by each MDC may include, a prepaid credit lookup facility and an IMSI lookup facility. These capabilities may be provided at each MDC individually, or may be provided between a group of MDCs at a central point. Storage capabilities may also allow each MDC to store messages that cannot be delivered immediately to their destination entities, however, it would be preferable for each MDC to have access to a central memory storage unit, which may provide message storage capabilities for a number of MDCs. Existing components in the telecommunications network, such as the SMSC, may be used provide, for example storage capabilities or other functionality to the MDCs. Hence the existing functionality of the telecommunications network may be utilised by the MDCs. In addition, a number of different types of MDC may be implemented within a single telecommunications network. Different types of MDC may comprise different functionality, for example, one type of MDC may provide local destination lookup capabilities whilst a second type of MDC may request destination lookup from a central message handling component. In addition, different MDCs within a single network may handle messages in different ways according to different predetermined conditions or different routing rules stored within each MDC.

In a network of MDCs which has a central message handling component, it may be possible to control each MDC from the central component. For example, it may be possible to modify predetermined conditions set within each MDC from the central component and hence change, for example, which messages are captured by each MDC or which messages are sent back from the MDC to the telecommunications network.

In summary, the embodiments described above minimise traffic and so reduce congestion on the SS7 layer both by passing messages over a separate network for as large a proportion of their journey as possible and by minimising the distance travelled by each message by allowing routing at the MAP layer. This relieves congestion particularly at the STPs of the mobile network and also allows application-terminated messages to be transferred directly to the application across the separate network from a position close to the originating mobile.

Further aspects of a system which facilitates the sending of messages between Short Message Entities (SMEs), which term includes any device that is capable of sending or receiving short messages, such as a mobile telephone, are described below. Aspects of the system described below are preferably implemented in conjunction with the system described above. The system may be used for the transmission of SMS messages in a GSM network, but can also be applied to the transmission of messages in other networks (for example a third generation (3G) network).

The system described below relates particularly, but not exclusively, to the sending of SMS messages between mobile telephones and applications. SMS was originally designed to transmit a small number of messages, such as voice-mail notifications or mobile-to-mobile messages, within a single operator network. By way of background, each user is normally assigned a home Short Message Service Centre (SMSC) which handles messaging for that user. An SMS message is first sent to the home SMSC of the user originating the message. To route a message to its recipient, a request for routing information is normally sent by the SMSC to a Home Location Register (HLR) which contains information for the mobile for which the message is destined. The HLR supplies routing information leading to the Mobile Switching Centre (MSC) connected to the radio link which is in communication with the destination mobile.

The basic system works within a network but a problem arises if the destination mobile is on a different network as the network HLR will not have an entry for the destination mobile. To overcome this, gateway MSCs (GMSCs) have been introduced, under network interconnect agreements, to enable mobile-to-mobile message transmission between users on different networks; this is achieved by routing the request for routing information via a gateway connecting networks of different operators. However, the home SMSC remains responsible for delivering outbound messages.

As well as user to user communication, it has been proposed to communicate messages between applications and users. A simple solution to the problem of sending messages between an application and a user is to use a mobile modem. In this solution, a mobile telephone (or a dedicated GSM radio modem) which is assigned a mobile number (Mobile Station ISDN (MSISDN)) is connected to an application (for example, via an infrared link or a cable to a computer running an application) so that the device receives incoming SMS messages and forwards them to the application. The modem or telephone behaves exactly as another mobile user (it is physically equivalent) as far as the network is concerned, and gateways which allow network to network interconnection operate as normal. However, this solution has a very limited throughput of SMS messages, typically only of the order of one message every seven seconds, and also uses the expensive and potentially unreliable air interface. This solution is not readily scalable. Limited scalability for outgoing messages can be achieved by providing multiple modems but each of these must have a unique MSISDN number and occupies valuable and limited air interface bandwidth and there is a limit to how many devices can be accommodated in a cell. Furthermore, incoming messages are still limited in throughput per mobile number (and it is not normally practicable or desirable to have to give potential senders of incoming messages multiple incoming numbers to try in the hope that one will be capable of receiving messages). Thus, this is not a practical solution to the problem of sending (and more particularly receiving) high-volume SMS traffic.

For serious applications requiring a high throughput, a completely different approach has therefore been adopted. A solution to the basic problem can be achieved by connecting an application directly to the mobile telephone network at an SMSC and allocating a “short code” to the application. “Short codes” differ from standard MSISDN numbers in that they are typically only a few digits long and each SMSC only has a limited number of “short codes” that it can allocate to applications. Using proprietary techniques, a message arriving at an SMSC addressed to a “short code” can be intercepted by the SMSC (assuming the SMSC is configured to recognise the short code) and sent directly to an application using a proprietary “back end” interface, rather than being routed over the telecommunications network.

A problem with this system is that, since it requires the SMSC to “intercept” the message rather than send it over the network, mobile telephone users can only send messages to an application connected directly to their home SMSC. Messages that arrive at an SMSC addressed to an application short code cannot be routed across the network to other SMSCs and if a message is sent to a “short code” that is not configured on a particular user's home SMSC the message will not be delivered. For the application providers, this means that to obtain useful coverage an application must be connected to all SMSCs of relevant users. Another problem is that “short codes” are intrinsically “local” to an SMSC and different networks may not assign the same “short codes” to the same application, even if the application has been connected directly to multiple SMSCs in multiple networks. A further problem with connecting an application directly to an SMSC is that a further load is placed on an important network element and a faulty connection to an application may cause the SMSC itself to fail causing network disruption. Network operators therefore need to perform rigorous tests on any application having a connection to their SMSCs.

To overcome some of the limitations of the above method, it has been proposed to exploit a provision in the GSM standards to allow messages to be sent flagged “reply-by-same-centre”. This potentially allows users on any network who have received an initial message to reply to SMS messages by sending the reply via the SMSC from which the message originated, rather than the user's normal home SMSC. The message can then be intercepted at the originating SMSC and so the need for connections to multiple SMSCs is avoided. However, this only works when replying to a message. Furthermore, as networks are generally designed so that users always use an SMSC within their own network to send outgoing messages, this usage may cause problems for network operators. As a result, the provision allowing “reply by same centre” has now been blocked on some networks.

The present system, outlined in more detail below, addresses these and other problems, aiming to facilitate messaging with fewer limitations.

independent claims and preferred features are set out in the dependent claims. Preferred features of each aspect may be applied to other aspects and may be combined unless otherwise stated. Advantages of the system are set out below.

In a first aspect, the system described herein provides a method of routing a message to an application via a mobile telecommunications network, in which mobile devices are assigned globally unique mobile identifiers, comprising: assigning at least one virtual mobile identifier to the application; receiving a request for location information for said virtual mobile identifier; and supplying routing information corresponding to a static connection to said application in response to said request.

In a second aspect, the system described herein incorporates a method of providing routing information across a mobile network for at least one application comprising: storing at least one globally unique identifier; storing an identifier of at least one application assigned to the at least one globally unique identifier; storing routing information for the at least one application via at least one predefined connection point; and responding to requests for location information for the globally unique identifier by supplying routing information for the assigned application.

By assigning a virtual mobile identifier (which preferably has a format corresponding to the format of a real mobile identifier) to an application, the network(s) involved in passing on the message will at least initially treat a message destined for an application as a message for another mobile. Thus routing across network gateways (for example) is performed automatically using existing technology. However, in response to a request for routing information for the virtual mobile identifier, the routing information supplied actually ultimately leads to a static connection to an application (instead of pointing to a switch connected to a radio link as it would in the normal case). In this way, communication may be seamlessly directed to an application from any message originator's home SMSC without requiring the message originator's home SMSC to be modified or to be connected to the application—the application is effectively treated by the originating SMSC as a remote mobile device.

The term “static connection” is preferably intended to connote a connection other than a conventional connection to a mobile device and preferably connotes a connection which is pre-configured. The connection preferably does not require use of the air interface. This is advantageous since bandwidth on the telecommunications air interface is expensive and so the interface easily becomes congested. However, the static connection may include multiple connections and may be updated or re-configured.

The routing information for the static connection is preferably periodically updated. One purpose of the updating process is to monitor the availability of the applications assigned to the virtual mobile numbers so that messages are not routed to applications that are unavailable to receive those messages.

In a preferred embodiment, more than one virtual mobile identifier may be assigned to each application.

Having a range of identifiers for a single application gives the application operator the flexibility to provide a multi-channel service; for example, using one application to record votes for different people in a television contest depending on the mobile identifier number used to submit the vote.

Preferably, the virtual mobile identifier has the same format as the globally unique identifiers used for mobile devices in the mobile network; for example, it may comprise an MSISDN number (which, in this case, is assigned to an application rather than a mobile device). This allows an application operator to use one number that subscribers of every network can access and which is in a form easily recognisable to potential customers.

In one implementation, the location information is stored in at least one network element containing location information for a plurality of mobile devices the location information may be stored as entries in an existing network Home Location Register (HLR). This gives the advantage that requests for location information for a plurality of “real” mobile devices and also for “virtual” mobile devices, such as an application, may be directed at the same network element.

However, more preferably, the mobile network may have a first network element, typically a Home Location Register (HLR), that stores location information for mobile devices connected to the network, and a second network element containing location information corresponding to the application. That is, preferably, the location information corresponding to the application is stored in a network element separate to the HLR. This reduces the load on the network's HLR (which must cope with multiple requests rapidly) and may also allow greater flexibility for virtual mobile devices, as will become apparent.

A further advantageous feature is that a plurality of physically separate network elements may be used to store location information for the applications. This is advantageous since, if one of the network elements fails, only the applications with location information stored in that network element will no longer be able to receive messages; the majority of the applications will be unaffected since their routing information will be stored elsewhere.

A further feature is that the plurality of elements storing location information are preferably located at geographically disparate locations; this can increase fault tolerance and reliability. For example, if there is a power outage at one of the geographically disparate sites, then the elements at the other sites will continue to operate.

Most preferably, more than one of the plurality of physically separate network elements stores routing information for the same application. This is advantageous since it further increases fault-tolerance and reliability; ff data is lost from one network element, then a copy of this data can be used from another network element. For a conventional HLR, there must be only a single master copy of the routing information. However, it has been appreciated that multiple copies can be stored for a virtual mobile device. A further advantage of more than one network element having a copy of the routing data for an application is that messages for applications can be routed by network elements that are located close(r) to the elements requesting the routing information. This may mean that the routing information may be transferred shorter distances across the network saving on expensive SS7 bandwidth.

Preferably, the plurality of physically separate network elements is connected by a data transfer link separate to the mobile network. This allows routing information to be transferred between the location network elements without using the limited/expensive SS7 bandwidth. A further advantage of providing a separate data transfer link is that it relieves the load on the telecommunication (SS7) channels.

In a preferred embodiment, this separate data transfer link is an Internet Protocol (IP) network. An IP network may provide the advantage of cheaper and more resilient bandwidth than an SS7 network.

An advantageous feature facilitated by the fact that data can be transferred without causing SS7 congestion between the network elements is that the location data stored can be exchanged and periodically updated between the network elements.

This means that more than one location network element can store the most up to date location data for an application.

The system described herein further provides a method wherein a predefined connection point to a mobile network is provided via a network element providing a static connection between a mobile switching centre (MSC) and an application. If a dedicated network element is used to connect the application, via a static connection, to an MSC of the mobile network, then all messages for the application can be routed through this network element. Preferably, the static connection of the application to the mobile network does not pass over the air interface. Again, this has the advantage of further decreasing the load on the air interface, which may make it cheaper for application operators to connect to the mobile network. In a preferred embodiment, the connection of the application to the network element providing a static connection between an MSC and an application is over an Internet Protocol (IP) network. An IP network provides cheaper bandwidth than the common SS7 telecommunications air interface. A further advantage of using IP to connect the applications via the network element to the mobile network is that IP is already widely known and used, so it is relatively straightforward for application operators to implement the connection. Preferably, the connection of the application to the network element providing a static connection between an MSC and an application is a secure connection over an open network. This provides the advantage that messages can be transmitted over a resilient network but securely between the network element and the application.

Preferably, the static connection between the application and the network element providing access to the mobile network via an MSC may be updated or reconfigured. This feature allows location and routing information stored for the applications to be updated when applications are unavailable to receive messages, or when they again become available. It also allows the route taken to deliver a message to a particular application to be changed, for example, so that the message is delivered through a different network element.

A further preferable feature is that the static connection of the application to the mobile network bypasses a Short Message Service Centre (SMSC), at least for messages directed to the application. This may prevent large peak loads being placed on the SMSC, for example if multiple users send a message to an application at a given time. As explained in more detail below, this is advantageous to both the network operator, whose SMSC does not have to deal with the large peak loads in incoming messages, and to the application operator, who does not have to purchase a large busy hour licence on the SMSC to cover large peaks in incoming messages.

In a further aspect of the system described herein, an application is connected to the mobile network via a plurality of network elements each providing a static connection between an MSC and the application. One advantage of connecting the application to the mobile network via a plurality of network elements is that a further degree of redundancy and fault tolerance is introduced into the system. If one network element fails, then messages can be routed to the application through one of the other network elements. Furthermore, the load can be shared between network elements. As discussed in more detail below, this aspect of the system facilitates the possibility that the routing information provided for the application need not always be through the same network element.

Preferably, the plurality of network elements providing a static connection between an MSC and an application are interconnected by a data transfer link separate to the mobile network. Again, this allows communication between the network elements to take place without using expensive SS7 bandwidth. Connection between the network elements may be used to communicate information regarding the static connections to the applications between network elements. This information may include status information about the applications, such as the availability of the applications to receive messages.

A further aspect of the system described herein provides a method wherein at least one location network element contains location information for the application and at least one switch network element provides a static connection between an MSC and an application, and wherein the or each location network element and the or each switch network element are interconnected by a data transfer link separate to the mobile network. This embodiment both to supplies routing information for the application to the mobile network and, in addition, provides a static connection through which to route messages to the application. As discussed above, it is preferable to have the plurality of location network elements interconnected by a data transfer link separate to the mobile network and to have the plurality of switch network elements interconnected by a similar link. In this embodiment, the system further provides a data link between the plurality of location network elements and the plurality of switch network elements. Communication between the location network elements and the switch network elements may be used to implement features such as monitoring of the load on the switch network elements by the location network elements. This may be used by the location network elements to perform load balancing between the switch network elements (e.g. by selecting routing information) to ensure maximum message throughput.

A further preferable feature is that a location network element is connected to a plurality of switch network elements each switch network element, providing a static connection to the network for the application. This provides redundancy in the application connections to the mobile network. This feature may allow messages to be routed to the application via more than one switch network element.

In a further aspect, the system described herein provides a method comprising generating a call data record (CDR) for a virtual mobile device containing information including at least one of: the originator's MSISDN number; the service centre (SC) number; the recipient's MSISDN number; the time/date that the message was sent; identification of the originating account owner and; the billing plan of the originator. This feature may be used within the system, or externally to the system to provide information such as, the rate of messages passing through the system and the number of messages passed to each application.

Preferably, the method further comprises providing remote access to the call data records. This allows a separate network element to access the records for purposes such as billing the message originator.

Preferably, the location network element selects the static connection through which to route a message to an application based on at least one predetermined criterion. This feature may allow a message to be routed to the application more effectively than by routing all the messages in the same way.

Preferably, the routing information provided for a given application varies between network elements within the plurality of network elements. An advantage of this is that the routing information provided to the requesting element may vary, for example, according to factors such as the location of the source of the request. For example, messages may be routed to travel a shorter distance on the SS7 network.

A further aspect of the system described herein provides a method for providing routing information across a mobile network for at least one application wherein the routing information supplied in response to a request for information is selected based on at least one condition other than the location of the application. This feature provides the advantage that factors other than the application location may be used to determine the best way for the packet to be routed to the application. Factors such as the load on the connections to the application and the proximity of those connections to the source of the request may be incorporated. The advantages of incorporating these factors are discussed in more detail below.

Preferably, the routing information is dynamically compiled in response to a request. In contrast with a conventional HLR which simply retrieves stored information on request, “active” routing for an application may be performed. The routing information is preferably compiled based on the location information for the application, which is stored in the location network element, and on other predetermined conditions.

Preferably, the routing information supplied comprises information selected from a plurality of available connections to the application based on the location of the source of the request. As mentioned above, it may be advantageous to base the routing information supplied on the location of the source of the request so that the message may travel a shorter distance using SS7. Using this feature, the message may be transferred to a switch network element that is connected to the application and that is also situated close to the source of the request rather than a switch network element situated further from the source of the request. As discussed in more detail in the description, the distance between the source of the request and the connections to the application may simply be based on a measure of the geographic distance between the elements, or it may be a measure of the “network” distance between the elements on the mobile network, which may take into account cost and/or availability of links.

Preferably, the routing information is provided based on a measure of application availability. For example, messages may not be sent to an application unless the application is available to receive the messages. This may have the advantage that messages are automatically stored in the originator's SMSC until the application becomes available.

Preferably, a route is selected by the location network element based on measures of availability of a plurality of connections to the application. In this way, the location network element can perform load balancing between switch network elements. If one switch becomes particularly busy, the location network element is preferably able to direct further messages towards a less busy switch network element.

Preferably, a further condition governing delivery of a message to an application is based on the availability of the connection point to the application. This ensures that routing information is not provided for messages to be sent to an application if there is no connection available to that application.

A further aspect provides a system for delivering messages including means for monitoring the availability of at least one application connected to a mobile network. This may include means for signalling that an application is unavailable to the network, preferably in the same way as unavailability of a mobile device is signalled. Preferably, the information provided by the monitoring means can be used to update or modify routing information to be supplied based on a measure of application availability.

Preferably, the routing information provided is based on a combination of at least two criteria. More than one criterion may be used to determine the best way of routing the message to the application. Preferably, the combination of predetermined criteria is calculated including a weighting factor for each of the criteria. This allows more importance to be assigned to certain factors than to others. For example, it may be preferable that the message is routed through a less busy switch other than through a switch closer to the source of the request.

A further aspect of the system described herein provides a method of connecting at least one application to a mobile network comprising: providing a connection for at least one application; and providing a connection at the core network signalling protocol layer to at least one switch on the mobile network and; routing a message directed to the application via said connection. Connecting the application to a switch on the mobile network at the core network signalling layer may mean that incoming messages for the application do not have to pass through the air interface or an SMSC.

The core network signalling protocol preferably comprises the SS7 protocol. If the switch network element connects to the mobile network using this protocol, then few changes need to be made to the mobile network to incorporate the new switching element.

Preferably, the connection to the at least one application is over a data transfer link separate to the mobile network and the separate data transfer link preferably comprises an Internet Protocol (IP) network, the advantages of which are also discussed above and in the more detailed description which follows.

Preferably, the connection to the at least one application is via a gateway, which provides an interface between the at least one application and the mobile network. The gateway may provide an interface between the protocol(s) of the mobile network and at least one other protocol used by an application.

Preferably, the gateway provides a secure connection between the application and the mobile network.

Another preferred feature is that the connection to the at least one application bypasses the air interface of the mobile network. As discussed above, this is advantageous since the air interface is expensive and easily becomes congested.

Preferably, the connection to the application comprises a connection via a switch dedicated to serving the at least one application. This has the advantage that the switch only has to deal with routing traffic for the at least one application and means that it is not congested with routing traffic for other mobile devices.

A further aspect of the system described herein provides a computer program or computer product comprising instructions for performing a method according to any of the preceding claims.

A further aspect of the system described herein provides a data packet for transmission over a network carrying information regarding the status and location of an application.

Preferably, the location information within the data packet includes information for routing a message to the application.

A further aspect of the system described herein provides a data structure stored in a network element comprising at least one virtual mobile identifier, an identifier of at least one application, and an assignment of at least one application to at least one virtual mobile identifier.

The system described herein further provides apparatus that is capable of carrying out any one of the methods described herein.

A further aspect provides a method of routing messages between an application and a mobile telecommunications network wherein messages are passed from the application to the mobile network without passing through a Short Message Service Centre (SMSC). This may be advantageous in reducing the load on the SMSCs of the mobile network and may allow application operators to overcome many of the problems described herein and which arise in connecting an application to an SMSC and in sending large volumes of messages from an application through an SMSC, particularly if the messages are sent in transient spikes.

Preferably, the method of routing messages further comprises: receiving the message from the application over a static connection, requesting routing information for the globally unique identifier associated with the destination address of the message and routing the message to the message recipient via the mobile network.

Preferably, the method further comprises routing messages from the mobile network to the application according to the method of the first aspect or any of its dependent features. This may allow the provision of a full two-way messaging service for applications connected to a mobile telecommunications network. Means both for sending and for receiving messages may be provided via one connection to the network.

Preferably, the static connection of the application to the mobile telecommunications network does not pass over the air interface. This may reduce the load on the air interface and may allow the application to connect to the network using a well-defined standard protocol, rather than using a proprietary interface.

Preferably, the message is routed to the message recipient via at least one component in a network of message delivery points, the message delivery points being interconnected over a network separate to the mobile telecommunications network and the separate network being connected to the SS7 layer of the mobile telecommunications network at a plurality of points. This may allow the use of the SS7 layer to be minimised in the delivery of each message.

Preferably, messages are automatically rejected according to at least one predetermined condition. This may allow some automatic control of where messages are sent to and received from.

Preferably, the at least one predetermined condition includes the destination address of the message. This may allow the provision of mobile station blacklisting, which may be used to block applications from sending messages to barred mobile stations, or to groups of mobile stations, such as those on a particular network.

More preferably, the at least one predetermined condition includes the identity of the service centre by which the routing information for the application was requested. This may be used to block the sending of messages to the application from particular SMSCs on the mobile network, such as the SMSCs of a particular operator.

Preferably, at least one service feature may be made available selectively to at least one application. This may allow the provision of a more specialised service for each application.

Preferably, a predetermined subset of service features may be provided to at least one application. Particular service features may be made available to some applications. This may be done by the request of the application operator, or some features may be provided automatically to applications with particular properties, for example it may be advantageous to provide particular additional features to applications that send large transient volumes of messages. Providing sets of preferable features may also be useful for limiting users to certain types or levels of service.

Preferably, the at least one service feature comprises the provision of at least one of: the “Outbind” procedure, windowing and support for enhanced messaging services. These features may allow some application operators to provide an enhanced service to their users.

Preferably, the method further comprises generating internal system reports. More preferably, the data contained in the internal system reports includes at least one of: usage data, provisioning information and error records. This may allow monitoring of the system as well as fault detection and resolution.

Preferably, the method further comprises generating user reports for specific applications. These reports may be made available to application operators or may be used internally to monitor usage of the system by individual applications.

Preferably, the method further comprises providing at least one advanced messaging function. More preferably, the at least one advanced messaging function includes at least one of: sessions, variable retry schedules, variable priority levels, support for native Smart Messaging (for example, those constructed from RTTTL, GIF, BMP) and support for Enhanced Messaging Service functions. This may allow a wide range of messages to be sent and received by the application.

The provision of voice services by the application is preferably also facilitated. This may allow the application to use the same connection to the mobile network for both SMS based services and voice services.

A further preferable feature is that at least one message comprises a multimedia message.

In addition, the method may further comprise providing support for high density signalling on the mobile telecommunications network.

In a further, apparatus, aspect, there is provided apparatus for routing messages between an application and a mobile telecommunications network comprising:
means for routing messages from the mobile network to the application according to the method of the first aspect or any of its preferable features;
means for routing messages from the application to the mobile network comprising:
means for receiving the message from the application over a static connection;
means for requesting routing information for the globally unique identifier associated with the destination address of the message;
means for routing the message to the message recipient via the mobile network.

A further apparatus aspect provides apparatus for routing messages between an application and a mobile telecommunications network wherein the apparatus communicates with the mobile telecommunications network at the SS7 layer and the message is passed to the network bypassing the network SMSCs.

According to a preferable feature of the apparatus aspects, the memory type used to store the message received from the application depends on the length of time the message is to be stored.

Preferably, a first type of message storage capability is used for a message that can be routed to its destination without delay. This may allow very fast data throughput for messages that do not need to be stored in the apparatus. The message may be stored in a memory persisted database until routing information is received for the destination address of the message.

More preferably a second type of message storage capability is used for a message that cannot be routed to its destination without delay and which must be stored in the apparatus. This may allow the message to be stored on a magnetic disk, or other long term storage means, if it is not possible to immediately route the message to its destination address once the routing information has been received. Magnetic disks may provide a reliable long term message storage solution.

Preferably, the apparatus further comprises means for providing support for storage area networking with distributed data stores and data mirroring. This may provide a resilient, robust and flexible data storage system.

Preferably, a web-based management and provisioning interface is also provided. This may allow the apparatus to be modified, for example to allow further applications to be connected. It may allow a single access point for management access to the apparatus from any location, even if the network has a wide geographical distribution.

According to a further aspect, there is provided a method of routing at least one message between an application and a mobile telecommunications network via at least one component in a distributed network of message delivery points wherein the distributed network is separate to the mobile telecommunications network and the separate distributed network is connected to the SS7 layer of the mobile telecommunications network at a plurality of points.

A further aspect provides a method of routing at least one message between an application and a mobile telecommunications network comprising routing the message via;
a plurality of message delivery points interconnected over a network separate to the mobile telecommunications network and providing an interface to the SS7 layer of the mobile telecommunications network at a plurality of points;
an application service centre as described in a preceding aspect or any of its preferable features connected to the application and connected over the separate network to the message delivery points.

Preferably, at least one of the message delivery points of the previous aspects intercepts any outgoing message from a short message service centre (SMSC) on the mobile telecommunications network. Hence messages may be intercepted as soon as possible after entering the mobile telecommunications network, reducing the load on the SS7 layer.

Preferably, at least one of the message delivery points intercepts any message entering the home network at a gateway message switching centre (G-MSC). This may facilitate a further reduction in the traffic on the SS7 layer of the home mobile network.

In further advantageous feature, the at least one message is routed over the separate distributed network to the message delivery point that minimises the distance travelled by the message over the SS7 layer of the mobile telecommunications network. In this way, messages may be transmitted over the separate network for the maximum possible proportion of their journeys which may reduce the volume of traffic on the SS7 air interface and allow the mobile telecommunications operator to minimize the SS7 overhead on their network. The separate network may comprise, for example, an IP network.

A related aspect provides apparatus for routing at least one message between an application and a mobile telecommunications network comprising;
a plurality of message delivery points connected over a network separate to the mobile telecommunications network and providing an interface to the SS7 layer of the mobile telecommunications network at a plurality of points;
an application service centre as described in the previous apparatus aspects or any of their preferable features connected to the application and connected over the separate network to the message delivery points.

An embodiment of the system described herein will now be described by way of example only with reference to FIGS. 1 to 15, the contents of which have been described above.

In a preferred embodiment, the system is incorporated into a network, preferably defined by the GSM standards, to allow mobile originated, application terminated SMS messaging across networks of different operators without necessarily requiring more than a single operator connection.

By way of illustration, the system will be described in the context of a GSM network. However, it is to be appreciated that the principles are not so limited and may be applied to other mobile telecommunications networks in which routing information is supplied to enable a message to be passed to a mobile device.

Terminology used for convenience and ease of understanding throughout this specification (description, claims and drawings) which corresponds to particular components of a GSM network is to be construed as extending to components of other networks possessing the relevant functionality. To assist, certain terms and a non-limiting outline of relevant functionality will be explained:—
MSISDN (Mobile Services ISDN)—an identifier of a mobile device, preferably globally unique.
HLR (Home Location Register)—a store of at least one identifier of a mobile device and location or routing information for the device.
SMSC (Short Message Service Centre)—a network component which handles short messages, preferably by forwarding to a destination
Short Message or SMS message—a message, typically a packet having a defined length and format and typically distinct from a stream such as voice channel (the system is not limited to any particular message format or length or even to discrete packets)
MSC (Mobile Switching Centre) or switch—a component capable of routing traffic in a network.

In order to explain more clearly the features of one embodiment of the present system, we begin with a more detailed description of the existing SMS system in a GSM network follows, with reference to FIG. 1.

The Short Message Service (SMS) was designed as part of the GSM (Global System for Mobile communications) specifications. One skilled in the art will be aware of the relevant GSM standards, to which reference should be made and which are incorporated herein by reference. In particular, reference should be made to GSM03.39, GSM03.40, GSM03.41, GSM04.11, GSM04.12, GSM07.05, GSM09.02 all incorporated herein by reference.

The principles of GSM messaging are well known to those skilled in the art and are succinctly summarised in “A tutorial overview of the short message service within GSM.”, G. Peersman et al., Computing and Control Engineering Journal, vol.11, no.2, April 2000, 79-89., the entire content of which is incorporated herein by reference.

As defined in the GSM standards, Short Messages are messages that contain up to 140 bytes of raw data, or 160 characters in single character sets. For ease of the following discussion, messages can be classified as one of three types; mobile-to-mobile, application-to-mobile (also known as one-way or mobile terminated (MT) messages) and mobile-to-application (also known as two-way or mobile originated (MO) messages).

Mobile-to-Mobile Messaging

Reference should be made to the schematic overview of the process of mobile to mobile SMS messaging presented in FIG. 3.

A short message is generated by a user at a Short Message Entity (SME), in this case, the user's mobile telephone 18. In addition to the 140 bytes of raw data that can be sent in the message, the message also incorporates a header which contains an identifier of the originating mobile 18, the identifier of the originating user's Short Message Service Centre (SMSC) 13, and the identifier of the recipient mobile 26 or 27; in this case, the mobile telephone number of the receiving user. Since the originating and terminating SMEs are, in this case, mobile telephones, the identifiers are the Mobile Station ISDN numbers (MSISDNs) of the devices.

The mobile 18 transmits the message via its base station 17 to its local mobile switching centre (MSC) 14, which sends it on to the originator's home SMSC 13, defined by the SMSC number in the message. The SMSC 13 must then route the message to the recipient number. Before doing this, the SMSC checks whether the recipient number is in fact a short code and, if so, whether the short code corresponds to an application to which the SMSC is attached, as discussed in more detail below. Assuming the destination identifier is an MSISDN number, as it will be for mobile-to-mobile messages, the SMSC must find a Home Location Register (HLR) entry for the recipient mobile 26 or 27. The HLR entry contains information such as the last known location of the recipient mobile 27, subscription information and any service restrictions. Further details of the HLR specification can be found in GSM standard 09.02.

Mobile telephone network elements communicate using the Common Channel Signalling System No. 7 (SS7) protocol defined by the International Telecommunication Union (ITU) and is used by the elements of the telephone network to communicate, facilitating call setup, routing and control. Using this protocol, the SMSC sends a “send routing information” request to an HLR which contains the relevant information for the destination mobile.

If the recipient mobile user 27 is a subscriber to the same network as the originating mobile user 18, then the SMSC 13 will find a HLR entry for the recipient mobile within its own network HLR 15. Having obtained the HLR information, the SMSC can then send the message to the MSC 29 corresponding to the last-known location of the recipient mobile 27 and the MSC 29 can transmit the message to a base station 28 for broadcast to the mobile 27. If the mobile is not available or does not have the capacity to receive messages at that time, then a message is sent by the MSC 29 back to the SMSC 13. The SMSC 13 retains the message and enters a retry cycle, attempting to send the message again after a specified amount of time. This retry cycle will continue either until the message has been sent, or until a predetermined time period has elapsed. If the network supports the Mobile Waiting Data (MWD) feature, then the HLR will record the identity of the SMSC that attempted to send data and can send an “SC alert” signal to instruct the SMSC to resend the message as soon as the mobile becomes available again.

If the recipient mobile 26 is not a subscriber to the same network as that of the originating mobile 18 then an HLR entry will not be found for the recipient identifier in the SMSC's home network. To obtain the routing information, the SMSC's “Send Routing Information” request (provided the network has interconnect agreements and gateways in place) is routed across the network by the MSCs (using a routing protocol such as SCCP routing), to break apart the recipient number contained within the request, and determine where the request is to be sent. For example, the first group of numbers gives the country code for the recipient mobile and the second group is defined according to which operator network the mobile user subscribes to. Using this routing method, the request is sent to the appropriate network via the Gateway MSCs (GMSCs) 19,20 that connect the different operator networks under interconnect agreements. Once the message reaches an MSC 24 of the recipient mobile user's network, the “Send Routing Information” request is passed to the HLR of that network 21. The HLR 21 determines the last-known location of the recipient mobile 26 and, assuming the mobile is available to receive messages from the sender, the routing information for that mobile device is sent back to the requesting SMSC 13. The message itself is then sent by the SMSC through the relevant gateways across the network to the MSC 24 corresponding to the recipient 26 for broadcast by the base station 25.

Application-to-Mobile Messaging

Reference should be made to the schematic overview of the process of application to mobile messaging presented in FIG. 4.

For an application 10 to send messages, it must be connected to an SMSC 13. Applications 10 generate mobile-terminated (MT) SMS messages and deliver them to the SMSC 13. These messages are communicated to the SMSC 13 via proprietary protocols (these are not defined in the GSM standards and so are specific to the network operator and the SMSC manufacturer). Once the SMSC has received the message from the application, it deals with the message in the same way as a message received from a mobile device.

It can be seen that for outbound transmission, the process is as for mobile-to-mobile messages, as described above. This means that, for example, application-to-mobile messages can be sent in the same way as mobile-to-mobile messages to mobile devices connected to networks of other operators and so outbound messaging is relatively straightforward, provided that a suitable and robust connection can be made to an SMSC.

Mobile-to-Application Messaging

Reference should be made to the schematic overview of the process of mobile to application SMS messaging within a single network presented in FIG. 5.

Applications 10 connected to an SMSC 13 are assigned a “short code” so that the SMSC can uniquely identify the application. When an mobile device 18 sends a message to the network, that message is sent to the home SMSC 13 of the originating mobile device 18. As discussed above, the SMSC 13 recognises “short codes” and a mobile device 18 can send messages to applications connected to its home SMSC 13 by addressing the messages to the application “short code”. Provided the application is connected, the SMSC 13 will recognise the recipient number as a “short code” and route the message directly to the application 10. In this way, mobile devices are able to send messages to applications that are attached to their home SMSCs using “short codes”.

However, as can be seen from FIG. 6, it is not possible for mobile-to-application messaging to occur across networks using the “short code” system (and there may even be problems within a single network ff there is more than one SMSC). The “short code” for a particular application is local to the SMSC that the application is connected to and no routing is performed or can be performed based on short codes to other SMSCs. By way of illustration of the limitations, we consider a mobile device from one network 26 trying to send a message to an application 10 connected to an SMSC on another network 13. The message is sent via the base station 25 and the MSC 24 to the originator's home SMSC 23. This SMSC 23 does not recognise the recipient's number as an application “short code”, as the application is not connected to that SMSC and the message delivery fails. Worse, an SMSC may coincidentally recognise a short code and deliver the message to a local application other than the intended application but which has locally been assigned the same short code. Solution of this problem would potentially require both a connection to all relevant SMSCs (potentially every SMSC globally) and organisation to ensure that all applications are allocated consistent short codes (which by virtue of being “short” are in limited supply) by all SMSCs.

As discussed earlier, using the “reply-by-same-centre” provision, an attempted solution has been proposed to alleviate the problem whereby it may be possible to allow SMEs on any network 26 to reply to messages sent by an application 10. When an application 10 sends a message to an SME on another network 26, a flag embedded in the message can temporarily change the SMSC identifier in a user's telephone so that when the user 26 sends a reply to the message, that message is sent directly to the SMSC 13 of the application rather than the message being sent to the mobile user's home SMSC 23. In such a case, the SMSC can deliver the message to the application using a short code. However, it will be appreciated that the message will not be processed by an SMSC on the home user's network which may cause problems (for example if billing is performed on the home SMSC). Also, this requires the mobile device to be reconfigured temporarily and to send messages across networks directly. Both of these may cause problems for network operators and thus use of the “reply-by-same-centre” provision is problematic and has been blocked by some network operators.

A further problem with both solutions (even for messages within a network) is that applications may attract large peaks in the volume of SMS traffic. This may occur when many mobiles send messages to one application at approximately the same time; for example, if users are prompted by a broadcast (e.g. on a television show) to send messages to an application. In order to cope with such spikes, large and expensive busy hour licences for the SMSC must be purchased and an SMSC must be able to cope with peaks of much greater traffic than is normally required in the steady state. If the SMSC becomes overloaded, significant network problems can arise. Furthermore, there will normally be a physical limit on the number of application connections to an SMSC. This may mean that there is little scope for redundancy in this prior art system since, due to the limited number of connections available, an application may have only one connection to one SMSC in each operator network.

Preferred Embodiment

A preferred embodiment of the system will now be described in more detail, with reference to FIGS. 2 and 7.

In outline, this embodiment acts as a virtual mobile for the application, intercepting messages directed to the virtual mobile numbers and routing them to the corresponding applications. By acting as a virtual mobile rather than a conventional application having a short code, the routing facilities of the network may be used advantageously but by intercepting messages, the limitations of a physical mobile (connected via a dynamic connection over the air interface) may be avoided.

In a preferred embodiment, the application may be a software component having the capability to send and/or receive SMS messages. As will become clear, the embodiment is particularly advantageous for applications that receive large volumes of SMS traffic.

In overview, an embodiment may incorporate at least one component which is here termed a “Virtual Mobile Location Register” (VMLR) by way of analogy with an HLR. This contains the location and routing information necessary to direct messages sent to virtual mobile numbers to their corresponding applications. The embodiment may also incorporate at least one component here termed a “Virtual Mobile Switching Centre” (VMSC), which acts as an MSC for the at least one application, providing a connection between the mobile network and the application(s) that correspond to the virtual mobile numbers managed by the VMLR and preferably bypassing an SMSC. In this embodiment, the combination of the VMLR and the VMSC are together termed a “Virtual Mobile Redirector” (VMR).

A description of the operation this embodiment now follows with particular reference to FIG. 2 and also to FIG. 7.

This embodiment can be used to route messages across a network from a mobile device to an application. In this embodiment, the network is a GSM network, but, as explained above, in other embodiments, a similar arrangement may be used in alternative networks, such as a 3G network.

In accordance with this embodiment, an SMS message, created by a user of a mobile telephone 59 on a first operator network, can be routed to an application 40 connected to a second operator network, with only the second operator network requiring modification by incorporating a VMR, 49.

An application is assigned an identifier which corresponds to an MSISDN number within the domain of operator network A. Thus, regardless of where a message originates, the originating network will attempt to route the message to what appears to be a mobile device in network A.

By way of example, a message is sent from mobile device 59 in operator network B, via the base station 58 and the MSC 56 to an SMSC 55 on the user's home network. The SMSC 55 sends a “Send Routing Information” request to request routing information from the location register for the device to which the message is addressed. The destination will appear to originator SMSC 55 to be a mobile such as mobile 46 in network A and the routing information request will initially be routed across the network through the GMSCs 53 and 52 to the second operator network, to which the VMR 49 is connected. However, rather than passing the request to the HLR 50 which contains real mobile information, the MSCs 44 in Network A are configured to pass the request to the VMLR 48, which, in this embodiment, is a component of the VMR 49.

The VMLR 48 provides routing information to the requesting SMSC 55 which directs the message to the VMSC 47 attached to the application. The sending SMSC then attempts to deliver the message to what appears to be a mobile device using the VMSC 47 and the VMSC receives the message, terminates it in the manner that a mobile device would, and passes the content on to the application. In this way, the message is delivered to an application as a message to a mobile would be delivered, irrespective of the source of the message. It will be appreciated that, although the message in this example originated from a mobile device in network B, it could of course have originated in the same network A as the VMR and could have originated from an application.

The embodiment may include further advantageous features. It will be appreciated that connections to mobile devices may be subject to interruption, for example if a user is out of coverage or if the device is switched off. Location or routing information normally indicates availability as well as route to last known destination. Furthermore, even if a mobile has been indicated to be available, it may not be possible for an MSC to connect when an attempt is made to deliver a message. The features of mobile networks which handle such events can be exploited to advantage in preferred embodiments.

On receiving a request for routing information, the VMLR can determine whether the application is available (it may be busy, overloaded or not functioning) and can signal that it is not available even if a physical connection exists. If the application is deemed to be unavailable (in accordance with defined criteria such as load), the VMLR 48 responds to the “Send Routing Information” request by informing the SMSC 55 that the receiving device is not available to receive messages at that time. The SMSC 55 either tries to send the message again after a short interval or sends a message failure report for the message to the message originator 59. The VMLR 48 monitors the availability status of the application, and, in a preferred embodiment, sends a message to the SMSC to inform it when the application again becomes available to receive messages. The SMSC can then send the message to the application immediately, speeding up the process of message delivery. This aspect of the embodiment may take advantage of the Mobile Waiting Data (MWD) feature supported in many GSM operator networks.

As mentioned above, a message may be deemed undeliverable if either the receiving application or the VMR system is under extreme load and running low on capacity. In this case, the VMLR can throttle back the flow of messages from SMSCs in order to safeguard system stability. This is done, as in the case of unavailable applications, by returning the message back to the SMSC, forcing the SMSC into its retry schedule.

By way of background, the Mobile Waiting Data feature is part of the GSM standards and is implemented in many networks to allow messages to be delivered promptly to mobile telephones that reconnect after a period of unavailability. If a mobile telephone is unavailable when an SMSC sends a request for routing information to its HLR, then the HLR responds to the SMSC's request with a message to inform it that the mobile telephone is unavailable. The SMSC enters its message retry cycle in which it will wait for a predetermined length of time before trying to resend the message. The HLR records the identity of the SMSC that has a message for the telephone. When the telephone again becomes available, the telephone re-registers with the HLR and the HLR checks a list (an “MWD list”) to see if it has any messages waiting for that telephone. If the HLR discovers an entry in its MWD list for a telephone, the HLR sends an SC alert to the relevant SMSC informing it that the mobile telephone is now available to receive the message. If the SMSC recognises this, the SMSC may resend the message immediately rather than waiting for the next retry cycle (which may take hours) before the message is delivered. A preferred feature of this embodiment is that the VMLR may store the identity of an SMSC attempting message delivery to the application. If delivery fails, the VMLR may send an SC alert subsequently to the SMSC when the application is available.

If the application 40 is connected and available to receive messages, then the VMLR 48 responds to the “Send Routing Information” request by providing the routing information necessary for the message to be routed to the VMSC that the application is attached to. The VMSC 47 receives the message from the SMSC 55 and terminates the message, sending a delivery confirmation message back to the SMSC 55. The VMSC 47 then creates an application terminated message and sends it directly to the application 40, optionally via a gateway, which may be used to provide an interface between the application and the mobile network. If the application has become busy, the VMSC may also reject the message.

Possible embodiments of gateways that may be used to connect an application to the mobile telecommunications network are described in more detail below.

In one embodiment, the gateway connects at least one application directly to at least one SMSC in at least one mobile operator's network. This may allow the application to send SMS messages to entities on the mobile network and to receive messages from mobile entities on the at least one operator network to which the gateway is connected, as described above. One function of the gateway in this situation may be to provide a connection between the proprietary interface of the SMSC and the application, which may be connected to the gateway over a standard interface, such as an IP interface. The gateway may allow multiple applications to connect to each of the limited number of ports on the SMSC and may also provide security to the network operators by providing a firewall between the telecommunications network and the applications.

In a second embodiment, the gateway may connect an application to the VMSC of the VMR or to an Application Messaging Service Centre (AMSC). The AMSC is described in more detail below. This connection may be provided instead of, or in addition to, the connection to the SMSC described above. Connecting to the VMR or AMSC may allow applications to send and receive SMS messages to and from any mobile entity, regardless of the home network of that entity, as described above.

The operation and some features of two embodiments of gateways which may be used to connect applications to a mobile telecommunications network are described in more detail below. In this embodiment, the gateway is a software server that operates as a messaging transport enabler in a wireless data service offering. The gateway may facilitate the sending of messages from an existing, or a purpose-built application to the mobile network. This process may also be implemented in reverse for mobile users sending data from their devices to an Enterprise application or an Operator-hosted VAS. Applications that may connect to the gateway preferably include existing Enterprise applications (e-Mail, CRM, ERP and Workflow Engines), custom-built applications, or VAS (or other application servers) operated either externally or directly by a mobile operator.

As outlined above, the gateway may reside within the operator network and may be used to interface between an application and an SMSC of an operator network. Applications preferably connect directly to the gateway via a proxy interface using, for example, a TCP/IP connection. Once connected, data may be sent from the application, via the gateway, to the SMSCs of the operator. The gateway is therefore preferably compatible with a wide range of existing SMSCs, for example those produced by SMSC vendors such as CMG, Logica, Nokia, SEMA, ADC Newnet and Comverse. Multi-vendor operator environments are preferably supported. The gateway may transfer data to the SMSC via one of the SMPP, EMI/UCP, CIMD2, SMS2000 or OIS protocols, commonly used by mobile network operators. The SMSC connection may be managed within the ability of the individual connection protocol used. The gateway is preferably compliant with the telecommunications standard GSM 03.38 and is able to handle Alphanumeric (7-bit), 8-bit and UCS2 SMSC Encoding Types. Preferably, the gateway also provides support for the GSM Character Set and GSM Extended Character Set.

Preferably, the gateway acts as a firewall to the network core infrastructure, retaining overall network security. This may eliminate the need for new applications to be rigorously tested and verified before being connected to the mobile network.

An existing, or custom-built, application is preferably able to integrate with one of the client interfaces of the gateway via a proxy interface. Preferably, SMS applications may avoid having to use vendor specific protocols to interface with an operator's SMS infrastructure. The gateway preferably removes this barrier to entry for application programmers with a set of common APIs (Application Program Interfaces) (including SMPP (Short Message Peer-to-Peer protocol, described in more detail below)) that simplify development. Other APIs that are preferably supported include CIMD2, SMTP, SOAP (XML/HTTP), CORBA, POP3, Java Remote Method Invocation (RMI), support for SSL, JDBC, DCOM/Active-X, HTTP, HTTPS, IMAP and JDBC.

As outlined above, the gateway preferably enables multiple applications to connect to each input of the SMSC, VMR or AMSC, which may effectively remove the restriction on the number of applications that can connect to each operator network. The gateway preferably supports in excess of 10,000 application connections to the mobile network. The gateway also preferably provides SSL (Secure Sockets Layer) Support for application connectivity. SSL may be available for RMI (Remote Method Invocation), SOAP (Simple Object Access Protocol), HTTP (HyperText Transfer Protocol) and Proxy Communication between the application and the gateway.

The gateway architecture may be designed to provide scalability and reliability. The gateway architecture may be similar to that described below for the VMR and AMSC. Mobile network operators with two or more gateways may implement fail-over between the gateways to offer a high availability option for client connections. Operating systems supported by the gateway may include Microsoft Windows NT4/2000, Solaris 8.0, Linux and HP-UX 11. Automated installation capabilities may also be provided. The gateway preferably also supports transport protocols such as TCP/IP, X.21 and X.25. The gateway preferably further includes persistence (crash recovery) capabilities. This may allow the gateway to recover incomplete transactions after failure.

The gateway preferably incorporates traffic management capabilities to allow for different capacity SMSCs and for applications that pass large volumes of traffic through the system in a short period of time. Preferably, the gateway has a capacity in excess of 1000 messages per second, although the gateway may operate at capacities of between 200 and 300 messages per second.

The gateway may also provide channel grouping capabilities, wherein a number of SMSC connections may be grouped together. The number of SMSC channels supported may be unlimited. Channel traffic balancing may also be provided to distribute the message load between SMSC connections within a group, or between groups of connections. Preferably, the gateway dynamically distributes message load amongst channels within a group. In addition, messages may be routed to a specific group of SMSCs (a specific channel group).

Channel throttling capabilities may allow the gateway channel speed to be matched to the SMSC speed (where the channel speed defines the maximum number of messages that may be sent to a particular channel each second). If messages are received at the gateway at a faster rate than they can be delivered (either to the SMSC or the applications), the messages may be queued for later sending. The messages may be queued in order of receipt, or messages may be prioritised according to predetermined rules. In this way, higher priority messages may bypass lower priority messages.

Further gateway features may include message filtering to allow whitelisting/blacklisting of mobile numbers or groups of mobile numbers. Support for custom filters may also be provided. Unicode International Language Support may be provided if the server operating system and SMSC support the character set.

Preferably, the gateway allows the transmission of a wide range of message services, such as rich content Enhanced Messaging Services (EMS) and Nokia Smart Messaging 3.0. This may be implemented through the use of JAVA classes and messages may be transmitted via RMI. In addition to supporting 2-way text messaging, the gateway may also support binary messaging and provide access to the User Data Header (UDH).

A further preferable feature of the gateway is the capability to provide Mobile Originated SMS (Mobile Pull) services. This enables mobile phone users to access data on demand.

The gateway preferably provides logging facilities. These may be file-based (archived) or RDBMS (Relational Database Management System) (preferably JDBC compliant (Java Database Connectivity)). Details stored in the log are preferably configurable. A web interface, which allows for easy configuration and management and which may be customizable, is also preferably provided to allow account management and the provision of billing records for messages sent and received. All message events may be logged for billing purposes. Custom billing formats may also be provided to application operators. A command line interface or console output may also be provided for account management. Account management may also be provided through custom integration to a 3rd party CCB system. Authentication capabilities on the control interfaces or the message sending interfaces may be used to restrict access to authorised users only. A variable tariff system may allow allotments based on different tariffs to be assigned concurrently. A graphical application, such as “TestSpeed” may also be included for benchmarking gateway performance.

A further preferable feature may allow multiple MSISDN support wherein one or more MSISDNs may be mapped to a particular client account. Preferably, SNMP (Simple Network Management Protocol) and CDMP (an SMSC protocol) capabilities are also provided. Preferably, channel routing is also implemented to provide Cheapest/Fastest Route Negotiation.

It may also be preferable to allow a GSM modem to be connected to the gateway for the purposes of evaluation, demonstration and testing, negating the requirement for direct SMSC connectivity at that stage.

One embodiment of the VMR will now be described with reference to FIG. 2 and FIG. 7. The VMLR and VMSC, which make up the VMR in this embodiment, can be integrated into a single component but are preferably distributed to improve fault tolerance. Preferably, the VMSC and VMLR communicate with each other over a link other than the telecommunications network, for example an IP network. The VMSC advantageously feeds back information concerning the state of the application to the VMLR.

The VMLR 48 is shown in this embodiment as a separate component in the mobile network, but, in another implementation, the VMLR 48 could be integrated into the network HLR 50 (this reduces hardware requirement, but may increase load on the HLR). Communication between a VMLR and VMSC and distribution of components will be explained further with reference to FIGS. 8-10. In a preferred embodiment, the system incorporates more than one VMLR and the VMLRs are preferably connected over a separate data transfer link, such as an Internet Protocol (IP) network. This IP network means that more than one location register can store the routing information for each application, even if the VMLRs are geographically remote. If routing information for an application changes, for example, if an application goes offline, then the information in each of the VMLRs can be updated across the IP network. This provides an advantage over the prior art system since more than one VMLR can provide routing information for the application to supply in response to a request from an SMSC of the telephone network. Replication of VMLR data also introduces redundancy into the system and increases system fault tolerance. It is important to note that this is a somewhat unexpected departure from prior art systems where there must only be a single logical version of the data stored in an HLR (even if there is some hardware redundancy in the physical store) as there is only one real mobile device and the data changes frequently.

A further feature of the preferred embodiment is the Virtual Mobile Switching Centre (VMSC). This acts as an MSC for the applications that correspond to the virtual mobile numbers contained within the VMLR. Preferably, the system comprises more than one VMSC, with the VMSCs connected to each other and to the applications over the IP network. The VMSCs are also preferably connected to the VMLRs using a separate network, preferably an IP network. If the system is implemented in this way, it affords a major advantage over the prior art system. In the prior art system, the MSC and the HLR communicate over the SS7 layer. When compared to communicating over IP channels, SS7 bandwidth is limited and expensive. Using an IP network (or another network separate to the mobile network) for communication between the VMLR and VMSC thus facilitates communication between the network elements and frees signalling bandwidth on the SS7 layer.

If an application is also connected to the network of interconnected VMSCs, for example over the IP network, which, in one implementation, could be the internet, then it becomes possible for more than one VMSC in the network to receive and redirect messages to the application. The VMLR may select routing information based on the availability of a plurality of VMSCs (and optionally other criteria such as distance to the VMSCs) and supply routing information accordingly to balance load between functioning VMSCs and to provide tolerance of faults of individual VMSCs.

In this embodiment, the application is connected to a VMSC and therefore does not need to connect to an SMSC in the operator network to receive messages. This alleviates the problems associated with using a proprietary interface to connect the application to the SMSC and the problem that an SMSC typically only has a limited number of ports to which applications can connect. It also means that messages intended for the applications are not routed via the SMSC. This is advantageous to both the SMSC operator and the application owner, as application messages tend to pass through the network in spikes of traffic. For example, a large volume of traffic is generated if many mobile users wish to send a message to an application simultaneously and a large amount of traffic may even cause components such as the SMSC to fail.

A further preferred feature of the VMSC is that it is capable of implementing a “reverse bind” process. This means that, if a message is sent to an application that is unavailable to receive messages, the VMSC can attempt to connect to the application in order to deliver the message.

Bypassing the SMSC is also advantageous to the application operator as the operator will not need to purchase a large busy hour licence to receive messages through the SMSC. Busy hour licences normally restrict peak throughput. However, using this embodiment, the applications no longer need to receive burst of messages through the SMSC, and the message sending rate can be controlled. This means that a smaller busy hour licence can be purchased.

It will be noted, however, that in this embodiment, the application may be connected to the SMSC to send outgoing messages. In such a case, the application is preferably configured to give the MSISDN number to which it is assigned in the VMLR as an originator number so that incoming messages are sent via the VMR. Since the outgoing messages can be sent at a timing determined by the application, the peak throughput can be controlled. In an alternative embodiment, the VMSC may incorporate message sending capability so that the SMSC can be omitted completely from the application connection.

In a preferred embodiment, the VMLR and/or the VMSC have an SMS message throughput capability at least as great as the interface to the core mobile network. This means that the throughput rate of messages in this embodiment is limited by the throughput rate of the interface to the mobile network and problems caused by spikes will not cause failure of the VMLR or VMSC.

The VMSC itself is preferably connected to one of the MSCs on one of the telephone operator networks. It thus becomes part of the switching technology of the telephone network and is accessible, through operator interconnect agreements, from anywhere on the telephone network. For many of the reasons outlined above, it is advantageous for the VMSC to be connected to a switch in the telephone network and not to the SMSC and so not to forward messages from the network through the SMSC to the application.

In one embodiment of the system, the VMLR network element and the VMSC network element together form the Virtual Mobile Redirector (VMR). The function of the VMR is to facilitate the transfer of messages between SMEs and applications by presenting a virtual mobile number to the network for each application and redirecting messages sent to those numbers to the corresponding applications.

In the preferred embodiment, the VMLRs and VMSCs are all interconnected by a data transfer network separate to the mobile network, such as an IP network. This means that every VMLR has access to location information for all of the applications connected to the VMSCs; therefore, each VMLR is capable of providing routing information for any application. This means that, when a routing path is requested by an SMSC trying to deliver a message to an application, any VMLR can respond to the “Send Routing Information” request by supplying the appropriate routing information. Since, in this embodiment, the VMSCs are all interconnected by a network separate to the mobile network, such as an IP network, the message can be routed to the application via any of the VMSCs. It is therefore possible for the VMLR to select the route it provides to the SMSC using an algorithm that calculates the best route to the application based on predetermined factors. These factors are not limited to but may include criteria such as a measure of the geographical proximity of the VMSC to the SMSC requesting the routing information. The measure of geographical proximity may be a measure of the physical distance between the network elements, or it could be a measure of the distance between the elements over the network, for example, the number of switches (MSCs) between the SMSC requesting the information and the VMSC. This geographical proximity criterion is useful since it allows the VMLRs to preferably route messages oft the SS7 layer and onto the separate network connecting the applications to the VMSCs as close to the originating SMSC as possible. For example, requests for routing information originating from an SMSC in the North of a country could preferably be routed to a VMSC in the North of a country. Similarly, requests from an SMSC in the South of a country could preferably be routed to a VMSC in the South. In this way, messages are transmitted a shorter distance on the expensive SS7 bandwidth.

Other predetermined criteria used by the VMLR to determine the best routing information to provide to the SMSC could include the availability of the VMSCs, which may be assessed by measuring the load on each of the VMSCs.

A plurality of criteria such as those described above is preferably incorporated into an algorithm to allow the VMLR to determine the best routing information to supply to the requesting SMSC. Such an algorithm preferably includes weighting factors based on the relative importance of each criterion. An example might be that the availability of the VMSCs is considered more important than their geographical location, and these criteria would be weighted accordingly within the algorithm.

Thus the preferred system can perform both load balancing and proximity balancing on the VMSCs to maximise the throughput of messages to the applications. This would not be possible in a prior art network.

The interconnection of VMLRs and VMSCs over a network separate to the mobile network also provides a level of hardware and software redundancy in the system. This may mean that graceful degradation can take place if some of the system components fail; the system retains full functionality, although at a reduced capacity, if some of the components fail.

In the preferred embodiment, the hardware is designed around a distributed “N+1” implementation model.

This means that the hardware is comprised of many small elements. More than one element is capable of performing the a particular task at any time, so if any of the hardware fails, other hardware elements are able to take over their roles.

The software implementation of the VMR could take many forms, but in one embodiment, the system is implemented using a distributed software architecture. Individual software elements, or agents, each performing a single simple task, are controlled by a management system, or wiring. The wiring ensures that the correct agents are connected to allow the VMR to perform the tasks that comprise its functionality. New agents can be introduced to the system by the wiring and agents that are not functioning can also be removed or replaced. This allows the system configuration to be upgraded in a live environment since any new agents that are introduced and that do not function appropriately cause the wiring to roll the system configuration back to the last known good configuration, minimising disruption. This live configuration mechanism, and the software redundancy, ensure that the system retains full functionality even if some of the agents fail.

A further advantage of this embodiment of the system, using distributed software and hardware technologies, is that they can provide just-in-time scalability. As demand for the system grows, new hardware components can quickly be added to follow the growth in demand. This provides an advantage over conventional systems, which must add large hardware components and reconfigure software to incorporate the changes. This leads to periods of over-utilisation of the system, before the new hardware is added, followed by periods of under-utilisation when the new hardware has been added but demand has not yet grown to utilise the hardware to its full potential.

The architecture of one embodiment of the VMR is described in more detail below and is illustrated further in FIGS. 12 and 13.

In one embodiment, as illustrated in FIG. 12, the VMSC and VMLR both share the same distributed architecture. Unlike traditional SMS infrastructure, this platform may be completely modular using software redundancy, replication and distribution. Each logical node may be made up of several medium to small systems that are redundant and scalable. Examples of such systems include the “Receive SM” 150 “Queue Management” 152 and “SS7 Export” 154 nodes illustrated in FIG. 12. Message queues and processes (agents) can be spread across all of these systems while management agents or a management system controls their activity and distribution.

Agents and queues may be replicated throughout the node, minimizing the possibility of a single point of failure. In this embodiment, the self-healing distributed internal messaging system is capable of detecting and correcting faults without operator intervention. In the case of a system failure within a node, management agents may take immediate corrective action to resume normal operations as quickly as possible. This means nodes may still be available to provide a nearly full level of service even in the event of multiple failures. In multi-node installations, queues can be replicated across entire nodes to minimize the potential impact of site failures.

In this embodiment, the same architecture may be deployed throughout all VMSC and VMLR nodes. It may provide the advantage of allowing for smooth just-in-time expansion that is simple and quick to complete. There may be no need for overhaul, major reconfiguration, or changing hardware. Capacity increases may be managed simply by adding additional servers to the configuration. When new components are introduced to the system, the agents and other components may be redistributed to take advantage of the extra capacity. In addition, nodes can share resources and tasks making them a very efficient way to expand rapidly.

The modular design of the VMR may provide the ability to introduce new functionality to the general architecture without major overhaul or redesign. Management agents may be used to ensure that new components do not interfere with operational functions so they can be introduced into live systems without downtime.

Features incorporated into the design of the architecture of the VMR enable it to provide SMS services for applications in an efficient manner. An example of this is the VMR's ability to cope with large transient spikes in service without system degradation. This may be done through special dynamic queue optimization. Further attention to the requirements of management and operations provides ease-of-use features like centralized configuration for both the VMSC and VMLR and different access levels for account creation.

Further redundancy may be provided by the use of multiple VMR nodes 160, 162, 164, 166, as shown in FIG. 13. These multiple nodes may provide further resiliency and flexibility to the VMR system.

An additional feature of the preferred embodiment is that messages within the message store of the VMR that are being stored before transfer to applications, or the network, are replicated to a constantly updated replicated message space. This is another feature that is made practical by the separate data transfer link connections within the VMR.

A further feature of the preferred implementation is that it may incorporate a system to monitor the availability of the applications connected to it. The VMLR can frequently update its location register for the status and location of applications attached to it. The frequent updating of multiple VMLR records across many different interconnected VMLRs is made feasible by the separate data transfer links by which they are connected.

Applications may become unobtainable temporarily (for example, if their link to the internet fails) or permanently (if the application is withdrawn from the system) and messages will not be sent from the SMSC to the application via the VMR until the application becomes available again to receive the message. This means that messages are stored in the originators SMSC until the application becomes available, so the messages do not need to be stored for the application by the VMR. As a consequence, the VMR does not require large amounts of storage memory.

In the preferred embodiment, when an application again becomes available to receive messages, the VMR can notify the SMSC, which can then try to resend the message immediately. This aspect of the embodiment takes advantage of the Mobile Waiting Data (MWD) feature incorporated into many operator networks.

As discussed above, a further embodiment of the present system may incorporate means for sending application originated (AO) messages from an application to the mobile network. One embodiment of the system which incorporates this function will now be described in more detail with reference to FIG. 11.

In this embodiment, the network incorporates both a VMR (a VMSC and a VMLR) and an Application Messaging Service Centre (AMSC) 100. The AMSC may comprise all of the features of the VMR and may provide further functionality for an application 102, or External Short Message Entity (ESME), accessing a mobile network, as described below.

In this embodiment, the AMSC 100 provides means for routing mobile (or application) originated messages from the mobile network to the application 102, as described above for the VMR. The AMSC 100 may also incorporate all or some of the features of the VMR described above.

In this embodiment, the AMSC 100 further provides means for sending messages originated by an application 102 attached to the AMSC to other entities on the mobile network. By way of example, the application 102 generates a short message and sends it to the AMSC 100 over an IP network 108. The AMSC 100 receives the short message from the application 102 and processes the message in a similar way to that in which the home SMSC of a mobile device would process a message sent to it from a mobile. This is described in detail above and is readily applied to the AMSC, which is able to determine the destination address of the message and send out “Send Routing Information” requests in order to obtain the routing information for the destination device to which the message may then be sent.

The AMSC 100 may provide full support for GSM phase III networks as described in the GSM standard 3GPP 29.002 for the Gd interface. In addition, the AMSC 100 may provide an interface to the application over a standard protocol, such as the Short Message Peer to Peer protocol version 3.4 (SMPP 3.4) ESME interface as defined by the SMS Forum (formerly the SMPP Forum).

As with the VMR, the AMSC 100 assigns an MSISDN (Mobile Station ISDN) number to each of the applications 102 attached to it. This number uniquely identifies the application 102 as an entity within the mobile network. It provides an address via which messages may be sent to the application from the home mobile network or any network interconnected to the home network via the gateway MSCs 106. Using MSISDN identifiers for each application means that the mobile network can treat the application as another mobile station, as if it were a mobile telephone. This means that the mobile network does not have to be modified to incorporate the application and can route messages to and from the application using standard procedures.

In one embodiment, messages are not sent from the AMSC 100 to Short Message Entities (SMEs) 118 on the mobile network until routing information has been received and the destination SME 118 has confirmed its availability to receive the message. This may mean that messages must be stored in the AMSC 100 for later transmission. In this case, the AMSC 110 may use an intelligent media hierarchical message store. A memory persisted database may be combined with a magnetic disk to provide optimal message storage capabilities. Memory persistence may be supplied by a memory-based database and is used for very fast data throughput. The database may be used when messages are passed quickly through the AMSC 100 from the application 102 to the destination 118. If the data needs to be stored for later delivery, for example if the destination mobile entity is unavailable to receive the message immediately, the hierarchical storage system may transfer the message from persisted memory to magnetic media for longer-term storage.

In one embodiment, a further feature of the system may be distributed Message Delivery Points (MDPS) 110, 112, 114, which may be attached to SMSCs 104 and G-MSCs 106 of the mobile network. The MDPs 110, 112, 114 may be connected to each other to the AMSC 100 and to the VMR (VMSC and VMLR) over a distributed IP network 108, separate to the mobile network. The function of the MDPs is to offload SMS messages from the operator's mobile network to which they are attached and onto the IP network 108 at the earliest possible point. For SMS traffic that originates on the home mobile network (on-net traffic), this earliest possible point is at the home SMSC (for example, SMSC 104) of the SME that sent the message. For messages that originate on the mobile networks of other operators (off-net traffic), the earliest possible point is at the G-MSC (for example, G-MSC 106) via which the message reaches the home mobile network. Similarly, for outgoing messages originating at an application 102 attached to the AMSC 100, the message may be transmitted from the AMSC 100 over the IP network 108 and via an MDP 110, 112, 114 to the servicing MSC 116 for the destination mobile 118, or to a G-MSC 106 for transmission to a mobile on another operator's network.

The architecture of the AMSC 100 may be similar to that of the VMR outlined above and may provide many of the same features. It is designed to be robust and provide high-availability of the system. Multiple hardware and software nodes may provide a capability for graceful degradation in case of hardware or operating system failure. Increased fault tolerance may be provided by the use of alternate routes, the use of distributed agents and MDPs 110, 112, 114. The AMSC may also provide geographical and availability load balancing capabilities, as described above for the VMR.

In one embodiment, the AMSC also provides SMSC Blacklisting facilities which enable the AMSC to reject messages sent to applications connected to the AMSC from specific SMSCs, or ranges of SMSCs. This may be done on a system-wide basis and may provide a method by which the AMSC may, for example, block messages sent from other operator's networks. In addition, the AMSC may be able to block the sending of messages from applications to specific mobile stations, or groups of mobile stations on the network. Hence applications may be blocked from sending messages to, for example, barred mobile stations. A bar may be imposed on a mobile station by the network operator to which the mobile station is connected. This may be done on the request of the mobile station user in order to prevent messages being sent to the mobile station from a particular application.

The AMSC may further provide advanced ESME provisioning, which may allow the AMSC to disable/enable specific features for individual users who may require a more specialised service, or for those users who may be restricted to a more limited service. Such features may include the use of SMPP 3.4 “Outbind”, windowing, enhanced messaging, etc. Subsets of features may be combined to provide particular level of service to a user or a group of users.

SMPP 3.4 “Outbind” is a procedure defined in the Short Message Peer to Peer Protocol Specification (v3.4). The procedure allows an SMSC to initiate the opening of a connection to an application (ESME), which may be used, for example if an AMSC has a message to deliver to a particular application. Windowing is a common feature of TCP/IP networks and allows the AMSC to control the rate at which data may be transferred to and from the ESME. Enhanced messaging functions include the capability of the AMSC to send formatted text, pictures, animations and sounds with the messages.

The AMSC may also allow the provision of voice service by the applications attached to it. These voice services may be voicemail messages, which may be used or produced by the application, or which may be stored for later distribution to mobile stations. The voice services may also include Interactive Voice Response (IVR) services, such as automatic ticket booking services, in which the application may respond to voice commands from a user.

In this embodiment, the AMSC may also provide support for high-density signalling on the mobile telecommunications network. This may allow the application to send and receive messages in a high density format and may facilitate the correct billing of these messages.

The AMSC may be tested and verified in order to ensure that it is capable of processing a given number of short message delivery processes per second. In one embodiment, the AMSC may be able to process up to 250 short message delivery processes per second. In other embodiments, the AMSC may be capable of processing up to 750, or 1000 short message delivery processes per second.

A high level functional description of one embodiment of the invention follows. This is not intended to limit the scope of the invention, but serves to provide further details of how one embodiment of the invention might be implemented. In the following description of an embodiment, the term VMR relates to the Virtual Mobile Switching Centre (VMSC) described above and the term HLR relates to a modified HLR which corresponds to the Virtual Mobile Location Register (VMLR) described above.

Aspects of the system may further be described and illustrated by way of the following numbered clauses:
1. A method for providing routing information for at least one device connected to a mobile network at a plurality of connection points wherein the routing information supplied for routing to the device is dependent on a plurality of predetermined criteria.
2. A method according to clause 1 wherein the predetermined criteria include the geographical location of the source of the request.
3. A method according to any of clauses 1 to 2 wherein the predetermined criteria include the availability of the connection point to the application.
4. A method according to any of clauses 1 to 3 wherein the predetermined criteria include a combination of a plurality of criteria.
5. A method according to clause 4 wherein the combination of predetermined criteria is calculated including a weighting factor for each of the criteria to allow for the relative importance of each of the plurality of criteria
6. Apparatus for configuring a mobile telecommunications system to communicate messages to an application, comprising: means for assigning a mobile identifier to the application;
   means for providing a connection from the network to the application;
   means for storing the mobile identifier together with an identifier of the application assigned and routing information for directing communication via said connection.
7. Apparatus for routing a message to an application via a mobile telecommunications network in which mobile devices are assigned globally unique identifiers, comprising:
   means for assigning at least one globally unique virtual mobile identifier to the application;
   means for receiving a request for location information for the virtual mobile identifier;
   means for supplying routing information corresponding to a predefined static connection point to the application in response to the request.
8. Apparatus for providing routing information across a mobile network for at least one application comprising:
   means for storing at least one globally unique identifier;
   means for storing an identifier of at least one application assigned to the at least one globally unique identifier;
   means for storing location information for the at least one application via at least one predefined connection point and;
   responding to requests for location information for the globally unique identifier by supplying routing information for the assigned application.
9. Apparatus for providing routing information across a mobile network for at least one application wherein routing information for a single application is stored in a plurality of physically separate network elements situated at geographically disparate locations.
10. Apparatus for providing routing information across a mobile network for at least one application wherein the routing information supplied in response to a request for information is selected based on at least one condition other than the location of the application.
11. Apparatus for connecting at least one application to a mobile network comprising:
   means for providing a connection for at least one application using a first network protocol and;
   means for providing a connection, using a second protocol, at the core network signalling protocol layer to at least one switch on the mobile network and;
   means for routing a message directed to the application via said connection.
12. Apparatus for providing routing information for at least one device connected to a mobile network at a plurality of connection points wherein the routing information supplied for routing to the device is dependent on a plurality of predetermined criteria.
13. A method of connecting at least one application, assigned to at least one virtual mobile number, to a mobile network comprising providing a connection for the at least one application at a switch network element, wherein the switch network element is separate from a location network element, which stores location information to route messages sent to said virtual mobile number to the application via the switching element.
14. A method according to clause 13 wherein the location network element and switch network element are interconnected by a data transfer network separate to the mobile network.
15. A method according to clause 13 or 14 wherein the application is connected to a plurality of switch network elements.
16. A method according to clause 15 wherein at least two of the plurality of switch network elements are served by at least one common location network element.
17. A method of configuring a mobile telecommunications system to communicate messages to an application, comprising:
   assigning a mobile identifier to the application;
   providing a connection from the network to the application;
   storing the mobile identifier together with an identifier of the application assigned and routing information for directing communication via said connection.

A high-level description of one embodiment of the message delivery system described herein now follows. This description is not intended to be limiting in any way but is intended to further illustrate one embodiment of the invention. In this embodiment, the system is described as a Message Delivery Platform (MDP).

Message Delivery Platform (MDP) may be implemented as an intelligent message handling and delivery system with the capacity to handle a diverse range of messaging requirements. MDP preferably achieves this by allowing mobile operators to distinguish different types of messages in their network and to process each one according to the message type.

Known messaging systems provide basic peer-to-peer, application and voting messaging via a traditional store-and-forward mechanism for all types of message, i.e. they operate a “one size fits all” approach.

MDP may replace the “one size fits all” approach by providing tailored delivery strategies for specific types of messages. MDP is preferably designed to compliment and take advantage of existing SMSCs and MMSCs by using them for peer-to-peer messages that are not delivered directly by it. By using this existing infrastructure, MDP may allow mobile operators to expand messaging capacity and provide critical enhancements to existing messaging services.

Further details of how one embodiment of the MDP system operates are outlined below.

MDP may be placed between the SMSCs and the mobile subscribers such that messages originated by mobile subscribers are received by the MDP. The MDP may then analyze each message and may use a rule engine to determine the type of message, hence allowing the MDP to apply a delivery strategy to the message. The delivery strategy may determine factors such as how, where, and in what order the message is processed, recorded, delivered and acknowledged.

MDP may be implemented as a distributed modular solution in that MDP nodes may be placed at points in the network where it makes the most sense for their function to be performed. Distributed MDP nodes may then act in concert as part of one logical system in order to achieve the right balance of distributed vs. centralized function. This distribution of nodes may also provide a high degree of resiliency in case of individual or even multiple component failure. Furthermore, because of its distributed nature, it may be more able to accommodate very large volumes of messages.

According to one preferred embodiment, MDP is built on an extensible platform on which common messaging functions may be performed. The MDP solution may be implemented with a set of functions that deliver various different features to mobile operators. These features may include:
Message Classification—The identification of each message as it is received by the system. The system may identify one or both of the type of message and the intended destination of the message.
Peer-to-Peer (P2P) Direct Delivery—This may comprise delivering a message from one subscriber to another without using the SMSC. If the MDP identifies an MO message as a P2P message that is suitable for direct delivery, it maybe designed to attempt to deliver the MT directly to the recipient MS. The process of direct delivery may comprise issuing an SRI, awaiting the response and if the MS appears available, issuing an MT delivery attempt. If for any reason, this fails, the HLR takes too long to respond, or responds with a P_error, then the message may be sent to the SMSC. If the MDP system receives an MO that is specifically identified as a P2P message that should be delivered via the SMSC (for example, using criteria defined in rule engine), it may be sent to the SMSC for delivery.
Peer-to-Application Direct Delivery—Passing a message from a subscriber directly to an application avoiding the use of the SMSC. If the MDP system receives an MO and identifies it as an application terminated message that should be sent via the SMSC (for example using criteria defined by rule system), the message may be sent to the SMSC for delivery to an application.
Voting—Providing a means of terminating very high volume short bursts of traffic to specific applications for mass media (e.g. radio, television) voting campaigns. The MDP is preferably designed to identify and deliver messages that are destined for connected voting applications. The MDP may have one or more “delivery strategies” for voting that allow the messages to be delivered in an efficient manner in order to accommodate very high short term volumes of traffic.
Application-to-Peer—The system is preferably further designed to be able to receive a message from an application and deliver it to a mobile station. There may be the option of using a retry mechanism (which may be set per application) that may submit the message to the SMSC via TCP/IP or may use its own persistence engine and retry schedule.
SMSC Load Balancing—Achieving more optimal loading of multiple SMSCs such that they are not under-utilized or over-utilized. The system is preferably designed to distribute MO traffic from the MDP to more than one SMSC. The distribution may be such that the SMSCs are being used according to their availability and licensed capacity (SMS/sec). This may work both for connections to SMSCs over SS7 and for SMSCs connected via SMPP or UCP or another similar protocol.
Inter-Carrier Message Delivery—Transiting messages between mobile operators for wholesale functions. This may also allow inter-carrier connections to be made via TCP/IP as well as SS7 and to transit messages between the two.
IP Offload—Passing messages between elements via TCP/IP and avoiding the use of expensive transit infrastructure.
Dynamic Delivery Strategies—Using a series of slightly different delivery strategies to accommodate traffic in case of excessive traffic, system failures, etc. The system is preferably further designed to change from one delivery strategy to another depending on defined thresholds, for example thresholds relating to throughput, latency, system availability.
Non-Persisted Message Delivery—Delivering messages without incurring the overhead of storing them on a disk but meanwhile assuring that no messages are lost.

According to one implementation, MDP's flexibility of treating messages differently means that each message may be delivered at the lowest cost possible. MDP may reduce the average cost per message costs by:
Using a lightweight, efficient, scalable architecture design that lowers hardware costs.
Reducing resources needed from “high cost per use” infrastructure like SMSCs, SS7, transit equipment, storage systems, etc.
Removing unnecessary steps from specific transactions so that only a bare minimum of steps are used.

Implementation of the MDP system may reduce the need to take on additional SMSC resources. The system may be implemented with a highly simplified centralized management and preferably includes many features that enhance messaging. In this way, MDP can reduce management overhead and reduce the need for equipment that has large management costs associated with it.

The MDP may be particularly useful in facilitating messaging between mobile equipment and applications (peer-to-application messaging). In the early days of SMS, applications were connected directly to the SMSCs for two-way traffic, but application messaging volumes have increased dramatically (in some places it is now over 10% of total volume). With such an arrangement, many problems have arisen since the SMSC is not designed to host a large number of disparate applications that burst traffic on and off the network.

One solution to this problem is to create units dedicated to application services with their own messaging infrastructure. Initially this application messaging infrastructure may connect to the SMSCs but, more preferably, it works around the SMSC altogether. This is where MDP may be deployed with great effect. MDP may be designed to identify and separate application traffic from peer-to-peer traffic allowing dedicated infrastructure to effectively service each type of traffic. With MDP, application messaging units can deliver a wide range of functionality as set out below.

An example of the functionality that may be provided by the MDP system is voting via SMS. Typically a voting campaign may be associated with a television or radio show whereby the audience would be invited to send information to the show by SMS.

Voting can present unique requirements to the network since it is typically associated with a very high volume of messages being sent in a very short period of time, i.e. a short term burst of traffic. Using one embodiment of the MDP system, however, the messages may be identified as vote messages and then treated according to predetermined criteria for vote messages.

Examples of further functionality that may be provided by an MDP system are outlined below. Supplementary services such as Spam filtering and SMS forwarding may be provided and delivered by the MDP system to enhance the SMS service.

MDP may further incorporate a message forwarding system to allow users not only to receive messages to their mobile phone as they would normally but also to have them copied or forwarded to e-mail or to a private web interface.

In addition, MDP may inter-work with known Spam detection systems in order to root out and eliminate unsolicited bulk SMS messages from the network. MDP can preferably work in conjunction with systems that detect misuse, report it, and then block the source as directed, or such systems can be implemented within the MDP system itself.

MDP preferably further provides means for routing messages between networks as well as for one network, for example high speed reliable messaging between operators may be facilitated using a unique routing capability over TCP/IP, SS7 and combinations of GSM, CDMA, and TDMA. This may allow an operators to use a third party to provide and manage the connections to all the other operators that they wish to be able to work with.

According to a preferable embodiment, MDP can receive mobile terminated messages from one connected network and reroute them to another network connected to it. Billing and reporting capabilities may further be provided. This feature may be combined with other SMS enhancements, application messaging, etc. hence MDP may provide intercarrier message termination services along with other value-added services.

An example of the deployment of MDP into a medium sized mobile operator network will now be described in more detail by way of illustration only and by reference to FIG. 29, in which an example mobile telecommunications network is illustrated. In this example, the operator has two SMSCs which can deliver up to 1,000 SMS per second but the SMSC is quickly running out of capacity. In this case, third party content providers are also connected to their SMSCs to send and receive messages.

FIG. 30 illustrates the same mobile telecommunications network as FIG. 29 but with an embodiment of the MDP system incorporated into the network. In this example, by deploying the MDP system, the operator achieves an upgrade to their SMS capacity, in this case to 1,500 SMS per second. In addition, the MDP may modify the application messaging infrastructure giving it dedicated resource and management capability. In this example, they are now able take on a large number of high volume content providers without affecting their peer-to-peer services and without taking on a large amount of management overhead. Further to this, the operator may now offer high-volume voting services and other enhancements like Spam detection, SMS forwarding, SMS copy to email, etc.

A high level functional description of one embodiment of the MDP system follows. This description is intended to be by way of illustration only.

In this embodiment, the MDP is deployed in between the network switches (MSC) and the SMSCs, as illustrated in FIG. 31. It can be interconnected to STPs in large networks as well which may allow multiple MSC connections to be “nailed up” in order to make the most efficient use of SS7 links. Traffic from on-net mobile stations may be routed to the MDP using the default SMSC presentation address set in the handsets. To facilitate this process, when MDP is put live in a network, the presentation address of the SMSC may be given to the MDP. A secondary backup route is preferably still available to the SMSC in case of MDP failure.

In this way, MDP may be designed to be installed “on top of” an existing SMS solution such that if MDP became completely disabled, the network could be arranged to fall back to the original SMS solution.

In this embodiment, the MDP receives mobile originated traffic and analyses it via the rule (routing) engine as described in more detail below. Once the message type is identified, a delivery profile may be associated with it and this may be used to determine what happens to the message next.

The delivery profile preferably contains a set of delivery strategies ordered by preference. The delivery strategy may translate to a series of steps that need to be executed culminating in the transfer of the message to another location. These steps may include interacting with HLRs, interacting with prepaid platforms, etc. before forwarding the message. The delivery strategy that is used may be determined by specific criteria. For example, a more efficient delivery strategy may be used when the recipient service has exceeded its throughput limit. This more efficient means of delivery may not execute all the steps normally executed in order to gain this efficiency.

MDP can preferably identify, process, and route messages from many different sources. These sources currently include:
Mobile originated SMS over SS7 (GSM MAP and IS-41)
Mobile terminated SMS over SS7 (GSM MAP and IS-41)
Application originated SMS over TCP/IP (SMPP and UCP)
Application terminated SMS over TCP/IP (SMPP and UCP).

MDP can preferably also interact with intermediate systems that service information requests or deduct money from prepaid customers, etc. in a preferred embodiment, these are real time interactions but can also be done out of sequence in order to create further efficiency. The intermediate systems that MDP may be designed to interact with include:
Interface to prepaid platform over IN
Interface to prepaid platform over TCP/IP
Interface to HLR over SS7
Interface to Spam detection and reporting over TCP/IP
Interface to subscriber management over TCP/IP.

Finally MDP may provide interfaces for management, provisioning and control. The interfaces are preferably configurable to employ different levels of access for different roles.

These interfaces may include:
Alarms via SNMP
Statistics via SNMP
Management and Provisioning via HTTP
CDRs and Reports via FTP.

Management Functions that may be provided may include some or all of the following:
routing
configuration
application connections
black/white lists
SMSC connections
viewing the health and availability of nodes, links, etc.
administering the backup of the configuration database
viewing the health and availability of nodes, links, etc.
removing, changing and/or adding links, nodes and/or SMSCs as well as bulk loading the database.

The MDP preferably copies a backup of the database to removable media on a periodic basis.

The system is preferably also capable of generating CDRs for specific events and in defined formats. This may be performed using information from the message and the system.

Further management features which may be implemented as part of the MDP system may include some or all of the following:
Message Trace may be implemented for every message or may be able to be turned on for a particular message or particular message type or criteria.
The MDP shall be controllable from a single node such that multiple nodes can be configured, taken out of service (or any other common function) via a single management node interface.
Statistics information may be generated, in particular SNMP statistics information, regarding the messages transiting the system. Statistics information may include information relating to some or all of the following factors:
   Message Delivery Attempts,
   MO messages received,
   MT messages received,
   MO messages delivered,
   MT messages delivered,
   % Direct Delivered,
   Temporary Errors,
   Permanent Errors,
   Submit SM Delivered,
   Submit SM Received,
   Deliver SM Delivered,
   Deliver SM Received,
   Temporary Errors,
   Permanent Errors,
   Persisted,
   % Persisted to Disk.

The statistics information may include measurements in messages per second as well as totals from a preset interval. The information may further be filterable such that it can be narrowed down to a particular subset of traffic using regular expressions for example for source MSISDN, dest MSISDN, calling party, called party.

Deployment of one embodiment of the MDP network itself will now be described in more detail. MDPs are typically deployed with more than one node in more than one physical location. This may allow MDP to intercept messages at the most effective point in the network. In this embodiment, each MDP is connected to a local network for interaction between servers in that node. They are preferably also connected to a WAN network that allows MDP nodes to talk to each other. In this embodiment, there are two WAN network connections, as illustrated in FIG. 32. One may be used for the transfer of messages between nodes (DATA) and the other may be used for control of the system (CTRL), which may include the replication of configuration information, heartbeats, and other vital information. In this implementation, each wide area network may act as a backup for the other.

The data network may be used to allow messages to transit the network using TCP/IP instead of SS7. In large networks that have extensive transit infrastructure, this TCP/IP network can be used to transit all messages. This may save the core network from having to continuously increase their SS7 capacity and the switch/STP capacity. Furthermore, it may help to eliminate bottlenecks in peak traffic conditions.

Nodes may be able to pass messages to other MDP nodes over the DATA network as part of a delivery transaction. This may be advantageous since it may reduce the usage of SS7 and transit MSCs and STPs.

The control network may further link to the service node, which may act as a central point of management for the distribution of nodes within a network. It may be designed to periodically download CDRs, log files, etc. to the central host so that they may be collected from one point. It may also allow each node to be managed from one screen. This may allow changes to be made once and applied across all nodes via this central system.

According to a preferred implementation, the MDP has the ability to examine the PDU of an SM (either MO or MT) to determine information, for example information about the originating mobile station, the destination mobile station, the calling and called party addresses. This introspection is preferably done at the MAP layer of the SS7 stack in order to get access to the complete contents of the message. Each SM received by the MDP, for example via SS7 or via the MDP network, may be examined for information about the origin and destination of the message. The identified information may then be matched against a routing criteria found in the rule engine. An example of a typical routing table is shown in FIG. 33. If a match is found in the rule engine table, the matching entry may be used to determine the type of message, it's destination, how it should be processed, and its billing type and class if any.

According to the present embodiment, entries in the routing table may be made via the Provisioning & Management Interface (PMI) using a web-based interface and may then be propagated to the relevant MDP nodes in the network over the control network. Adding or changing routes through the PMI will preferably cause an update to take place in the routing table of the MDP. Most routes are preferably published as global routes meaning that they are valid across all MDP routing nodes. However, certain location specific routes can be published to specific MDP nodes as needed.

The process of delivering a mobile terminated message using one embodiment of the present system will now be discussed in more detail by way of example.

Typically upwards of 50% of all mobile terminated messages are delivered on their first attempt. This means that the present store and forward mechanism is used unnecessarily for half or more of all SMS messages sent. In the MDP system, direct delivery may be used to eliminate the need for storing messages prior to their first delivery attempt by delivering the message directly to the handset as opposed to the SMSC. This may be facilitated using a technique called the synchronised double acknowledgement. When a mobile originated message is received by the MDP and it is determined to be a peer-to-peer message that can be direct delivered, the MDP may perform several steps before the original message is acknowledged. These steps may include one or more of the following:
Query the source MSISDN to check for ported or other illegal numbers.
Query the destination MSISDN to for routing and availability information.
Request a credit from the prepaid platform.
Initiate a mobile terminated message to the recipient before.
Receive the acknowledgement from the recipient.

The process of delivering a message directly to an application will now be described in more detail according to one embodiment of the system described herein.

In order to relieve the SMSC of the burden of transiting messages that are destined for applications, the MDP may identify and separate traffic that is destined for applications and deliver it directly to the applications. The MDP may receive a mobile originated message and identify it as an application message. The message may then be passed to the MDP-IP which is responsible for all TCP/IP connected applications and SMSCs. It may then employ one of several different delivery strategies to transfer the message to the application. If the application is off-line (not connected) the system can store the message or it can reject the request from the handset. If the application is available, the message can be persisted first and then passed to the application or it can be directly passed to the application and then acknowledgement is sent back to the handset.

The MDP may further be provided with load balancing capabilities. The MDP is preferably capable of distributing load to SMSCs according to their capacity to process messages. This functionality may be implemented only for messages that are sent to the SMSC but do not need to be sent to a particular SMSC. According to the present embodiment, the MDP uses two metrics to perform the load balancing of which one is static, and one is variable.

The static metric may be used to determine the SMSC's overall capacity to process messages. This may be measured in SM delivery attempts per second of available capacity. This other metric may be calculated by the MDP determining how long the latency is between submitting an SM to the SMSC and its acknowledgement of that submission. Also, there may be a measurement of how quickly the SMSC can accept another SM. These latencies may be used to do trend analysis that determines whether or not the SMSC is slowing. When a particular SMSC is slowing the MDP may slow the delivery to that SMSC until the latencies reduce again.

In order to maintain correct distribution of multipart messages, MDP may use a session timer for individual messages. The session is preferably started immediately upon delivery of each message. If another message with the same B number, originating number and SMSC ID should pass through the same MDP node within a certain period of time, the MDP preferably routes the message to the same SMSC as the previous message was sent to.

The load balancing function may be managed via the MDP management interfaces. This may be used, for example to change the loading metrics and to view load balancing statistics. In addition, the interface may be used to take SMSCs can be taken in and out of service, for example for scheduled maintenance work. In cases where the MDP is unable to direct deliver an SM to a peer, the message needs to be stored and a retry schedule entered into. According to a preferred embodiment, existing SMSC resources can be utilized effectively to fulfill this requirement. There are two options for how a message is relayed from the MDP to the SMSCs.

According to one embodiment, the replay option uses the MDP to re-issue the MO_FSM to the SS7 network using a global title different to the presentation address used on the original MO FSM. It may use load balancing weighting data to determine which SMSC global title to send the SM to. Also the MDP preferably addresses the SM such that the SMSC acknowledges directly back to it. Once the SM is in the SMSC, it is then the responsibility of the SMSC to deliver it and the MDP preferably has no further interaction with that message.

The alternative option may route the messages into the SMSC using its application interface (typically SMPP, UCP, etc.). By using this relay option all SM that are not successfully delivered directly by the MDP may be transferred to the MDP-IP over the TCP/IP MDP network. Once at the MDP-IP, it may employ a load balancing weighting to determine which SMSC to submit the SM to. The submission to the SMSC may be done over a TCP/IP connection using the SMPP protocol and spoofing the originator's MSISDN source address. The spoofing may allow the delivery report to be sent back to the SM originator (if supported by the SMSC).

When submitting the SM to the SMSC, the MDP-IP may schedule the message such that the SMSC does attempt to retry the MT_FSM immediately. This may save a second SRI from being sent to the HER immediately.

As illustrated in FIG. 34, MDP may also provide a repeater function whereby it can receive an MT message from one interconnected mobile operator, determine the message's routing, and then repeat the message onto the other network. This can preferably be done across SS7 interconnected networks, across TCP/IP interconnected networks and in between the two.

One embodiment of the architecture of the MDP will now be described in more detail by way of illustration. MDP is preferably based on a distributed architecture, one embodiment of which is illustrated in FIG. 35.

According to this embodiment, the MDP is deployed as one or more physically distributed nodes in a network, wherein the nodes may function as part of one logical solution. This distributed architecture, or a similar solution, may allow the distribution of functionality across servers, sites, and even across large geographies in order to achieve maximum flexibility and efficiency. Some benefits of a distributed architecture may include:
Increased unit level and system level reliability
Cost of message transit may be reduced
Potential for bottlenecks may be eliminated
Services may be in close proximity to the places where they are needed
Services may be in close proximity to required resources
Lower cost, commoditised hardware.

The distributed architecture may make the MDP solution a fully redundant solution, which may provide high availability and reliability for SMS messaging. This may be achieved by providing an N+1 solution ensuring there is no single point of failure. This reliability and availability may be achieved while maintaining the ability to upgrade and expand system functionality without service outage.

Reliability of the MDP system may be measured using criteria such as: total uptime percentage (which may be measured, for example over one year), ratio of number of messages lost to number of messages delivered, maintenance (scheduled) downtime and unscheduled downtime.

Examples of components of one implementation of the MDP system will now be outlined in more detail.

According to the present embodiment, the MDP is composed of a core information exchange engine (commonly referred to a “space”) that manages a set of routing tables. These tables preferably contain well defined entities (“entries”) which may be used to determine the type of event for the message in question. Event types preferably include:
Direct Delivery
Route to SMSC
Route to Application.

According to the present embodiment, functionality may be provided by number of loosely coupled “agents”.

An agent may be designed to perform specific functionality in the solution. These building blocks may manage, for example CDR generation, SS7 message delivery, logging, load balancing etc. As a result functional changes specifically for customer needs can be facilitated quickly and easily.

Agents make take entries from a space, perform an operation and put them back. Some agents may be designed only to write entries to a space taken from an external influence (by reading SS7 hardware, for instance). Some agents may be designed to take entries without changing anything in the space (e.g. a trace logger). Communication between agents may be implemented as pass-by-value, particularly through the moderation of one or more spaces.

The MDP application is preferably implemented with strict control of the flow of information between agents. This may be accomplished by the wiring layer. This may be distributed logic defined by wiring configuration (for example, stated in XML). This may be used to ensure, for example, that a complete and consistent set of agents are present while the application is operating, that agent failure is recognized and can be corrected, and that new agents may be cleanly instantiated to take advantage of spare resource or to introduce functional enhancements in the case of system upgrades. This system architecture may be used to deliver a high system uptime and reliability.

The MDP runtime engine is preferably designed to optimize itself automatically in order to process various traffic flows as efficiently as possible. Therefore as traffic flows change the MDP may automatically adapt itself and preferably performs resource optimization to increase system efficiency.

According to the present embodiment, the MDP hardware is deployed in a N+1 cluster so that even in the extreme case of server failure the MDP is fully capable to meet the required traffic levels. As a result, in this embodiment, no single point of failure interferes with system capability, functionality or capacity.

Examples of components of one embodiment of the MDP system will now be described in more detail.

MDP Node:

Deployment of an MDP node according to one embodiment of the system described herein is illustrated in FIG. 36. MDP may be placed at a switch or STP site (optionally can be at the SMSC site) and may be responsible for a number of functions such as picking up short messages (SM), determining their type and routing, and then forwarding them onward. It may consist of two or more Unix based servers (e.g. Sun Fire V480), which may be connected via TCP/IP to a local LAN and which may further be connected via a router to the core MDP network. A separate TCP/IP connection may be made back to the MDP Service Node for control functions. It may also be connected via SS7 signalling links either directly go two or more MSCs or two or more STPs.

The MSCs and STPs which may be connected to the MDP as described may be set up such that all mobile originated forward short messages (MO_FSM) from home subscribers are routed to it on global title. To provide a fail over capability, a backup or secondary route for the SMSC presentation address may be made such that MO_FSM are routed along the original (pre-MDP) path to one or more MSCs where it is distributed by round-robin to the SMSCs.

With the MO_FSM routed to the MDP, it may enter into a series of steps and depending on the type of SM may perform one of several routines for it. For MO_FSM, the MDP may supports one or more of four types of SM: peer-to-peer, peer-to-application, peer-to-SMSC application, and peer-to-vote.

Once in the MDP, the SM may be processed and an attempt to deliver it to its destination may be made via another MDP or other compatible element. This internal MDP communication is preferably facilitated over a TCP/IP network dedicated for the function of the MDP.

When an MDP receives an SM for delivery from another MDP, it may be designed to initiate a mobile terminated forward short message (MT FSM) via a SS7 connection to an MSC. The MDP may use a routing table to determine the type of SM, how it should be delivered, and where it should be sent.

MDP-IP Node:

One embodiment of deployment of an MDP-IP node according to the system described herein is illustrated in FIG. 37. The MDP-IP is preferably essentially the same as a standard MDP except that it may not interface to the SS7 network and may not receive traffic from outside the MDP network. Instead may interface to applications and optionally to the SMSC for the purpose of message delivery. The SMSC connection may be available as an alternative to the SS7 replay option used by the MDP in case a peer-to-peer SM cannot be direct delivered.

Where the MDP-IP is used with the SMSC relay connection, the MDP-IP may perform load balancing functions, as outlined above, for SM that are passed to it for scheduling and delivery by the SMSC.

As with the normal MDP node, the MDP-IP may consist of two or more Unix servers. These may be connected to the MDP network, the control network, and to an application network which may allow access to applications and SMSCs.

MDP Service Node:

The MDP Service Node preferably provides the centralized function of the MDP. It may be connected centrally and preferably consists of one or more Unix servers which are attached to the TCP/IP MDP Network. Since the MDP system is preferably designed to carry on functioning without the MDP Service Node, only one service node is required however the availability of two further increases the reliability of the system.

According to the present implementation, the MDP Service Node holds the master configuration of the MDP system. At build time, it may dictate which components perform which function and what configuration they are to have. Any changes to the configuration are preferably replicated from the MDP Service Node to the other nodes.

The MDP Service Node may further provide a provisioning and management interface (PMI) web management interface which may be used to configure the MDP system. The PMI may provide management capability over each node, its status, and function. The PMI may be used to make changes to the routing table used by each of the MDPs. According to the present embodiment, routing updates are propogated throughout the network after they are committed and cleared by the MDP Service Node. It may also be used to change the load-balancing table for the SMSCs in order to maintain the equipment. Through the PMI and the use of SNMP, the MDP Service Node may monitor availability and health of other MDP nodes and may report on their status.

The MDP Service Node preferably collects and may store CDRs and other log files centrally for collection. According to the implementation described herein, CDRs and log files may be transferred from MDP nodes at regular intervals or if the files grow beyond a set size. The MDP Service Node may then work in conjunction with a centralized disk store to hold all the files required of the system.

Important features of the embodiment of the MDP system described herein include its reliability and its scaling capabilities.

MDP is preferably implemented as a highly scalable solution, through its distributed N+1 design. The MDP may use a high number of small efficient servers instead of a lesser number of larger systems. These can then be increased in number as additional capacity is required. Each server preferably works as part of a logical group performing similar tasks to other servers and communicating with others as required. This type of communication may also take place between different elements—in this case, between the MDP and the AMSC.

Because of the N+1 architecture, reliability may also increase as the system is scaled due to the increased unit level redundancy. Preferably, multiple nodes may be deployed and the system may incorporate the ability to add more nodes, hence system level redundancy may also increase as a function of growth.

The servers in each node may be implemented to interact with each other as part of a group over a common local Ethernet network. This may enable them to act as one logical entity even though the resources may be distributed across several servers. Adding extra capacity may then simply be a matter of introducing a new server into the group. The theoretical capacity limit of this type of solution is bound to the input/output (I/O) capabilities of the transport between the servers. In this implementation, the solutions are transport agnostic (i.e. they can be upgraded from 100 Megabit Ethernet to Gigabit Ethernet, etc.), hence the solution scales extensively.

According to the system described herein, each node is comprised of small servers, so the operator has a high degree of flexibility to size each node as needed and grow each node on a “just-in-time” basis.

There are three specific areas of the MDP that may be upgraded to increase capacity:
SS7 links
Processor capacity
Servers.

New SS7 links may be added by installing new SS7 cards in existing servers. Typically, up to 4 SS7 cards (12 SS7 links) can be supported in a single server.

As the number of SS7 cards increases, additional processor capacity may be required to cope with the additional traffic. The Sun Fire V480 servers specified are examples of hardware that may be used and are capable of holding up to 4 900 Mhz processors. As a rule of thumb, one processor is required per SS7 card.

Once existing servers have the maximum number of SS7 cards installed, a new server may be required with a minimum of 1 processor and 1 SS7 card. A wide variety of hardware and operating systems may be used to implement the system described herein.

A further important feature of the MDP described herein is its reliability. The MDP is preferably designed to be a high availability, carrier grade solution. The solution is preferably designed to achieve 24×365 operation. Where individual components of the solutions fail, the design preferably allows normal operation to continue while individual hardware units are repaired or replaced. The MDP is preferably built on an N+1 architecture, as described above, allowing the full rated system load to be processed during a single server failure. In the event of multiple failures, system performance is preferably designed to degrade gracefully and predictably.

During normal operation, each server is preferably designed to communicate regularly with its peers. This “heartbeat” process may allow each component to discover and retain knowledge of the current system status. When servers or other components fail, the system as a whole, is preferably designed to automatically adjust traffic flows to ensure maximum processing capability within the constraints of the failure. Due to the multiple servers and the environmentally aware architecture, the system is preferably designed so that there is no single point of failure for power systems, fans, or Ethernet connections.

All SS7 hosts in the MDP are preferably installed in an N+1 type architecture as described above. This may allow component and unit failures to be in effect without any impact on the overall traffic throughput of the system.

Further, SS7 traffic is preferably routed to and from the MDP in a manner that allows traffic to be rerouted through alternative links when failures occur. Link dimensioning may be such that they can double their normal load without any problems (i.e. 0.4E under normal load and 0.8E under failure conditions).

Turning to the IP network, this may be protected through the use of multiple physical links and multiple VLANs. High throughput links such as those connecting to applications may be isolated from control networks to ensure that operational integrity is retained.

IP link redundancy is preferably available through the use of multiple physical links from the redundant IP switches to the IP network, and optionally through the used of IP Spanning Trees (supported by the Cisco Catalyst 2950XL). Layer 3 IP switching can also be implemented in more complex IP switching solutions.

Failures of power supplies or hard drives in SS7 nodes may result in the affected server's operating system being halted. In such situations, heartbeat failures may be used to detect that the server has gone offline and traffic and services may be redistributed to remaining functioning nodes (the N+1 architecture in association with the processing “headroom” on each node preferably allows for at least one full server failure without affecting throughput.

Within each network node, configuration data, application data and application software may be replicated across multiple small servers. This may allow system data to be recovered rapidly in the case of component failure and may also allow the system as a whole to remain operative since there is preferably always a full set of configuration information available during single component failure conditions.

Dynamic data such as CDRs can be protected in two ways. Transporting the data off the network nodes onto the billing system at regular intervals provides an inexpensive, yet reliable way of protecting data. Alternatively, a disk array can be added to the solution to ensure that a single disk failure never results in the loss of data.

The operation, maintenance, support and provisioning of one embodiment of the system will now be described in more detail.

MDP may be implemented as a fully managed network entity. The solution can be integrated with an OMC/NMC for monitoring via the SNMP protocol. SNMP may be used for both alarms and statistics. In this embodiment, alarms may be generated based on some or all of the following:
Node availability
System availability
Hardware availability
SS7 availability
Disk availability.

Statistics may also be generated based on some or all of the following:
MO messages received
MO messages delivered (SMSC)
MO messages delivered (Direct Delivery)
MO messages delivered (IP offload)
Error stats: Mobile Not Reachable Reason (Temporary)
Error stats: Mobile Not Reachable Reason (Permanent)
Error stats: IP delivery reason.

The MDP is preferably desogned to integrate fully with HP Openview. Hence element information may be presented through standard SNMP techniques, allowing operators to have a full view of the system operation.

The MDP may further be implemented with a Provisioning and Management Interface (PMI). The PMI is preferably a web-based tool that acts as a centralized management point for routing and configuration information. The PMI may allow multiple concurrent operator sessions and can be used locally or remotely and user access and system privileges may be managed through username and password checks.

In this embodiment, the PMI is hosted on the Service Node and may be used to perform one or all of the following functions:
Provision routing table used by each of the MDPs
Change the load-balancing table for message transfer to SMSCs
Provision applications
View node availability
View SS7 Link availability.

Through the PMI and the use of SNMP, the OMC/NMC may monitor availability and health of other MDP nodes and report on their apparent status.

The MDP may further use standard IP access tools to provide local or remote system and management access. The PMI preferably uses a standard HTTP(S) web browser and low-level system access can be gained through telnet or a secure shell (ssh).

The MDP is preferably further supplied with external DDS3 tape drives to enable system backups to take place. In the present embodiment, operating system scripts can also be executed on a scheduled basis to perform backups of application software and configuration.

Backups to remote systems may also be performed using standard operating system remote mount type functions. Preferably, the system is implemented so that application software is identical on all servers within a node so a copy is always readily available from a working server in the case where a system has to be reloaded. Similarly, configuration files may be backed up across multiple servers.

Due to the design of the MDP described herein, individual servers can be taken offline for upgrade, repair or reloading without affecting system traffic. As a consequence, there may be no outage associated with such an event.

To facilitate billing, the MDP may generate configurable CDR records for each successful event. The records may be configurable to include any field of information from the row in the routing table that applied to it. It may further be possible to record any field of information that is received in the PDU of the message. If required, CDRs can also be created for unsuccessful events. The information captured in the CDR is preferably configurable, for example, detailed information may be captured about the originating network and MSISDN and also the destination network and MSISDN. The CDRs may be captured in files that are closed periodically (e.g. every 30 minutes) or after a configurable number of CDR records have been written.

CDRs may be generated based on some or all of the events in the following non-exhaustive list: Submission (message received by MDP) Delivery attempt (message sent by MDP) Delivery success (message sent by MDP) Delivery failure (message not sent by MDP). The events on which CDRs are generated is preferably configurable per message profile. One message profile may encompass zero or more CDR generating events (e.g. generating a CDR for a submission and the delivery attempt).

The CDR format, location, and filename used to record a message delivery attempt are preferably determined by the message profile. It may be possible to not record a CDR for particular message profiles.

Fields that may be stored in the CDR/ADR records may include, but are not limited to:

Date and/or timestamp
Originating or destination IMSI or other identifier
MNC/MCC details
Message length
Routing information
Message class.

Examples of file formats that MDP can construct include:
Binary
CSV
Block format
ASCII
Hex.

CDRs may be stored in the individual servers for collection from, or transmission to the billing system. Each server preferably has a separate disk partition for CDR storage and SNMP traps may be provided to alert system managers to CDR space problems or CDR write failures.

If required, a redundant disk array can be integrated with the service node to provide a secure central repository. CDR files on the individual servers may be regularly transferred to the RAID and from there transferred to the billing system.

CDRs may further be stored on a central server such that all CDRs can be retrieved from one place. CDRs can be transferred to the central store once the file is closed. The CDR storage is preferably designed to be resilient to individual disk failures. CDRs may be retrievable from the central location using, for example the FTP protocol or SCP protocol.

Storage and transfer mechanisms can be implemented such that the risk of loss of CDRs before and during the transfer of files is negligible. After the file is successfully transferred to the main billing system or mediation device, the local file can be archived or deleted.

The CDR transfer session can be based on protocols such as FTP or scp (secure copy). The MDP is preferably capable of initiating, according to a configurable schedule, the transfer of files to the billing system. Alternatively, the MDP can passively wait for FTP connections from remote systems.

The MDP solution described herein is preferably fully compatible with industry standard security techniques. Security concepts are preferably applied from the lowest levels of the operating system, through to intersystem communications. The end to end security concepts that may be applied in the MDP are outlined below.

Users, Usernames and Passwords:

At the OS level, there are two primary users may be configured at installation. The user with the highest level of privilege is the root user. This user preferably has access to all areas of the system and all files including application and network configuration files. This level of access is likely be restricted to essential management personnel only when the system is in operation.

The other primary user is the application user. The application user executes the application code. This is also a powerful user and again, access is likely to be restricted to essential management and maintenance personnel.

In particular, management interfaces may be implemented to use some form of trusted authentication to validate users.

Standard OS features may be configured and used to provide password aging and to provide an audit trail of access attempts.

The MDP system may further, if it is possible, use a form of authentication for all interwoking systems including access to SMSCs, applications, etc.

Interfaces:

Each node preferably employs multiple physical IP interfaces, as outlined above. This may not only allow traffic on individual interfaces to be managed separately, it may also provide operational security. Typically, a server will have at least 3 physical interfaces, which may be used for management and configuration, intranode communication, and system traffic.

The management and configuration interface may be used for web access to the Provisioning and Management Interface (PMI), telnet, and ftp access (or their secure equivalents).

The intra-node communication interface may be used to facilitate system heartbeats and information transfer. Each server in a node preferably issues regular heartbeats and status information to enable its peer to know when a failure occurs.

The traffic interface may be used for system traffic and is likely to be the most vulnerable of all interfaces. A firewall and associated authentication information may be used to protect this interface.

The MDP system may protect some or all of its TCP/IP interfaces by shutting down unused ports. Secure protocols may also be used to transmit data between different locations. The system may be implemented so that multiple TCP/IP interfaces on the same host connected to more than one network do not allow packets to be routed between them.

Ports:

All non-essential services and ports may be disabled on interfaces to increase security. Regular port scanning may also be implemented to maintain security levels.

Networks:

All networks that are associated with particular interfaces may use standard techniques to provide operational security and to maintain link integrity. Virtual Private Networks (VPN5), spanning trees and layer 3 switching can be employed to provide secure and reliable network connections. To provide security without the expense of VPNs, utilities such as ssh and scp can be employed.

Application and Configuration Security:

As discussed above, configuration files may be protected by standard OS features. The system may further be implemented such that information that is stored in configuration databases is also subject to user level restrictions and can be protected by encryption mechanisms provided by the database itself.

FIG. 38 is a schematic diagram of a high level security architecture which may be implemented as part of the system described herein. The architecture of FIG. 38 shows interfaces and methods that may be used in the MDP to ensure high security levels are maintained.

Compliance of one embodiment of the MDP system will now be discussed in more detail.

The MDP solution is preferably fully compliant with GSM and 3GGP international standards with relation to SMS message receipt and delivery (for example GSM standards 03.38, 03.40, 09.02 and UMTS standards 23.040, 23.038, 29.002). MDP may further be fully compliant with Phase 1 (v1), Phase 2 (v2) and Phase 2+ (v3) for the following MAP (Mobile Application Part) operations as defined in ETSI GSM 09.02 and 3GPP UMTS 29.002.

MAP Operations that may be performed preferably include:
MAP_SEND_ROUTING_INFO_FOR_SM
MAP_SEND_ROUTING_INFO_FOR_SM_ACK
MAP_FORWARD_SHORT_MESSAGE (MT)
MAP_FORWARD_SHORT_MESSAGE_ACK
MAP_ALERT_SERVICE_CENTRE
MAP_ALERT_SERVICE_CENTRE_ACK
MAP_REPORT_SM_DELIVERY_STATUS
MAP_REPORT_SM_DELIVERY_STATUS_ACK.

Furthermore the underlying SS7 stack used is preferably fully compliant with ITU-T standards for GSM and UMTS networks. For example, standards Q.771-Q.775 (TCAP), Q.711-Q.714 (SCCP), Q.781-Q.782 (MTP), Q.701-Q.707.

The MDP may also be fully “White Book” and “Blue Book” compliant.

The MDP system may further provide high density SS7 connectivity and may further be implemented in conjunction with the Sigtran protocols M3UA and SUA.

The MDP may further be compliant with IEEE standard 802 governing Local and Metropolitan Area Networks, in particular, the following parts:
802.IQ (Virtual Bridged Local Area Networks) δ 802.3 (ISO/IEC 8802 3:2000(E) (CSMA/CD access method and physical layer specifications).

With relation to SMSC connectivity the MDP may be implemented to support a wide range of SMSC vendors and protocol types, for example, SMSCs from Logica, CMG, SEMA, Nokia, Ericsson, ADC Newnet, Comverse and Technomen may be supported using protocols such as SMPP 3.3& 3.4, UCP/EMI 3.5, OIS and CIMD-2.

The MDP preferably supports relevant parts of the SMPP 3.3 and SMPP 3.4 protocols acting as a client. The MDP preferably supports the relevant parts of SMPP Versions 3.3 and 3.4 acting as a server and/or the relevant parts of the UCP protocol version 3.5 and 4.0 acting as a client.

Using the MDP system it is preferably possible to submit an SM to an SMSC via SMPP. The MDP may also be able to receive a Submit SM from an SMPP client and to send a Deliver SM to an SMPP client. Further the MDP is preferably able to receive a deliver SM from an SMSC using SMPP.

As discussed above, the MDP also preferably interworks with SS7 using GSM MAP Phase 2 and underlying protocols such as ETSI GSM 09.02. The MDP shall preferably also be able to interwork with GSM MAP phase 2+ (version 3) and underlying protocols, such as 3GPP UMTS 29.002. In each case, support may also be provided for relevant primitives.

The MDP system may further be able to issue an SRI and receive the results. Also, the MDP may be capable of receiving an SRI request, sending an MO FSM to an SMSC, receiving an MO FSM over SS7, issuing over SS7 an MT FSM and receiving and processing the response and/or receiving MT FSM delivered to it.

By way of example, a number of example delivery strategies for different message types will now be described. In each case, the MDP may determine the message type before selecting and implementing the appropriate delivery strategy.

Peer-to-Peer Direct Delivery

According to one embodiment, the MDP system may be able to perform some or all of the following steps:
Receive and identify an MO identified to use peer-to-peer direct delivery
Query the source MSISDN to check for ported or other illegal numbers (optional).
Query the destination MSISDN to for routing and availability information.
Request a credit from the prepaid platform (optional).
Initiate a mobile terminated message to the recipient. (SRI+FSM)
Receive the acknowledgement from the recipient.
Acknowledge the originator.

If it takes too long to perform any of these steps or if any of them return with temporary errors, the message may be sent to the SMSC or another message service centre instead.

Peer-to-Peer Via a Message Service Centre (for Example an SMSC) over the Mobile Telecommunications Network (for Example over SS7)

According to one embodiment, the MDP system may be able to perform some or all of the following steps:
Receive an MO identified to use peer-to-peer via the SMSC (note this may also apply to messages that have failed a direct delivery attempt),
resend the MO FSM to an SMSC via SS7,
receive the acknowledgement and forward it to the originator,
or —replicate the MSC address such that the acknowledgement is sent directly back to it.
   Peer-to-Peer Via a Message Service Centre (for Example an SMSC) over a Separate Network (for Example a TCP/IP Network)

According to one embodiment, the MDP system may be able to perform some or all of the following steps:
Receive an MO identified to use peer-to-peer via the SMSC (note this may also apply to messages that have failed a direct delivery attempt)
submit the message to the SMSC using a supported SMSC application protocol, replicating the source MSISDN as address if possible
receive the acknowledgement and forward it to the originator.
   Peer-to-Application Direct Delivery

According to one embodiment, the MDP system may be able to perform some or all of the following steps:
Receive an MO identified to use peer-to-application
Query the source MSISDN to check for ported or other illegal numbers (optional).
Request a credit from the prepaid platform (optional).
Either Persist the message to disk and ACK the sender and then deliver it to the application,
Or Deliver the message to the application and ACK the sender
Receive the acknowledgement from the recipient.
Acknowledge the originator.

If it takes too long to perform any of these steps or if any of them return with temporary errors, the message may be persisted for later delivery to the application.

Peer-to-Application Via a Message Service Centre (for Example an SMSC) over the Mobile Telecommunications Network (for Example an SS7 Network)

According to one embodiment, the MDP system may be able to perform some or all of the following steps:
Receive an MO identified to use peer-to-application via the SMSC
resend the MO FSM to an SMSC via SS7
receive the acknowledgement and forward it to the originator.
   Peer-to-Application Via a Message Service Centre (for Example an SMSC) over a Separate Network (for Example a TCP/IP Network)

According to one embodiment, the MDP system may be able to perform some or all of the following steps:
Receive an MO identified to use peer-to-application via the SMSC
submit the message to the SMSC using a supported SMSC application protocol, replicating the source MSISDN address if possible
receive the acknowledgement and forward it to the originator.
   Peer-to-Voting Application

According to one embodiment, the MDP system may be able to perform some or all of the following steps:
Receive an MO identified to use peer-to-voting application,
Query the source MSISDN to check for ported or other illegal numbers (optional).
Request a credit from the prepaid platform (optional),
Either Persist the message to disk and ACK the sender and then deliver it to the application,
Or Deliver the message to the application and ACK the sender,
Receive the acknowledgement from the recipient,
Acknowledge the originator.

If it takes longer than a pre-configured global timer threshold to perform any of these steps or if any of them return with temporary errors, the message may be persisted for later delivery to the application.

Application-to-Peer No Retry

According to one embodiment, the MDP system may be able to perform some or all of the following steps:
Receive a submit SM from an application
Determine the destination as a mobile station
Initiate a MT FSM
If the FSM fails, the application may be NACKed and the message discarded.
   Application-to-Peer Retry Via MDP

According to one embodiment, the MDP system may be able to perform some or all of the following steps:
Receive a submit SM from an application
Determine the destination as a mobile station
Initiate a MT FSM
If the FSM fails, the message may be put into a persistence engine and a retry mechanism employed.
   Application-to-Peer Retry Via a Message Service Centre (for Example an SMSC)

According to one embodiment, the MDP system may be able to perform some or all of the following steps:
Receive a submit SM from an application
Determine the destination as a mobile station
Initiate a MT FSM
If the FSM fails, the message may be submitted to the SMSC via the application interface.
   Application-to-Peer Reverse Bill

According to one embodiment, the MDP system may be able to perform some or all of the following steps:
Receive a submit SM from an application
Determine the destination as a mobile station
Validate destination as on-net subscriber
Initiate credit to prepaid system as needed
Send MT FSM
Create CDR to bill mobile subscriber in additional to normal CDR.
   Inter-Carrier SS7 to SS7 (ie Delivery of a Message Between Mobile Networks of Different Operators)

According to one embodiment, the MDP system may be able to perform some or all of the following steps:
receive an SRI
reissue the SRI to another network
receive response
reissue response (with addr of MDP, caching the original addr)
receive an MT FSM
reissue the MT FSM
receive response
reissue response.
   Inter-Carrier SS7 to IP (ie from a Mobile Operator'S Network to an IP Network of Another Mobile Operator)

According to one embodiment, the MDP system may be able to perform some or all of the following steps:
receive an SRI
check the availability of an interconnected SMSC
Issue SRI response
receive an MT FSM
persist the MT FSM and ACK
send submit SM to SMSC
receive ACK.
   Inter-Carrier IP to SS7 (ie Delivery of a Message from the Home Operator's IP Network to Another Operators SS7 Network)

According to one embodiment, the MDP system may be able to perform some or all of the following steps:
receive deliver SM from a connected SMSC
persist the SM and ACK
Issue an SRI
Accept SRI response
Issue MT FSM
Accept MT FSM response.
   Inter-Carrier IP to IP (i.e. Delivery of a Message from One Carrier's IP Network to Another Carrier's IP Network)

According to one embodiment, the MDP system may be able to perform some or all of the following steps:
receive deliver SM from a connected SMSC
persist the SM and ACK
send submit SM to connected SMSC
receive ACK.

By way of further illustration of the principles outlined herein, FIGS. 39 to 47 illustrate example processes by which messages may be transmitted through a mobile operator's network in which the MDP system described herein has been implemented.

FIG. 39 illustrates one example of the process of direct delivery of messages. The message does not pass through an SMSC, but is taken out of the mobile network at the MSC of the originating Mobile Station and is transferred by the MDP system to the MSC of the destination Mobile Station. The message may be acknowledged to the originating mobile station when it has been delivered successfully to the destination Mobile Station.

FIG. 40 illustrates one example of the process of delivering a message to an SMSC via an MDP. The message may be returned to the mobile network at the SMSC if, for example, the destination Mobile Station is temporarily unavailable.

FIG. 41 illustrates one example of the process of delivering a message to an SMSC via an MDP and an MDP-IP. The MDP-IP may acknowledge delivery of the message to the originating mobile station before passing the message to the SMSC.

FIG. 42 illustrates one example of non-delivery of a message to a blacklisted number. In this example, the message is received by the MDP and the MDP determines from the HLR that the destination Mobile Station is blacklisted. The MDP then transmits a delivery failure message to the originating Mobile Station and the message does not need to be re-transmitted into the mobile network.

FIG. 43 illustrates one example of the process of delivery of a message to a gateway MSC (SMS G/W) for delivery to another network via an MDP. The message is received by the MDP and delivered via an MDP-IP to the gateway MSC of the home network. The message does not have to pass through an SMSC of the home network and delivery of the message may be acknowledged by the MDP-IP before the message is passed to the gateway.

FIG. 44 illustrates one example of the process of delivery of a message from another network to a mobile station via MDP. The message is received by the MDP-IP from the gateway MSC and delivered directly across the MDP system network to the MSC corresponding to the destination Mobile Station.

FIG. 45 illustrates one example of the process of delivery of a voting message to a voting application using the MDP system. The message may be delivered directly to the voting application from the MDP-IP and may be acknowledge by the MDP-IP before delivery to the voting application.

FIG. 46 illustrates one example of the process of delivery of a message from a voting application to a mobile station via MDP. The message does not have to pass through an SMSC of the home mobile network, but can be delivered directly to the MSC corresponding to the destination Mobile Station by the MDP system.

FIG. 47 illustrates one example of the process of delivery of a message from a voting application to a gateway MSC for delivery to a destination Mobile Station on another network.

Further optional feature of the MDP system are described below.

The MDP is preferably configurable such that the integrator of the system into the mobile network can restrict its functionality to only those functions which are licensed to the operator.

According to a further feature, the MDP may be capable of optionally making a credit reservation on a prepaid platform by an interface to be defined. This may be done for the message originator. If the credit is not available the message may be NACKed. If provided, this option may be set per message profile. If the message is not delivered, the MDP may then request a credit release.

According to a further optional feature an SRI may be issued to the originator's HLR to validate him as a subscriber on the correct network, for example by looking at his IMSI. If provided, this option may be set by the message profile. This feature may be used particularly in MNP enabled environments.

As described above, the MDP system may be able to change the delivery strategy for a message should it fail to be delivered within a predefined period of time. The period of time may be set per message profile.

To enable application interworking, the MDP is preferably able to interface to multiple applications.

A “Blacklist” may further be provided in the MDP system and MDP may be able to reject messages from/to sources/destinations that are designated as “blacklisted”. It shall preferably be possible to blacklist based upon combinations of the following:—Origin MSISDN
A number Destination MSISDN
B number Calling Party Address
Called Party Address.

It is preferably possible to designate these addresses using regular expressions.

According to a further preferable feature, the MDP may maintain a cache of SRI responses used when performing the inter-carrier SS7 to SS7 delivery strategy so that the destination indicated in the SRI response may be swapped with the address of the MDP and then switched back when reissuing the MT FSM.

A further embodiment of the MDP system will now be described. Features of the other embodiments described herein may be applied to this embodiment and features of this embodiment may be applied to other embodiments of the MDP system.

The MDP system is preferably designed to meet some or all of the following high level requirements:
Intelligent Routing
Scalability
Resilience
Load Balancing
Lower Cost per message and lower total cost of ownership.

These requirements may be met by implementing the system using an Adaptive Distributed Architecture as opposed to a traditional centralised approach. Distributing the architecture may allow the system to be implemented with minimum impact on existing network infrastructure and operations. The distributed approach may be used to provide a flexible solution that is agile to changes in the system.

The decentralised approach described herein is considered to have several advantages over a centralised approach. For example, the centralised approach may produce bottlenecks which confine message processing and concentrate message transfer and further may require significant capital investment to provide scalability and resilience. FIG. 49 illustrates one embodiment of a prior art mobile telecommunications network designed with a centralised approach.

A distributed approach, however, preferably allows the use of smaller, commoditised hardware to provide a flexible solution that can be varied, for example, to suit differences in regional loads. FIG. 50 shows an example of a mobile telecommunications designed using a decentralised approach. A decentralised approach may also allow for use of clustered commodity hardware to distribute load and accommodate variations in load. A decentralised approach preferably further allows for the functionality to be located at the most appropriate part of the network and increased redundancy, for example by using multiple machines per location. The disadvantages of a de-centralised architecture may include the perceived increase in management costs and complexity due to increased number of locations and hardware. In the system described herein however, management may be implemented as a centralised function so system management overhead may be minimised.

The system described herein is preferably based on a distributed architecture that may be designed to allow a high degree of reliability, scalability, and flexibility:
Reliability may be achieved with multiple levels of system, unit, and component level redundancy.
Scalability may be derived from the N+1 system architecture that uses simple reusable hardware components integrated over a common TCP/IP network.
Flexibility may be achieved through modular design that, for example, allows functional components to be organised so that they can closely match the unique demands of the network.

Further features of the system preferably include:
Intelligent routing of messages within the network.
Storing and delivering messages to applications.

Because these two functions have differing requirements for architecture, resources, and throughput, they are preferably facilitated by two different elements working synchronously together. This two-element solution allows a system to be implemented with no compromise to the architectural design for each function and that one function will not compete for resources with the other. Such a system may allow each element to achieve high rates of throughput and to accommodate extreme stresses and variance of input without hindrance.

The intelligent routing function is preferably implemented by capturing mobile originated (MO) SMS traffic at various points in the network and intelligently applying routing rules to them. These routing rules may be used to determine, for example, whether or not a message is delivered to an application (in the case that it is a vote message) or to an SMSC (for normal peer-to-peer functionality). This function may be provided by the Message Delivery Platform (MDP).

The MDP is a distributed system for managing mobile messages throughout a network. The system preferably provides features such as:
Expanded capabilities and service (e.g. voting, applications, peer-to-peer direct delivery, etc.)
A reduced cost for delivering messages
Increased reliability and throughput.

The MDP may be purpose built to route messages in the network at high speed. The distributed nature of MDP “nodes” (occurrences of MDP elements in a network) may allow them to function at optimal points in the network to accept, manage, and route messages. Furthermore, if the system is implemented by the use of small servers in an N+1 scalable design, each node may be sized to fit the exact requirements of the area it is servicing and scaled accordingly.

In the present embodiment of the system, messages from the MDP may be:
Routed and load balanced/distributed to the SMSC
Relayed to a voting application via the Application Messaging Service Centre (AMSC).

Further details of embodiments of the AMSC are provided herein and one embodiment is described in more detail below. The AMSC may be used to hold messages as needed and deliver them to applications. It preferably provides application management capabilities including provisioning, security, throttling, prioritisation, load balancing, etc. A special provisioning tool for event management may be used in order to manage multiple concurrent voting campaigns.

The AMSC preferably further provides the connection interfaces for the participating applications. The present embodiment of the AMSC provides standard SMSC protocols such as UCP and SMPP, and it may also provide highly efficient, open and standard IT protocols such as XML, HTTP, SMTP, etc. The AMSC may share some of the distributed capabilities of the MDP since it may run on small common hardware and preferably scales effectively through an N+1 design. This may provide unit and component level redundancy in addition to system redundancy.

In this embodiment, the MDP and the AMSC interoperate with each over a common TCP/IP network. One embodiment of the implementation of MDP and AMSC into a network is shown in FIG. 51. The TCP/IP network preferably allows high volumes of messages to traverse the network to and from applications without congesting the transit network and other core signalling areas. The use of the TCP/IP network may allow for a significant reduction in both purchase and operational costs.

The combination of MDP and AMSC may be used to create a powerful set of functions and capabilities designed to meet a mobile telecommunication operator's routing, voting and load balancing requirements.

The solution preferably further offers a number of additional features that would allow an operator to leverage further value through the provision of enhanced capabilities and services. These additional features may include:
Direct-delivery, the ability to terminate messages to a handset or an application without using the SMSC
Application services providing QoS traffic management tools. These can be used for voting and non-voting applications
Special processing and routing for specific message types (e.g. premium rate, short codes, specific applications).

The system is preferably based on a distributed architecture, as described above. This may allow the distribution of functionality across servers, sites, and even across large geographies in order to achieve maximum flexibility and efficiency. The primary benefits of such a distributed architecture may include:
Increased unit level and system level reliability
Reduced cost of message transit
Potential for bottlenecks may be eliminated
Services may be in close proximity to the places where they are needed
Services may be in close proximity to required resources
Lower cost, commoditised hardware.

Both MDP and AMSC preferably use distributed architectures in order to achieve some or all of these benefits. MDP and AMSC servers preferably communicate within each node, between nodes, and between different components, for example over TCP/IP networks. These networks may provide the advantages that they are cost-efficient and are easy to deploy and maintain.

The distributed architecture used may be designed to interface efficiently and work advantageously with an existing mobile telecommunications network. This may involve the placement of MDP nodes at each or at many STP sites; this may allow the system to capture SMS in volumes that are more manageable and negate the need for very large and specialised hardware and equipment. Each node may be designed to be remotely managed from a central location to minimise overhead involved with site deployment and management.

MDP nodes may provide the ability to receive mobile originated SMS in high-speed and to determine their message type by analysing parameters within each message. Such parameters may include the SMSC ID and the B number (the ultimate destination address). The MDP may further identify voting messages and SMSC handled messages. For a vote message type, the message may be passed to the AMSC for delivery to a voting application. For messages that are not in the voting message type, they may be passed to the SMSC as mobile originated messages.

One embodiment of the deployment of the MDP and AMSC systems in a mobile telecommunications network is shown in FIG. 52. In this solution, MDP nodes 5203 are preferably connected to an IP network which may run over a high throughput network. This may allow the MDP nodes 5203 to interface with each other and to the AMSC nodes 5201 which may be deployed at SMSC sites. This may be done over a segmented and switched high-availability TCP/IP network. More detailed information on one embodiment of the TCP/IP network is provided below.

As mentioned previously, the AMSC may be connected to the TCP/IP network, described in more detail below. In this implementation, the AMSC may be responsible for terminating messages, persistence (as needed), hosting multiple application connections, provisioning, CDR generation, and system management. The MDP nodes may be centrally managed through the AMSC's common management interface.

The system is preferably designed to be highly scalable due to its distributed N+1 design. The MDP and AMSC solutions preferably both use a high number of small efficient servers instead of a lesser number of large systems. These can be increased in number as additional capacity is required. Each server may be designed to work as part of a logical group performing similar tasks to other servers and communicating with others as required. This type of communication preferably also takes place between different elements—in this case, between the MDP and the AMSC.

If the system is implemented with an N+1 architecture, reliability increases as the system is scaled due to the increased unit level redundancy. With multiple nodes deployed and the ability to add more nodes, system level redundancy also increases as a function of growth.

The servers in each node may be designed to interact with each other as part of a group over a common network, in this case a local Ethernet network. This may enable them to act as one logical entity even though the resources may be distributed across several servers. Adding extra capacity may then simply be a matter of introducing a new server into the group. The theoretical capacity limit of this type of solution is bound to the input/output (I/O) capabilities of the transport between the servers. Because the system is preferably designed to be transport agnostic (i.e. they can be upgraded from 100 Megabit Ethernet to Gigabit Ethernet, etc.), the solution scales extensively.

As each node may be comprised of small servers, the operator has a high degree of flexibility to size each region as needed and grow each node on a “just-in-time” basis. In this response, each MDP node may be initially deployed with the ability to process up to around 600 SMS/sec. In the case of partial or complete link failure at another site, the same node may be able to process up to 1.200 SMS/sec sustained throughput.

This brings the combined throughput of all MDP nodes in this embodiment up to 6,000 SMS/sec running the equipment and links at a standard 0.4 Erlang.

In this example, each MDP site is one rack containing the following equipment:
MDP Node for 600 SMS/sec
3 Sun Fire V480 servers running MDP software
2 Cisco layer 2 switches with high speed uplink
3 E1 with 16 signalling links each
10 MDP nodes will be deployed to support 6,000 SMS/sec.

In this case, this is scalable to achieve 20,000 SMS/second and further as needed, for example:
MDP Node for 2,000 SMS/sec
7 Sun Fire V480 servers running MDP software
2 Cisco layer 2 switches with high speed uplink
7 E1 with 16 signalling links each
10 MDP nodes will be deployed to support 20,000 SMS/sec.

The AMSC solution of this embodiment consists of one node at each of two SMSC sites and splits the total load of traffic between them. The AMSC may have similar hardware but does not require any SS7 interfaces for this solution. It may be used to host the main layer 3 TCP/IP switches that are used to gather traffic from across the network. It may also host SAN data stores, which may be used for message persistence and for CDR storage. Each AMSC of this example is initially deployed with the ability to process up to around 3,000 SMS/sec (around 6,000 SMS/sec total) and then with the addition of more servers is grown to accommodate around 20,000 SMS/sec.

The AMSC equipment according to this embodiment is as follows:

AMSC Node for 3,000 SMS/sec
3 Sun Fire V480 servers running AMSC software
2 Sun Netra T1 service nodes
1 high-speed Cisco layer 3 redundant switch
2 storage array units.

This system may be designed to be scalable to achieve around 20,000 SMS/second and further as needed:
AMSC Node for 10,000 SMS/sec
10 Sun Fire V480 servers running AMSC software
2 Sun Netra T1 service nodes
1 high-speed Cisco layer 3 redundant switch
5 storage array units
Two AMSC nodes may be deployed to support 20,000 SMS/sec.

As discussed above, the system described herein provides high levels of flexibility for coping with the unpredictable nature of mass media, high-volume audience participation. This embodiment of the system may provide a number of different processes for message termination, which may be known as “message delivery strategies”. Three types of message termination are outlined below. The flexibility of provided by the use of a number of different message termination processes may allow the system to achieve greater efficiency for receiving as many messages as possible in the shortest possible period of time.

Identification of message types, which may be used at least as a factor in determining the delivery strategy used, may be identified based on the analysis of one or more fields in the message. The fields may be known as the identification criteria. Examples of fields that may be used may include:
Origin MSISDN
A number Destination MSISDN
B number Calling Party Address (CaPa) Called Party Address (CdPa).

It is preferably possible to designate these addresses using regular expressions.

It may be possible to set a message priority for each identification criteria. This may allow the system to NACK, or reject, messages in order of priority if the system enters a congestion state.

The MDP is preferably designed to support the definition of a message profile (e.g. a peer-to-peer message, a peer-to-application message, etc.). An identification criteria may then be associated with a message profile. The message profile may further be associated with one or more message delivery strategies.

A message delivery strategy may define the steps and conditions that may be used to process and deliver a message. A message profile may be assigned one or more delivery strategies ordered by preference (see dynamic delivery strategies). The delivery strategy may change according to network conditions or other predetermined conditions.

It may further be possible to state a destination for an identification criteria. The destination can be one of one or more SMSCs (for example, as expressed by GT or PC), or one of one or more MDPs. The available delivery strategies may then be determined by the destination.

The type of message termination used in any particular situation preferably depends on predetermined conditions. The predetermined conditions preferably include the status of the network, such as the load on the network, and the type of message that is being terminated (which may be governed by, for example, the identifier of the destination for the message).

Three types of message termination which are preferably provided are:
Immediate acknowledgement (ACK)
Persistence
Sychronised double acknowledgement (ACK).

The list above is not exhaustive and other types of message termination may also be provided.

According to a further feature that may be provided, it may be possible to NACK all messages, specific messages or specific message types if the system should risk becoming overloaded.

The processes that form three of the different types of message termination will now be described in more detail with reference to FIGS. 53, 54 and 55.

FIG. 53 shows one embodiment of the process of Immediate acknowledgement of messages using the present system. The mobile originated message is sent from the MSC to the MDP 5302 and the message is acknowledged immediately by the MDP. This acknowledgement message may be passed back to the originating mobile station immediately 5304, which may allow the radio channel between the originating mobile station and the MSC to be closed more quickly after the message has been sent. This may help to reduce congestion on the network during busy periods.

In this way, Immediate ACK may provide the maximum throughput through the system, but does not guarantee that messages will be delivered successfully to their final destination (i.e. terminated successfully). This option is intended for services that don't require a guarantee for message delivery or may be used as a last resort for services that require a guarantee but have exceeded the maximum throughput of the solution when guaranteeing messaging delivery.

When the message has been acknowledged by the MDP, the MDP may then use a burst transfer between the MDP and AMSC to optimise throughput 5306. The messages may be sent to the AMSC over the separate network that they share, in this case a TCP/IP network. The messages may also be grouped, as described herein, and all duplicated information within them may be removed (for example a large number of messages destined for the same terminating application or mobile station may be grouped together). This may allow a large number of messages to be sent to the AMSC more efficiently than if each message was sent separately. The group of messages may further be compressed by the MDP to allow them to be sent more quickly to the AMSC.

The AMSC can then forward the message to an application 5308, as shown in FIG. 53, or to a terminating mobile station, for example via a second MDP. Acknowledgement of the receipt of this message may be passed back to the AMSC 5310, which may allow the AMSC to confirm that the message is finally delivered to its destination.

Immediate ACK can preferably be terminated if predetermined conditions, for example network conditions, subsequently arise. For example, Immediate Ack may be terminated and all subsequent messages automatically rejected if a destination application exceeds latency thresholds or becomes unavailable and the persistence option (outlined in more detail below) is either not being used or has already exceeded its storage quota.

A second message termination option that may be implemented is the Persistence option. The process of the persistence of messages will now be described in more detail with reference to FIG. 54. The persistence message termination process may allow messages to be stored for later delivery and may be used, for example, when the network is very busy or when a destination application or mobile station is not available to receive a message.

As illustrated in FIG. 54, in one embodiment of the process of persistence of messages, a message is sent from the MSC of the mobile network to the MDP (1. FSM) 5402 and this message is transferred directly to the AMSC (2. TFR) 5404 across the network that the components share, in this case a TCP/IP network. The message may then be passed to a message store (3. Store) 5406 to be persisted. An acknowledgement of the receipt of the message may then be passed back to the MSC (4. ACK) 5408 for delivery to the originating mobile statement. The stored message may then be passed by the AMSC to the terminating mobile station or application (5. FSM) 5410 and an acknowledgement message may be transmitted from the terminating mobile station or application to the AMSC (6. ACK) 5412 to confirm that the message has been finally delivered.

The persistence message termination option may be designed to maintain a constant in-flow of messages even if the application or mobile station has exceeded latency thresholds or has become unavailable. It is preferably designed to maintain the throughput of a non-persisted solution for up to around 5 minutes in this example.

In this embodiment, there are two methods in which persistence works. The persistence method may be determined, for example, by the overall throughput of new messages arriving into the system.

If the input of new messages does not exceed normal operational parameters, the system may be designed to accept new messages for storing and may also provide stored messages to the delivery engine, for example the AMSC, at the same time. In this embodiment, resources may be split between accepting new messages for storage and delivering messages that are already persisted.

In the situation where there is an overload of new messages arriving at the solution, the system may be designed to change to persist only mode whereby it will use resources to store messages as fast as possible. Delivery of messages to the application may then be delayed until the overload condition no longer exists or the message store quota is exceeded. A typical store quota in this embodiment may be around 5 minutes at peak volume. In some embodiments, messages may be persisted more quickly by the system in persist only mode, since it is likely to be faster to exclusively write to the message store, rather than both writing and reading from the same message store at a particular time.

A third message termination process that may be provided is the Synchronised Double Acknowledgement (ACK) process. This process may be used to terminate messages to applications or mobile stations in high volumes. This acknowledgement process preferably does not require persistence in order to guarantee delivery of the message. The process preferably operates by relaying the message to a high-speed application and relaying the acknowledgement back the originating handset, as illustrated in FIG. 55, which shows one embodiment of the synchronised double acknowledgement process.

According to one embodiment of this process, a message is sent from the MSC corresponding to the originating mobile station to an MDP (1. FSM) 5502. The message may then be transferred to the AMSC (2. TFR) 5504, which may then deliver the message to its destination (3. FSM) 5506. An acknowledgement of receipt of the message is then passed back to the AMSC (4. ACK) 5508 and forwarded to the MSC (5. ACK) 5510 for onward delivery to the originating mobile station.

This procedure may be designed particularly for delivery of messages to applications that can receive and acknowledge messages at high speed. In order for the delivery and acknowledgement process to work, the application should be designed to be able to respond within a set threshold. This may reduce the likelihood of radio and SS7 resources becoming congested with open dialogues (in particular between the originating mobile station and its base station). If the set threshold is exceeded, the system may be designed to switch to using the persistence option described above.

FIG. 48 illustrates how a message may be delivered from an originating Mobile Station to an application, via an AMSC as described herein according to a further embodiment. A message may be sent 4804 from a mobile entity 4802 to an MDP 4808 as described herein. The message may then be processed further according to a predefined delivery strategy.

Depending on the message type, the message may also be terminated by the MDP and/or may be transmitted 4810 for onward storage or delivery to its destination (Direct Delivery) or to an. SMSC of the mobile network.

If the message is addressed to an application 4812 connected to an AMSC 4814 to which the MDP is attached, for example over a separate IP network, then, in this embodiment, the message may be transmitted to the application according to one of three delivery strategies illustrated in the diagram.

The message may be forwarded 4816 by the MDP to the AMSC, which may in turn forward 4820 the message directly to the application 4812. Acknowledgement of receipt of the message by the application may then be transmitted back to the originating mobile station 4802.

In a second delivery strategy, which may be used as a fall back strategy for that described above, the message may be passed from the AMSC 4814 into an associated persistent store 4824. The store may retain the message in memory until it can be delivered to the destination application 4812, for example when the network is less busy or when the application becomes available to receive messages. An acknowledgement message may be sent back 4818, 4806 to the originating mobile if the acknowledgement message is not sent back to the originating mobile until the message is received by the message store then the message will always be stored, either by the mobile 4802 or the message store 4824, hence it may not be necessary for the MDP 4808 to persist the message.

A further delivery strategy which may be used particularly if the network is heavily congested is also illustrated. The message is received by the MDP 4808 and an acknowledgement message 4806 is sent back to the originating mobile. This may allow the channel to the originating mobile to be closed as quickly as possible and hence reduce congestion on the mobile network. The message may then be processed by the MDP, for example, it may be forwarded to the AMSC or to an SMSC.

Below is a non-exhaustive list of conditions that can occur and the changes to the message delivery that may be made to accommodate them according to the present embodiment of the system.

| Condition | Message Delivery Method |
|---|---|
| Normal | Synchronised Double ACK as described above. |
| Application exceeds Response | Messages persisted and delivered concurrently. Message |
| Latency Limit | store is used as needed to hold messages for the application. |
| | Messages stored and delivered in a first-in, first-out (FIFO) |
| | order. |
| Application unavailable | Messages are persisted until the application returns or the |
| | application's store quota limit is exceeded. |
| Application unavailable and Store | Messages are NACK'ed by the MDP until the application |
| Quota Limit met | becomes available and/or the store quota limit is not |
| | exceeded. |
| Throughput exceeds limit (while | Messages are ACK'ed immediately and batch processed to |
| using Synchronised Double ACK) | increase efficiency. When throughput threshold is no longer |
| | exceeded, the message delivery method returns to |
| | Synchronised Double ACK. |
| Throughput exceeds limit (while | Messages are persisted but not delivered in order to make |
| persisting for a slow or absent | available as much resource as possible. Delivery of messages |
| application) | occurs when the throughput threshold is no longer met or the |
| | Store Quota Limit is met. Messages stored and delivered in a |
| | first-in, first-out (FIFO) order. |
| Manual Persistence | Option set when provisioning the application that it should use |
| | persistence by default when under normal circumstances. |
| Manual Immediate ACK | Option set when provisioning the application that it should not |
| | use any form of acknowledgement and should batch process |
| | messages for efficiency. |
| Application inactive (turned off or | Messages for this application are NACK'ed. |
| outside of valid voting period) | |
| System capacity limit exceeded | Messages for lowest priority applications are NACK'ed. System |
| | works through the priority chain until the capacity limit is no |
| | longer exceeded. |

The routing of messages within the present embodiment of the system will now be described in more detail. The MDP is designed to have the ability to examine the PDU of an SM (either MO or MT to determine the MT destination and the B number (which indicates the actual destination address of the message). This introspection may be done at the MAP layer of the SS7 stack in order to determine the PDU contents. Each SM received by the MDP either via SS7 or via the MDP network is examined for the MT destination. Once the MT destination is identified it may be matched against a list of known destinations found in the destination table. If a match is found in the destination table, the matching entry may be used to determine parameters for the message, such as the type of message, its destination, how it should be processed, and its billing type and class if any.

In this embodiment, entries in the routing table may be made via the Provisioning & Management Interface (PMI) using a web-based interface. These entries may further be propagated to the relevant MDP nodes in the network over the control network. Adding a voting application through the Event Handler may cause an update to take place in the routing table of the MDP solution. Most routes are preferably published as global routes meaning that the route is valid across all MDP routing nodes. However, certain location specific routes can be published to specific MDP nodes as needed.

In one embodiment, the MDP may have a plurality of routes and a plurality of processes for delivering messages. A first route may be designated as the default and may be used, for example, for all non-voting messages and for all messages originating from roaming subscribers. A further message type may be the voting message type which may be set up as a routing rule in the MDP routing table.

FIG. 56 is a flow diagram that shows one embodiment of routing decision flow in the system described herein. In this example, the system is designed to detect voting messages destined for voting applications and to deliver these messages directly to the voting applications without using the SS7 telecommunications network.

In the example illustrated, a mobile originated message is received at an MDP 5602. The MDP verifies whether the address of the originating mobile station or application belongs to an entity on the home network 5604. If the originating mobile station or application does not belong to the home mobile network, then the mobile originated message may be forwarded as a mobile originated message 5606 to an SMSC of the mobile network 5608 and delivered on to the destination mobile entity across the mobile telecommunications network.

If the message does originate from a mobile station on the home network, then the MDP may determine the identifier of the destination entity for the message by accessing the message at the MAP layer of the SS7 stack. In this embodiment, the MDP determines whether the destination identifier for the message corresponds to a voting application 5610. In this example, if the message is not a voting message, then the message is passed back as a mobile originated message 5612 to an SMSC of the mobile network 5608. If the message type is determined to be a voting message type 5610, then the MDP verifies that voting is in session 5614. If voting is not in session for the destination number of the short message, then a message that the message has not been delivered successfully (NACK) is sent back to the originating mobile station 5616.

If voting is determined to be in session for the destination number of the message, then the message may be passed to an AMSC 5618, preferably over the separate network that joins the MDPs and AMSCs of the system, in this case a TCP/IP network.

The AMSC receives the message and determines whether the destination application for the message is available to receive the message 5620. If the application is available, then the message is passed directly to the application. If the application is not available, then the message is passed to the AMSC message store 5622 for later delivery to the application.

In this embodiment, the voting message type may be identified using the SMSC identifier and by the B number (actual destination address) of the message. If these match a voting entry in the MDP routing table, the message may be sent from the MDP to AMSC for termination at an application. In this embodiment, there is an exception to this if the Calling Party Address is not a MSC address in the home operator's network which means the subscriber is roaming and will need to be subject to the roaming prepaid application.

If the message does not match a voting message it may be set as the default message type and may be sent via SS7 to the SMSC as a normal mobile originated SM.

The MDP may further have load balancing capabilities in that it may be capable of distributing load to SMSCs according to their capacity to process messages. This may only be done for messages that are sent to the SMSC but do not need to be sent to a particular SMSC. The MDP preferably uses two metrics to perform the load balancing of which one is static, and one is variable.

In this embodiment, the static metric determines the SMSC's overall capacity to process messages. Both the static and the variable metrics are described in more detail in the embodiment described above.

In order to maintain correct distribution of multipart messages, MDP may use a session timer for individual messages. The session is preferably started immediately upon delivery of each message. If another message with the same B number, originating number and SMSC ID should pass through the same MDP node within a certain period of time, the MDP may then be designed to route the message to the same SMSC as the previous message was sent to.

The load balancing function may be managed via MDP and AMSC management interfaces. This interface may be used to change the loading metrics and to view load balancing statistics. In addition, SMSCs can be taken in and out of service for scheduled maintenance work via this interface.

The TCP/IP network of this embodiment will now be described in more detail. As mentioned earlier, in this embodiment, the MDP nodes communicate with each other and with the AMSC nodes via a TCP/IP network. This network may be used to provide the primary means by which voting messages are relayed between the MDP and AMSC nodes and ultimately to the voting application.

One embodiment of a TCP/IP network that may be used to connect the components of the system is illustrated in FIG. 57.

The TCP/IP network illustrated in FIG. 57 is made up of branch 5702 and central 5704 locations that are interconnected over a high bandwidth network 5706. In ths example, the branch locations are placed at some or all of the MDP nodes and the central locations may be at some or all of the AMSC node sites. In the present embodiment, the majority of traffic may be routed from the branch locations to the central locations but some traffic (acknowledgement, control, management, etc.) may travel from the central sites to the branch sites.

This system includes TCP/IP switching equipment which may have the capability to manage, shape and route all the IP traffic between the MDP and AMSC nodes. Switching may be done throughout the network at layers 2, 3 and 4 in order to accommodate proper network segmentation, traffic shaping and management.

A further embodiment of the TCP/IP network is illustrated in FIG. 58. In this example, each branch location is preferably fitted with two fully redundant layer 3 switches 5802, 5804. Each switch may be up-linked to the other and to one or more of the central site switches 5806, 5808. The system described herein and illustrated in FIG. 58 is a partially meshed system which provides full redundancy capability. In this case, each server in the associated node is connected to both switches and is able to determine from latency which connection is best to use.

In this example, 2.5 Mbit/s of bandwidth are initially provided between each of the MDP sites and each of the AMSC sites discussed. This may grow to 8 Mbit/s of bandwidth for each link as required to accommodate 2,000 SMS/sec from each of the of the branch sites. Each of the TCP/IP routing switching components at either end of these links is preferably designed to be capable of routing more than double its expected load.

A further feature that may be provided is the Event Handler, which is a bespoke written add-on to provide a Web based User Interface for the configuration of voting entries. The Event Handler may provide some or all of the following functionality:
Configuration of Voting Entry—Event times, short codes and service numbers.
Voting Entry Mask Input—Forecast
Basic Statistical Information—Forecasts and high level actuals.

As the Event Handler is an additional component it may be designed to integrate with the existing provisioning agent that provides communication with the Service Node. The Service Node may further provide management functionality for the solution therefore the Event handler may be able to re-use existing functionality such as:
Security
User/Role Administration
Role/function Access definition.

The Event Handler may persist all configuration and entry mask information via the provisioning agent to a database, for example an Oracle Database. Once the configuration of a Voting Event has been released the Service node may be designed to distribute the configuration to the appropriate nodes in the architecture.

Basic high level aggregated performance event information (such as message successful delivery attempts, failures etc) may be available. True statistical analysis may be provided by forwarding detailed information to a statistics/analysis application (which may be provided independently) to avoid loading the production SMS platforms.

1. A method of routing at least one message to a destination at a component connected to a telecommunications network comprising:
receiving the message from the telecommunications network over a telecommunications communication protocol link;
interacting with the message at the MAP layer to determine at least one piece of information including information indicative of the destination, from the message;
selecting a route for the destination at a component connected to the telecommunications network from at least a first route via the telecommunications network and a second route via a network separate to the telecommunications network based on the information determined;
routing at least a portion of the message via the selected route.

2. A method according to claim 1 wherein the at least one piece of information including information indicative of the destination determined from the message is used to determine the message type, wherein the message type may be one of: mobile originated, mobile terminated, application originated or application terminated.

3. A method according to claim 1 further comprising determining that the message is an application terminated message destined for an application connected to a remote node.

4. A method according to claim 1 wherein the network separate to the telecommunications network is an Internet Protocol (IP) network.

5. A method according to claim 1 wherein the step of receiving the message from the telecommunications network further comprises terminating the message.

6. A method according to claim 1 wherein, the message is a mobile originated message, and the method further comprises:
parsing the message at the MAP layer to extract at least one further piece of information from the message;
routing at least a portion of the message to its destination over a network separate to the telecommunications network based on the further information extracted from the message.

7. A method according to claim 6 wherein the at least one further piece of information extracted from the message is an identifier of the final destination entity for the message.

8. A method according to claim 7 wherein the method further comprises performing a destination lookup for the identifier of the final destination entity for the message.

9. A method according to claim 8, wherein performing the destination lookup comprises requesting location information for the identifier of the final destination entity for the message from a remote component.

10. A method according to claim 1 wherein the message is routed to its destination without passing through an SMSC of the telecommunications network.

11. A method according to claim 1 wherein the message is routed to its destination without passing through an STP of the telecommunications network.

12. A method according to claim 1 wherein the message is passed to a message handling component, such as an SMSC or AMSC, to allow storage of the message.

13. A method according to claim 1 wherein the network over which the message is routed is selected according to at least one predetermined condition.

14. A method according to claim 13 wherein the at least one predetermined condition comprises at least one of:
information extracted from the message at the MAP layer;
the message type;
an identifier of the final destination entity for the message;
destination lookup information obtained for the identifier of the final destination entity for the message;
an identifier of the mobile entity which originated the message;
an identifier of the home SMSC for the message.

15. A method according to claim 1 wherein the step of routing the message over a network selected from the telecommunications network and a network separate to the telecommunications network further comprises:
selecting one connection from a plurality of connections to components in the telecommunications network, wherein the plurality of connections are connections separate from the telecommunications communication protocol links;
delivering the message into the telecommunications network via the selected one of the plurality of connections.

16. A method according to claim 15 wherein at least one of the plurality of connections is bidirectional and the method further comprises receiving a message via at least one of the plurality of connections.

17. A method according claim 16 wherein the message is received via a first connection out of the plurality of connections and wherein the message is delivered into the telecommunications network via a selected one of the plurality of connections.

18. A method according to claim 15 wherein the connection via which the message is delivered into the telecommunications network is selected according to the at least one further piece of information extracted from the message at the MAP layer.

19. A method according to claim 15 wherein at least one of the plurality of connections to components in the telecommunications network comprises a connection via a message delivery component, which processes received messages for transmission between components in the telecommunications network and transmits at least a portion of each message over one of the plurality of connections separate from the telecommunications communication protocol links.

20. A method according to claim 19 wherein a plurality of the connections to components in the telecommunications network are via message delivery components and the wherein the message delivery components are interconnected over connections separate from the telecommunications communication protocol links.

21. A method according to claim 1 wherein the message is received from a component in the telecommunications network over an SS7 connection.

22. A method according to claim 19 wherein at least one message delivery component receives messages from more than one component in the telecommunications network.

23. A method according to claim 15 wherein the connections separate from the telecommunications communication protocol links are IP connections.

24. A method according to claim 1 wherein at least some of the plurality of telecommunications components comprise switches in the telecommunications network.

25. A method according to claim 1 further comprising obtaining at least one piece of information from a location register before routing the message to its destination.

26. A method according to claim 25 wherein the location register stores location information for globally unique identifiers corresponding to applications connected to the telecommunications network.

27. A method according to claim 1 further comprising requesting at least one piece of information from a message handling component before routing the message to its destination, the message handling component comprising a device for obtaining information relating to mobile entities or applications connected to the mobile telecommunications network.

28. A method according to claim 1 wherein at least part of the message is routed to its destination via a message handling component.

29. A method according to claim 25 wherein the message handling component obtains at least one piece of information relating to mobile entities or applications from the location register.

30. A method according to claim 26 wherein the message handling component provides an interface between the telecommunications network and the applications for which location information is stored in the location register.

31. A method according to claim 25 wherein the at least one piece of information comprises at least one of:
location information for the destination entity corresponding to the identifier of the final destination of the message;
availability information for the destination entity corresponding to the identifier of the final destination of the message;
International Mobile Subscriber Identity (IMSI) information; and
prepaid credit information.

32. A method according to claim 1 wherein the message is received from a Gateway Mobile Switching Centre (G-MSC) in the telecommunications network.

33. A method according to claim 1 wherein the message is received from a Mobile Switching Centre (MSC) in the telecommunications network.

34. A method of routing at least one message to a destination at a component connected to a network separate to the telecommunications network comprising:
receiving the message from the telecommunications network over a telecommunications communication protocol link;
interacting with the message at the MAP layer to determine at least one piece of information including information indicative of the destination from the message;
routing at least a portion of the message to its destination over the network separate to the telecommunications network without routing the message via an SMSC of the telecommunications network.

35. Apparatus for routing at least one message to a destination at a component connected to a telecommunications network comprising:
a receiving device for receiving the message from the telecommunications network over a telecommunications communication protocol link;
a device for interacting with the message at the MAP layer to determine at least one piece of information including information indicative of the destination from the message;
a device for selecting a route for a destination connected to the telecommunications network from at least a first route via the telecommunications network and a second route via a network separate to the telecommunications network based on the information determined;
a routing device for routing at least a portion of the message via the selected route.

36. Apparatus according to claim 35 wherein the at least one piece of information including information indicative of the destination determined from the message is used to determine the message type, wherein the message type may be one of: mobile originated, mobile terminated, application originated or application terminated.

37. Apparatus according to claim 35 wherein the network separate to the telecommunications network is an IP network.

38. Apparatus according to claim 35 wherein the receiving device for receiving the message from the telecommunications network further comprises a device for terminating the message.

39. Apparatus according to claim 35 wherein the message is a mobile originated message, and the apparatus further comprises:
a device for parsing the message at the MAP layer to extract at least one further piece of information from the message;
a routing device for routing the message to its destination over a network separate to the telecommunications network based on the information extracted from the message.

40. Apparatus according to claim 40 wherein the at least one further piece of information extracted from the message is an identifier of the final destination entity for the message.

41. Apparatus according to claim 41 further comprising a device for performing a destination lookup for the identifier of the final destination entity for the message.

42. Apparatus according to claim 42, wherein the device for performing the destination lookup comprises a device for requesting location information for the identifier of the final destination entity for the message from a remote component.

43. Apparatus according to claim 35 wherein the message is routed to its destination without passing through an SMSC of the telecommunications network.

44. Apparatus according to claim 35 wherein the message is routed to its destination without passing through an STP of the telecommunications network.

45. Apparatus according to claim 35 wherein the message is passed to a message handling component, such as an SMSC or AMSC, to allow storage of the message.

46. Apparatus according to claim 35 wherein the routing device for routing the message over a network separate to the telecommunications network further comprises:
a device for selecting one connection from a plurality of connections to components in the telecommunications network, wherein the plurality of connections are connections separate from the telecommunications communication protocol links;
a device for delivering the message into the telecommunications network via the selected one of the plurality of connections.

47. Apparatus according to claim 46 wherein at least one of the plurality of connections is bidirectional and the apparatus further comprises a receiving device for receiving a message via at least one of the plurality of connections.

48. Apparatus according claim 46 wherein the message is received via a first connection out of the plurality of connections and wherein the message is delivered into the telecommunications network via a selected one of the plurality of connections.

49. Apparatus according to claim 46 wherein the connection via which the message is delivered into the telecommunications network is selected according to the at least one further piece of information extracted from the message at the MAP layer.

50. Apparatus according to claim 46 wherein at least one of the plurality of connections to components in the telecommunications network comprises a connection via a message delivery component, which comprises a device for processing received messages for transmission between components in the telecommunications network and a transmitting device for transmitting at least a portion of each message over one of the plurality of connections separate from the telecommunications communication protocol links.

51. Apparatus according to claim 50 wherein a plurality of the connections to components in the telecommunications network are via message delivery components and wherein the message delivery components are interconnected over connections separate from the telecommunications communication protocol links.

52. Apparatus according to claim 35 wherein the message is received from a component in the telecommunications network over an SS7 connection.

53. Apparatus according to claim 50 wherein at least one message delivery component comprises a receiving device for receiving messages from more than one component in the telecommunications network.

54. Apparatus according to claim 50 wherein a plurality of the connections to components in the telecommunications network are via message delivery components and wherein a distributed software system is run by the message delivery components.

55. Apparatus according to claim 46 wherein the connections separate from the telecommunications communication protocol links are IP connections.

56. Apparatus according to claim 35 wherein at least some of the plurality of telecommunications components comprise switches in the telecommunications network.

57. Apparatus according to claim 35 further comprising a device for obtaining at least one piece of information from a location register before routing the message to its destination.

58. Apparatus according to claim 57 wherein the location register comprises a device for storing location information for globally unique identifiers corresponding to applications connected to the telecommunications network.

59. Apparatus according to claim 35 further comprising a device for requesting at least one piece of information from a message handling component and a routing device for routing the message to its destination based on the at least one piece of information received, the message handling component comprising a device for obtaining information relating to mobile entities or applications connected to the mobile telecommunications network.

60. Apparatus according to claim 35 wherein at least part of the message is routed to its destination via a message handling component.

61. Apparatus according to claim 58 wherein the message handling component provides an interface between the telecommunications network and the applications for which location information is stored in the location register.

62. Apparatus according to claim 57 wherein the at least one piece of information comprises at least one of:
location information for the destination entity corresponding to the identifier of the final destination of the message;
availability information for the destination entity corresponding to the identifier of the final destination of the message;
International Mobile Subscriber Identity (IMSI) information; and
prepaid credit information.

63. Apparatus according to claim 35 wherein the message is received from a Gateway Mobile Switching Centre (G-MSC) in the telecommunications network.

64. Apparatus according to claim 35 wherein the message is received from a Mobile Switching Centre (MSC) in the telecommunications network.

65. Apparatus for routing at least one message to a destination at a component connected to a network separate to the telecommunications network comprising:
a receiving device for receiving the message from the telecommunications network over a telecommunications communication protocol link;
a device for interacting with the message at the MAP layer to determine at least one piece of information including information indicative of the destination from the message;
a routing device for routing at least a portion of the message to its destination over the network separate to the telecommunications network without routing the message via an SMSC of the telecommunications network.

66. A computer-readable medium comprising instructions for implementing a method comprising the steps of:
receiving the message from the telecommunications network over a telecommunications communication protocol link;
interacting with the message at the MAP layer to determine at least one piece of information including information indicative of the destination, from the message;
selecting a route for the destination at a component connected to the telecommunications network from at least a first route via the telecommunications network and a second route via a network separate to the telecommunications network based on the information determined;
routing at least a portion of the message via the selected route.
